(19) United States
(12) Patent Application Publication
(10) Pub. No.: US 2024/0048324 A1
(43) Pub. Date: Feb. 8, 2024

(54) Method and Apparatus for Sidelink Positioning Reference Signal in a Wireless Communication System

(71) Applicant: ASUS Technology Licensing Inc., Taipei City (TW)

(72) Inventors: MING-CHE LI, Taipei City (TW); Chun-Wei Huang, Taipei (TW)

(21) Appl. No.: 18/227,344

(22) Filed: Jul. 28, 2023

Related U.S. Application Data
(60) Provisional application No. 63/393,651, filed on Jul. 29, 2022.

(51) Int. Cl. H04L 5/00; H04W 72/25; H04W 24/08; H04W 72/0446

(52) U.S. Cl. CPC H04L 5/0051; H04W 72/25; H04W 24/08; H04W 72/0446

(57) ABSTRACT

In an example, a device, with a configuration of a sidelink resource pool comprising sidelink reference signal resources, determines candidate frequency resources of sidelink control channel in a slot in the sidelink resource pool. The candidate frequency resources are determined based on one or more parameters, one or more indexes and/or one or more identities associated with a plurality of candidate sidelink reference signal resources in the slot. The device performs monitoring on the candidate frequency resources. The device receives a sidelink control information (SCI) using a first frequency resource of the sidelink control channel. The candidate frequency resources include the first frequency resource of the sidelink control channel. The device measures a sidelink reference signal on a first sidelink reference signal resource in the slot. The first sidelink reference signal resource is associated with one or more first parameters, a first index and/or a first identity determined based on the first frequency resource of the sidelink control channel.

### CROSS-REFERENCE TO RELATED APPLICATIONS

The present Application claims the benefit of U.S. Provisional Patent Application Ser. No. 63/393,651 filed on Jul. 29, 2022, the entire disclosure of which is incorporated herein in its entirety by reference.

### FIELD

This disclosure generally relates to wireless communication networks, and more particularly, to a method and apparatus for sidelink positioning reference signal in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

In accordance with the present disclosure, one or more devices and/or methods are provided. In an example from the perspective of a device with a configuration of a first sidelink resource pool comprising sidelink reference signal resources, the device determines a plurality of candidate frequency resources of a sidelink control channel in a slot in the first sidelink resource pool. The plurality of candidate frequency resources is associated with a plurality of candidate sidelink reference signal resources in the slot. The plurality of candidate frequency resources associated with the plurality of candidate sidelink reference signal resources are determined based on one or more parameters associated with the plurality of candidate sidelink reference signal resources, one or more indexes associated with the plurality of candidate sidelink reference signal resource and/or one or more identities associated with the plurality of candidate sidelink reference signal resources. The device performs monitoring on the plurality of candidate frequency resources of the sidelink control channel in the slot. The device receives a sidelink control information (SCI) using a first frequency resource of the sidelink control channel in the slot. The plurality of candidate frequency resources comprises the first frequency resource of the sidelink control channel. The device measures a sidelink reference signal on a first sidelink reference signal resource in the slot. The first sidelink reference signal resource is associated with one or more first parameters determined based on the first frequency resource of the sidelink control channel, a first index determined based on the first frequency resource of the sidelink control channel, and/or a first identity determined based on the first frequency resource of the sidelink control channel.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5A is a diagram associated with a Downlink (DL) Positioning Reference Signal (PRS) according to one exemplary embodiment.

FIG. 5B is a diagram associated with a slot format of Sidelink (SL) PRS according to one exemplary embodiment.

FIG. 6 is a diagram associated with a SL PRS pattern according to one exemplary embodiment.

FIG. 7 is a diagram associated with dedicated SL-PRS configuration according to one exemplary embodiment.

FIG. 8 is a diagram associated with extending SL-PRS outside a SL resource pool according to one exemplary embodiment.

FIG. 9 is a diagram illustrating an exemplary scenario associated with sidelink control information (SCI) triggering SL-PRS occasions according to one exemplary embodiment.

FIG. 10 is a diagram associated with slot structure of SL positioning Reference Signal (RS) slot according to one exemplary embodiment.

FIG. 11 is a diagram associated with Time Division Multiplexing (TDM) resource pool configuration according to one exemplary embodiment.

FIG. 12 is a diagram associated with Physical Sidelink Control Channel (PSCCH) and/or Physical Sidelink Shared Channel (PSSCH) resource according to one exemplary embodiment.

FIG. 13 is a diagram associated with Resource Element (RE)-level multiplexing according to one exemplary embodiment.

FIG. 14 is a diagram associated with a fully staggered SL PRS pattern according to one exemplary embodiment.

FIG. 15 is a diagram associated with a partially staggered SL PRS pattern according to one exemplary embodiment.

FIG. 16 is a diagram associated with an unstaggered SL PRS pattern according to one exemplary embodiment.

FIG. 17 is a diagram associated with a dedicated resource pool for SL PRS according to one exemplary embodiment.

FIG. 18A is a diagram illustrating an example structure of SCI, PSCCH and/or SL PRS according to one exemplary embodiment.

FIG. 18B is a diagram illustrating an example structure of SCI, PSCCH and/or SL PRS according to one exemplary embodiment.

FIG. 18C is a diagram illustrating an example structure of SCI, PSCCH and/or SL PRS according to one exemplary embodiment.

FIG. 18D is a diagram illustrating an example structure of SCI, PSCCH and/or SL PRS according to one exemplary embodiment.

FIG. 18E is a diagram illustrating an example structure of SCI, PSCCH and/or SL PRS according to one exemplary embodiment.

FIG. 18F is a diagram illustrating an example structure of SCI, PSCCH and/or SL PRS according to one exemplary embodiment.

FIG. 18G is a diagram illustrating an example structure of SCI, PSCCH and/or SL PRS according to one exemplary embodiment.

FIG. 18H is a diagram illustrating an example structure of SCI, PSCCH and/or SL PRS according to one exemplary embodiment.

FIG. 18I is a diagram illustrating an example structure of SCI, PSCCH and/or SL PRS according to one exemplary embodiment.

FIG. 19 is a diagram illustrating example frequency resources of a SL PRS for different cases according to one exemplary embodiment.

FIG. 20 is a flow chart according to one exemplary embodiment.

FIG. 21 is a flow chart according to one exemplary embodiment.

FIG. 22 is a flow chart according to one exemplary embodiment.

FIG. 23 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3^{rd} Generation Partnership Project (3GPP) LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio) wireless access for 5G, or some other modulation techniques.

In particular, the exemplary wireless communication systems devices described below may be designed to support one or more standards such as the standard offered by a consortium named “3rd Generation Partnership Project” referred to herein as 3GPP, including: 3GPP TS 38.213 V17.2.0 (2022-06) 3GPP; TSG RAN; NR; Physical layer procedures for control (Release 17); 3GPP TS 38.214 V17.1.0 (2022-03) 3GPP; TSG RAN; NR; Physical layer procedures for data (Release 17); 3GPP TS 38.212 V17.1.0 (2022-03) 3GPP; TSG RAN; NR; Multiplexing and channel coding (Release 17); RP-213588, “Revised SID on Study on expanded and improved NR positioning”, Intel; RAN1 Chair's Notes of 3GPP TSG RAN WG1 #109-e; R1-2203566, “Discussion on potential solutions for sidelink positioning”, vivo; R1-2203624, “Discussion on potential solutions for SL positioning”, ZTE; R1-2204310, “Discussion on potential solutions for SL positioning”, CMCC. The standards and documents listed above are hereby expressly incorporated by reference in their entirety.

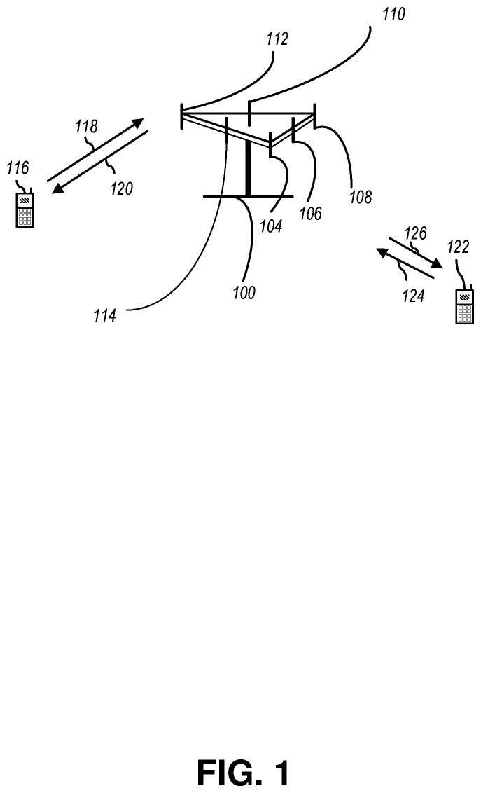

FIG. 1 presents a multiple access wireless communication system in accordance with one or more embodiments of the disclosure. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. AT 122 is in communication with antennas 106 and 108, where antennas 106 and 108 transmit information to AT 122 over forward link 126 and receive information from AT 122 over reverse link 124. In a frequency-division duplexing (FDD) system, communication links 118, 120, 124 and 126 may use different frequencies for communication. For example, forward link 120 may use a different frequency than that used by reverse link 118.

Each group of antennas and/or the area in which they are designed to communicate is often referred to as a sector of the access network. In the embodiment, antenna groups each may be designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage may normally cause less interference to access terminals in neighboring cells than an access network transmitting through a single antenna to its access terminals.

An access network (AN) may be a fixed station or base station used for communicating with the terminals and may also be referred to as an access point, a Node B, a base station, an enhanced base station, an eNodeB (eNB), a Next Generation NodeB (gNB), or some other terminology. An access terminal (AT) may also be called user equipment (UE), a wireless communication device, terminal, access terminal or some other terminology.

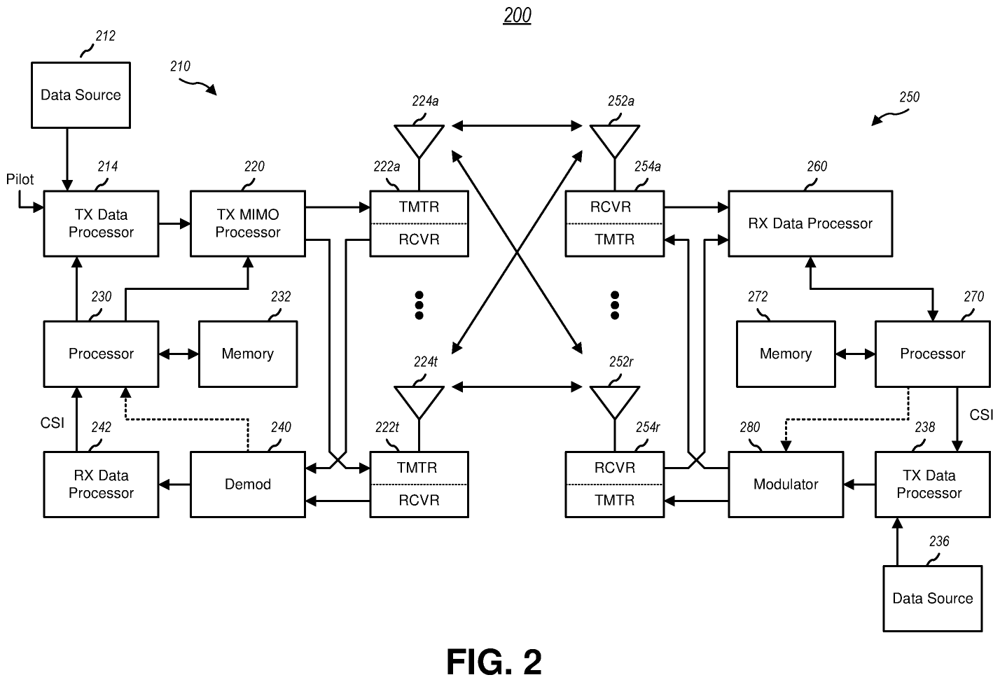

FIG. 2 presents an embodiment of a transmitter system 210 (also known as the access network) and a receiver system 250 (also known as access terminal (AT) or user equipment (UE)) in a multiple-input and multiple-output (MIMO) system 200. At the transmitter system 210, traffic data for a number of data streams may be provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using orthogonal frequency-division multiplexing (OFDM) techniques. The pilot data may typically be a known data pattern that is processed in a known manner and may be used at the receiver system to estimate the channel response. The multiplexed pilot and coded data for each data stream may then be modulated (i.e., symbol mapped) based on a particular modulation scheme (e.g., binary phase shift keying (BPSK), quadrature phase shift keying (QPSK), M-ary phase shift keying (M-PSK), or M-ary quadrature amplitude modulation (M-QAM)) selected for that data stream to provide modulation symbols. The data rate, coding, and/or modulation for each data stream may be determined by instructions performed by processor 230.

The modulation symbols for data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 may apply beamforming weights to the symbols of the data streams and to the antenna from which the symbol is being transmitted.

Each transmitter 222 receives and processes a respective symbol stream to provide one or more analog signals, and further conditions (e.g., amplifies, filters, and/or upconverts) the analog signals to provide a modulated signal suitable for transmission over the MIMO channel. N_{T} modulated signals from transmitters 222a through 222t may then be transmitted from N_{T} antennas 224a through 224t, respectively.

At receiver system 250, the transmitted modulated signals are received by N_{R} antennas 252a through 252r and the received signal from each antenna 252 may be provided to a respective receiver (RCVR) 254a through 254r. Each receiver 254 may condition (e.g., filters, amplifies, and downconverts) a respective received signal, digitize the conditioned signal to provide samples, and/or further process the samples to provide a corresponding “received” symbol stream.

An RX data processor 260 then receives and/or processes the N_{R} received symbol streams from N_{R} receivers 254 based on a particular receiver processing technique to provide N_{T}“detected” symbol streams. The RX data processor 260 may then demodulate, deinterleave, and/or decode each detected symbol stream to recover the traffic data for the data stream. The processing by RX data processor 260 may be complementary to that performed by TX MIMO processor 220 and TX data processor 214 at transmitter system 210.

A processor 270 may periodically determine which pre-coding matrix to use (discussed below). Processor 270 formulates a reverse link message comprising a matrix index portion and a rank value portion.

The reverse link message may comprise various types of information regarding the communication link and/or the received data stream. The reverse link message may then be processed by a TX data processor 238, which may also receive traffic data for a number of data streams from a data source 236, modulated by a modulator 280, conditioned by transmitters 254a through 254r, and/or transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 may then determine which pre-coding matrix to use for determining the beamforming weights and may then process the extracted message.

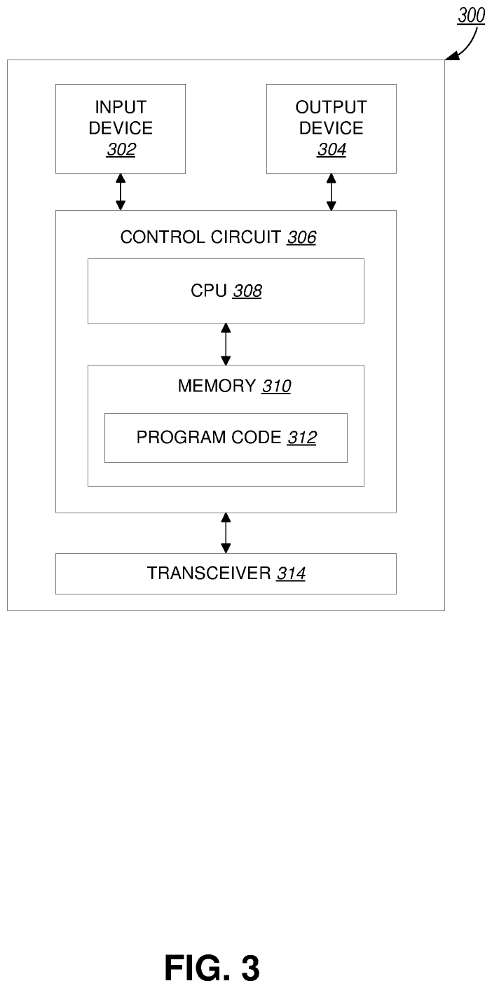

FIG. 3 presents an alternative simplified functional block diagram of a communication device according to one embodiment of the disclosed subject matter. As shown in FIG. 3, the communication device 300 in a wireless communication system can be utilized for realizing the UEs (or ATs) 116 and 122 in FIG. 1 or the base station (or AN) 100 in FIG. 1, and the wireless communications system may be the LTE system or the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

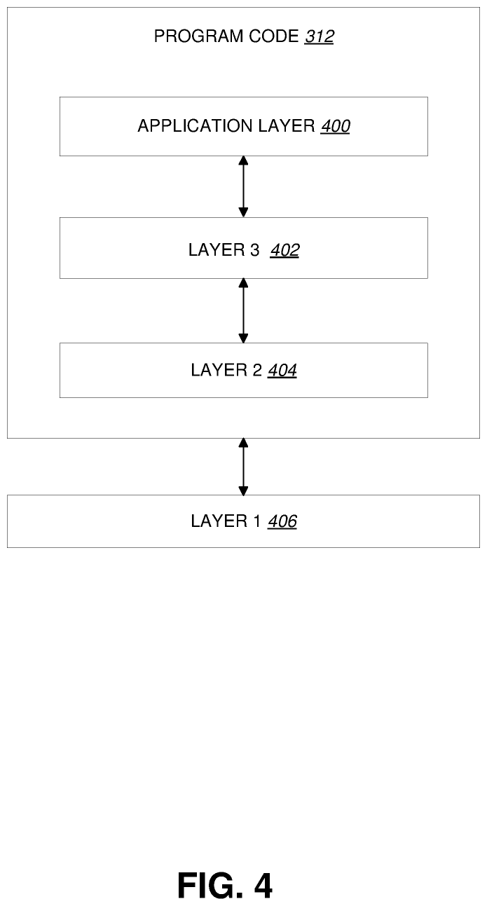

FIG. 4 is a simplified block diagram of the program code 312 shown in FIG. 3 in accordance with one embodiment of the disclosed subject matter. In this embodiment, the program code 312 includes an application layer 400, a Layer 3 portion 402, and a Layer 2 portion 404, and is coupled to a Layer 1 portion 406. The Layer 3 portion 402 may perform radio resource control. The Layer 2 portion 404 may perform link control. The Layer 1 portion 406 may perform and/or implement physical connections.

Sidelink (SL) related procedure for control is discussed in 3GPP TS 38.213 V17.2.0, one or more parts of which are quoted below:

16 UE procedures for sidelink
A UE is provided by SL-BWP-Config a BWP for SL transmissions (SL BWP) with numerology and resource grid determined as described in [4, TS 38.211]. For a resource pool within the SL BWP, the UE is provided by sl-NumSubchannel a number of sub-channels where each sub-channel includes a number of contiguous RBs provided by sl-SubchannelSize. The first RB of the first sub-channel in the SL BWP is indicated by sl-StartRB-Subchannel. Available slots for a resource pool are provided by sl-TimeResource and occur with a periodicity of 10240 ms. For an available slot without S-SS/PSBCH blocks, SL transmissions can start from a first symbol indicated by sl-StartSymbol and be within a number of consecutive symbols indicated by sl-LengthSymbols. For an available slot with S-SS/PSBCH blocks, the first symbol and the number of consecutive symbols is predetermined.
16.4 UE procedure for transmitting PSCCH
A UE can be provided a number of symbols in a resource pool, by sl-TimeResourcePSCCH, starting from a second symbol that is available for SL transmissions in a slot, and a number of PRBs in the resource pool, by sl-FreqResourcePSCCH, starting from the lowest PRB of the lowest sub-channel of the associated PSSCH, for a PSCCH transmission with a SCI format 1-A.
A UE that transmits a PSCCH with SCI format 1-A using sidelink resource allocation mode 2 [6, TS 38.214] sets
“Resource reservation period” as an index in sl-ResourceReservePeriodList corresponding to a reservation period provided by higher layers [11, TS 38.321], if the UE is provided sl-MultiReserveResource
the values of the frequency resource assignment field and the time resource assignment field as described in [6, TS 38.214] to indicate N resources from a set {R_{y}} of resources selected by higher layers as described in [11, TS 38.321] with N smallest slot indices yᵢ for 0≤i≤N−1 such that y₀<y₁< . . . <y_{N-1}≤y₀+31, where:
   . . . .
   y₀ is an index of a slot where the PSCCH with SCI format 1-A is transmitted.
      A UE that transmits a PSCCH with SCI format 1-A using sidelink resource allocation mode 1 [6, TS 38.214] sets
the values of the frequency resource assignment field and the time resource assignment field for the SCI format 1-A transmitted in the m-th resource for PSCCH/PSSCH transmission provided by a dynamic grant or by a SL configured grant, where m={1, . . . , M} and M is the total number of resources for PSCCH/PSSCH transmission provided by a dynamic grant or the number of resources for PSCCH/PSSCH transmission in a period provided by a SL configured grant type 1 or SL configured grant type 2, as follows:
   the frequency resource assignment field and time resource assignment field indicate the m-th to M-th resources as described in [6, TS 38.214].

SL related procedure for data is discussed in 3GPP TS 38.214 V17.1.0, one or more parts of which are quoted below:

### 8 Physical Sidelink Shared Channel Related Procedures

A UE can be configured by higher layers with one or more sidelink resource pools. A sidelink resource pool can be for transmission of PSSCH, as described in Clause 8.1, or for reception of PSSCH, as described in Clause 8.3 and can be associated with either sidelink resource allocation mode 1 or sidelink resource allocation mode 2.
In the frequency domain, a sidelink resource pool consists of sl-NumSubchannel contiguous sub-channels. A sub-channel consists of sl-SubchannelSize contiguous PRBs, where sl-NumSubchannel and sl-SubchannelSize are higher layer parameters.

The set of slots that may belong to a sidelink resource pool is denoted by (t₀^{SL}, t₁^{SL}, . . . , t_{Tmax-1}^{SL}) where
0≤tᵢ^{SL}<10240×2^{μ}, 0≤i<Tₘₐₓ,
the slot index is relative to slot #0 of the radio frame corresponding to SFN 0 of the serving cell or DFN 0,
the set includes all the slots except the following slots,
   N_{S-SSB} slots in which S-SS/PSBCH block (S-SSB) is configured,
   N_{nonSL} slots in each of which at least one of Y-th, (Y+1)-th, . . . , (Y+X−1)-th OFDM symbols are not semi-statically configured as UL as per the higher layer parameter tdd-UL-DL-ConfigurationCommon of the serving cell if provided or sl-TDD-Configuration if provided or sl-TDD-Config of the received PSBCH if provided, where Y and X are set by the higher layer parameters sl-StartSymbol and sl-LengthSymbols, respectively.
   The reserved slots which are determined by the following steps.
      1) the remaining slots excluding N_{S-SSB} slots and N_{nonSL} slots from the set of all the slots are denoted by (l₀, l₁, . . . , l_{(10240×2}_{^{μ}}_{-N}_{_{S-SSB}}_{-N}_{_{nonSL}}₋₁)) arranged in increasing order of slot index.
      2) a slot lᵣ (0≤r<10240×2^{μ}−N_{S-SSB}−N_{nonSL}) belongs to the reserved slots if

$$r = ⌊ \frac{m \cdot ( 10240 \times {2}^{μ} - {N}_{S - BB} - {N}_{nonSL} )}{{N}_{reserved}} ⌋ ,$$

here m=0,1, . . . , N_{reserved}−1 and N_{reserved}=(10240×2^{μ}−N_{S}_{_{SSB}}−N_{nonSL}) mod L_{bitmap} where L_{bitmap} denotes the length of bitmap configured by higher layers.
The slots in the set are arranged in increasing order of slot index.
   The UE determines the set of slots assigned to a sidelink resource pool as follows:
a bitmap (b₀, b₁, . . . , b_{L}_{_{bitmap}}₋₁) associated with the resource pool is used where L_{bitmap} the length of the bitmap is configured by higher layers.
a slot tₖ^{SL} (0≤k<10240×2^{μ}−N_{S-SSB}−N_{nonSL}−N_{reserved}) belongs to the set if b_{k′}=1 where k′=k mod L_{bitmap}
The slots in the set are re-indexed such that the subscripts i of the remaining slots t′ᵢ^{SL} are successive {0, 1, . . . , T′ₘₐₓ−1} where T′ₘₐₓ is the number of the slots remaining in the set.
   The UE determines the set of resource blocks assigned to a sidelink resource pool as follows:
The resource block pool consists of N_{PRB} PRBs.
The sub-channel m for m=0,1, . . . , numSubchannel−1 consists of a set of n_{subCHsize} contiguous resource blocks with the physical resource block number n_{PRB}=n_{subCHRBstart}+m·n_{subCHsize}+j for j=0,1, . . . , n_{subCHsize}−1, where n_{subCHRBstart} and n_{subCHsize} are given by higher layer parameters sl-StartRB-Subchannel and sl-SubchannelSize, respectively
   A UE is not expected to use the last N_{PRB} mod n_{subCHsize} PRBs in the resource pool.

### 8.1 UE Procedure for Transmitting the Physical Sidelink Shared Channel

Each PSSCH transmission is associated with an PSCCH transmission.

That PSCCH transmission carries the 1^{st} stage of the SCI associated with the PSSCH transmission; the 2^{nd} stage of the associated SCI is carried within the resource of the PSSCH.

If the UE transmits SCI format 1-A on PSCCH according to a PSCCH resource configuration in slot n and PSCCH resource m, then for the associated PSSCH transmission in the same slot
one transport block is transmitted with up to two layers;

### 8.1.2 Resource Allocation

In sidelink resource allocation mode 1:
for PSSCH and PSCCH transmission, dynamic grant, configured grant type 1 and configured grant type 2 are supported. The configured grant Type 2 sidelink transmission is semi-persistently scheduled by a SL grant in a valid activation DCI according to Clause 10.2A of [6, TS 38.213].

### 8.1.2.1 Resource Allocation in Time Domain

The UE shall transmit the PSSCH in the same slot as the associated PSCCH.
The minimum resource allocation unit in the time domain is a slot.
The UE shall transmit the PSSCH in consecutive symbols within the slot, subject to the following restrictions:
The UE shall not transmit PSSCH in symbols which are not configured for sidelink. A symbol is configured for sidelink, according to higher layer parameters sl-StartSymbol and sl-LengthSymbols, where sl-StartSymbol is the symbol index of the first symbol of sl-LengthSymbols consecutive symbols configured for sidelink.
Within the slot, PSSCH resource allocation starts at symbol sl-StartSymbol+1.
The UE shall not transmit PSSCH in symbols which are configured for use by PSFCH, if PSFCH is configured in this slot.
The UE shall not transmit PSSCH in the last symbol configured for sidelink.
The UE shall not transmit PSSCH in the symbol immediately preceding the symbols which are configured for use by PSFCH, if PSFCH is configured in this slot.
   In sidelink resource allocation mode 1:
For sidelink dynamic grant, the PSSCH transmission is scheduled by a DCI format 3_0.
For sidelink configured grant type 2, the configured grant is activated by a DCI format 3_0.
For sidelink dynamic grant and sidelink configured grant type 2:
   . . . .
For sidelink configured grant type 1:
   The slot of the first sidelink transmissions follows the higher layer configuration according to [10, TS 38.321].
      8.1.2.2 Resource allocation in frequency domain
      The resource allocation unit in the frequency domain is the sub-channel.
      The sub-channel assignment for sidelink transmission is determined using the “Frequency resource assignment” field in the associated SCI.
      The lowest sub-channel for sidelink transmission is the sub-channel on which the lowest PRB of the associated PSCCH is transmitted.
      If a PSSCH scheduled by a PSCCH would overlap with resources containing the PSCCH, the resources corresponding to a union of the PSCCH that scheduled the PSSCH and associated PSCCH DM-RS are not available for the PSSCH.
      8.1.5 UE Procedure for Determining Slots and Resource Blocks for PSSCH Transmission Associated with an SCI Format 1-A
      The set of slots and resource blocks for PSSCH transmission is determined by the resource used for the PSCCH transmission containing the associated SCI format 1-A, and fields ‘Frequency resource assignment’, ‘Time resource assignment’ of the associated SCI format 1-A as described below.
      ‘Time resource assignment’ carries logical slot offset indication of N=1 or 2 actual resources when sl-MaxNumPerReserve is 2, and N=1 or 2 or 3 actual resources when sl-MaxNumPerReserve is 3, in a form of time RIV (TRIV) field which is determined as follows:
      where the first resource is in the slot where SCI format 1-A was received, and tᵢ denotes i-th resource time offset in logical slots of a resource pool with respect to the first resource where for N=2, 1≤t₁≤31; and for N=3, 1≤t₁≤30, t₁<t₂≤31.

The starting sub-channel n_{subCH,0}^{start} of the first resource is determined according to clause 8.1.2.2. The number of contiguously allocated sub-channels for each of the N resources L_{subCH}≥1 and the starting sub-channel indexes of resources indicated by the received SCI format 1-A, except the resource in the slot where SCI format 1-A was received, are determined from “Frequency resource assignment” which is equal to a frequency RIV (FRIV) where.

where
n_{subCH,1}^{start} denotes the starting sub-channel index for the second resource
n_{subCH,2}^{start} denotes the starting sub-channel index for the third resource
N_{subchannel}^{SL} is the number of sub-channels in a resource pool provided according to the higher layer parameter sl-NumSubchannel
   If TRIV indicates N<sl-MaxNumPerReserve, the starting sub-channel indexes corresponding to sl-MaxNumPerReserve minus N last resources are not used.

### 8.3 UE Procedure for Receiving the Physical Sidelink Shared Channel

For sidelink resource allocation mode 1, a UE upon detection of SCI format 1-A on PSCCH can decode PSSCH according to the detected SCI formats 2-A and 2-B, and associated PSSCH resource configuration configured by higher layers. The UE is not required to decode more than one PSCCH at each PSCCH resource candidate.
For sidelink resource allocation mode 2, a UE upon detection of SCI format 1-A on PSCCH can decode PSSCH according to the detected SCI formats 2-A and 2-B, and associated PSSCH resource configuration configured by higher layers. The UE is not required to decode more than one PSCCH at each PSCCH resource candidate.
A UE is required to decode neither the corresponding SCI formats 2-A and 2-B nor the PSSCH associated with an SCI format 1-A if the SCI format 1-A indicates an MCS table that the UE does not support.

Downlink Control Information (DCI) format, SL grant and/or sidelink control information (SCI) format for sidelink are discussed in 3GPP TS 38.212 V17.1.0, one or more parts of which are quoted below:

### 8.3 Sidelink Control Information on PSCCH

SCI carried on PSCCH is a 1^{st}-stage SCI, which transports sidelink scheduling information.
8.3.1 1st-Stage SCI Formats

### 8.3.1.1 SCI Format 1-A

SCI format 1-A is used for the scheduling of PSSCH and 2^{nd}-stage-SCI on PSSCH
The following information is transmitted by means of the SCI format 1-A:
Priority— 3 bits as specified in clause 5.4.3.3 of [12, TS 23.287] and clause 5.22.1.3.1 of [8, TS 38.321]. Value ‘000’ of Priority field corresponds to priority value ‘1’, value ‘001’ of Priority field corresponds to priority value ‘2’, and so on.
Frequency resource assignment— . . . as defined in clause 8.1.5 of [6, TS 38.214].
Time resource assignment— . . . as defined in clause 8.1.5 of [6, TS 38.214].
Resource reservation period —└ log₂ N_{rsv_period}┘ bits as defined in clause 16.4 of [5, TS 38.213], where N_{rsv_period} is the number of entries in the higher layer parameter sl-ResourceReservePeriodList, if higher layer parameter sl-MultiReserveResource is configured; 0 bit otherwise.
DMRS pattern —└ log₂ Nₚₐₜₜₑᵣₙ┘ bits as defined in clause 8.4.1.1.2 of [4, TS 38.211], where Nₚₐₜₜₑᵣₙ is the number of DMRS patterns configured by higher layer parameter sl-PSSCH-DMRS-TimePatternList.
2^{nd}-stage SCI format—2 bits as defined in Table 8.3.1.1-1.
PSFCH overhead indication—1 bit as defined clause 8.1.3.2 of [6, TS 38.214] if higher layer parameter sl-PSFCH-Period=2 or 4; 0 bit otherwise.
Reserved—a number of bits as determined by the following:
   N_{reserved} bits as configured by higher layer parameter sl-NumReservedBits, with value set to zero, if higher layer parameter indicationUEBScheme2 is not configured, or if higher layer parameter indicationUEBScheme2 is configured to ‘Disabled’;
   (N_{reserved}−1) bits otherwise, with value set to zero.
Conflict information receiver flag—0 or 1 bit

TABLE 8.3.1.1-1
2^{nd}-stage SCI formats

| Value of 2nd-stage | |
|---|---|
| SCI format field | 2nd-stage SCI format |
| 00 | SCI format 2-A |
| 01 | SCI format 2-B |
| 10 | SCI format 2-C |
| 11 | Reserved |

### 8.4 Sidelink Control Information on PSSCH

SCI carried on PSSCH is a 2^{nd}-stage SCI, which transports sidelink scheduling information, and/or inter-UE coordination related information.
8.4.1 2^{nd}-Stage SCI Formats

### 8.4.1.1 SCI Format 2-A

SCI format 2-A is used for the decoding of PSSCH, with HARQ operation when HARQ-ACK information includes ACK or NACK, when HARQ-ACK information includes only NACK, or when there is no feedback of HARQ-ACK information.

The following information is transmitted by means of the SCI format 2-A:
HARQ process number—4 bits.
New data indicator—1 bit.
Redundancy version—2 bits as defined in Table 7.3.1.1.1-2.
Source ID—8 bits as defined in clause 8.1 of [6, TS 38.214].
Destination ID—16 bits as defined in clause 8.1 of [6, TS 38.214].
HARQ feedback enabled/disabled indicator—1 bit as defined in clause 16.3 of [5, TS 38.213].
Cast type indicator—2 bits as defined in Table 8.4.1.1-1 and in clause 8.1 of [6, TS 38.214].
CSI request—1 bit as defined in clause 8.2.1 of [6, TS 38.214] and in clause 8.1 of [6, TS 38.214].

TABLE 8.4.1.1-1
Cast type indicator

| Value of Cast type | |
|---|---|
| indicator | Cast type |
| 00 | Broadcast |
| 01 | Groupcast |
| | when HARQ-ACK information includes |
| | ACK or NACK |
| 10 | Unicast |
| 11 | Groupcast |
| | when HARQ-ACK information includes |
| | only NACK |

### 8.4.1.2 SCI Format 2-B

SCI format 2-B is used for the decoding of PSSCH, with HARQ operation when HARQ-ACK information includes only NACK, or when there is no feedback of HARQ-ACK information.
The following information is transmitted by means of the SCI format 2-B:
HARQ process number—4 bits.
New data indicator—1 bit.
Redundancy version—2 bits as defined in Table 7.3.1.1.1-2.
Source ID—8 bits as defined in clause 8.1 of [6, TS 38.214].
Destination ID—16 bits as defined in clause 8.1 of [6, TS 38.214].
HARQ feedback enabled/disabled indicator—1 bit as defined in clause 16.3 of [5, TS 38.213].
Zone ID—12 bits as defined in clause 5.8.11 of [9, TS 38.331].
Communication range requirement—4 bits determined by higher layer parameter sl-ZoneConfigMCR-Index.

### 8.4.1.3 SCI Format 2-C

SCI format 2-C is used for the decoding of PSSCH, and providing inter-UE coordination information or requesting inter-UE coordination information.
The following information is transmitted by means of the SCI format 2-C:
HARQ process number—4 bits
New data indicator—1 bit
Redundancy version—2 bits as defined in Table 7.3.1.1.1-2
Source ID—8 bits as defined in clause 8.1 of [6, TS 38.214]
Destination ID—16 bits as defined in clause 8.1 of [6, TS 38.214]
HARQ feedback enabled/disabled indicator—1 bit as defined in clause 16.3 of [5, TS 38.213]
CSI request—1 bit as defined in clause 8.2.1 of [6, TS 38.214] and in clause 8.1 of [6, TS 38.214]
Providing/Requesting indicator—1 bit, where value 0 indicates SCI format 2-C is used for providing inter-UE coordination information and value 1 indicates SCI format 2-C is used for requesting inter-UE coordination information
   8.4.5 Multiplexing of coded 2^{nd}-stage SCI bits to PSSCH
   The coded 2^{nd}-stage SCI bits are multiplexed onto PSSCH according to the procedures in Clause 8.2.1.

A Study Item Description (SID) on expanded and/or improved NR positioning is discussed in RP-213588, one or more parts of which are quoted below:

### 4 Objective

### 4.1 Objective of SI or Core Part WI or Testing Part WI

Study solutions for sidelink positioning considering the following: [RAN1, RAN2]
   Scenario/requirements
      Coverage scenarios to cover: in-coverage, partial-coverage and out-of-coverage
      Requirements: Based on requirements identified in TR38.845 and TS22.261 and TS22.104
      Use cases: V2X (TR38.845), public safety (TR38.845), commercial (TS22.261), HOT (TS22.104)
      Spectrum: ITS, licensed
   Identify specific target performance requirements to be considered for the evaluation based on existing 3GPP work and inputs from industry forums [RAN1]
   Define evaluation methodology with which to evaluate SL positioning for the uses cases and coverage scenarios, reusing existing methodologies from sidelink communication and from positioning as much as possible [RAN1].
   Study and evaluate performance and feasibility of potential solutions for SL positioning, considering relative positioning, ranging and absolute positioning: [RAN1, RAN2]
      Evaluate bandwidth requirement needed to meet the identified accuracy requirements [RAN1]
      Study of positioning methods (e.g. TDOA, RTT, AOA/D, etc) including combination of SL positioning measurements with other RAT dependent positioning measurements (e.g. Uu based measurements) [RAN1]
      Study of sidelink reference signals for positioning purposes from physical layer perspective, including signal design, resource allocation, measurements, associated procedures, etc, reusing existing reference signals, procedures, etc from sidelink communication and from positioning as much as possible [RAN1]
      Study of positioning architecture and signalling procedures (e.g. configuration, measurement reporting, etc) to enable sidelink positioning covering both UE based and network based positioning [RAN2, including coordination and alignment with RAN3 and SA2 as required]
   Note: When the bandwidth requirements have been determined and the study of sidelink communication in unlicensed spectrum has progressed, it can be reviewed whether unlicensed spectrum can be considered in further work. Checkpoint at RAN #97 to see if sufficient information is available for this review.

One or more agreements of RAN1 #109-e on sidelink positioning are provided in RAN1 Chair's Notes of 3GPP TSG RAN WG1 #109-e, one or more parts of which are quoted below:

### Agreement

For SL positioning evaluation, simulation bandwidths of 10, 20, 40 and 100 MHz in FR1 can be used.
For SL positioning evaluation, simulation bandwidths of 100, 200 and 400 MHz in FR2 can be used.

### Agreement

With regards to the Positioning methods supported using SL measurements study further the following methods:
RTT-type solutions using SL
   Study both single-sided (also known as one-way) and double-sided (also known as two-way) RTT
SL-AoA
   Include both Azimuth of arrival (AoA) and zenith of arrival (ZoA) in the study
SL-TDOA
SL-AoD
   Corresponds to a method where RSRP and/or RSRPP measurements similar to the DL-AoD method in Uu.
   Include both Azimuth of departure (AoD) and zenith of departure (ZoD) in the study
Consider in the study at least the following aspects:
Definition(s) of the corresponding SL measurements for each method
Which method is applicable to absolute or relative positioning or ranging, including whether such categorization is needed to be discussed.

### Agreement

Study new reference signal for SL positioning/ranging using the existing PRS/SRS design and SL design framework as a starting point.
The study could at least include: Sequence design, frequency domain pattern, time domain pattern (e.g. number of symbols, repetitions, etc), time domain behavior, configuration/triggering/activation/de-activation of the SL-PRS, AGC time, Tx-Rx Turanround time, supportable bandwidth(s), multiplexing options with other SL channels, randomization/orthogonalization options.

### Agreement

With regards to the configuration/activation/deactivation/triggering of SL-PRS, study the following options:
Option 1: High-layer-only signaling involvement in the SL-PRS configuration
   No Lower layer involvement, e.g., SL-MAC-CE or SCI or DCI, for the activation or the triggering of a SL-PRS.
Option 2: High-layer and lower-layer signaling involvement in the SL-PRS configuration
   Lower-layer may correspond to SL-MAC-CE, or SCI, or DCI
Option 3: Only lower-layer signaling involvement in the SL-PRS configuration
   Lower-layer may correspond to SL-MAC-CE, or SCI, or DCI

### Agreement

With regards to the Sidelink Positioning measurement report,
Study the contents of the measurement report (e.g. time stamp(s), quality metric(s), ID(s), angular/timing/power measurements, etc)
Study the time domain behavior of the measurement report (e.g. one-shot, triggered, aperiodic, semi-persistent, periodic)
FFS whether the Sidelink Positioning measurement can be a high-layer report and/or a lower layer report.

### Agreement

For the purpose of RAN1 discussion during this study item, at least the following terminology is used:
Target UE: UE to be positioned (in this context, using SL, i.e. PC5 interface).
Sidelink positioning: Positioning UE using reference signals transmitted over SL, i.e., PC5 interface, to obtain absolute position, relative position, or ranging information.
Ranging: determination of the distance and/or the direction between a UE and another entity, e.g., anchor UE.
Sidelink positioning reference signal (SL PRS): reference signal transmitted over SL for positioning purposes.
SL PRS (pre-)configuration: (pre-)configured parameters of SL PRS such as time-frequency resources (other parameters are not precluded) including its bandwidth and periodicity.
Continue discussion on additional terminology clarification(s) such as: Initiator UE, Responder UE, Sidelink Positioning group, reference UE, etc, including whether such terminology is needed within RAN1 discussion.

### Agreement

For the purpose of RAN1 discussion during this study item, at least the following terminology is used:
Anchor UE: UE supporting positioning of target UE, e.g., by transmitting and/or receiving reference signals for positioning, providing positioning-related information, etc., over the SL interface.
   FFS: clarification of the knowledge of the location of the anchor UE

### Agreement

With regards to the frequency domain pattern, study further a Comb-N SL-PRS design. Study at least the following aspects:
N>=1 (where N=1 corresponds to full RE mapping pattern)
Fully staggered SL-PRS pattern (e.g., M symbols of SL-PRS with comb-N with M=N and, at each symbol a different RE offset is used), Partially staggered SL-PRS pattern (e.g., M symbol(s) of SL-PRS with comb-N, with M<N, at each symbol a different RE offset is used), Unstaggered SL-PRS patterns (e.g., M symbol(s) of SL-PRS with comb-N, at each symbol a same RE offset is used, N>1)
The number of symbols of SL-PRS within a slot
   Any relation to the comb-N option
   RE offset pattern repetitions within a slot

### Agreement

For a potential new SL PRS, study further the following
   Number of symbol(s) for AGC and/or Rx-Tx turnaround time
   Conditions under which AGC training and/or Rx-Tx turnaround time are needed

### Agreement

With regards to the SL Positioning resource allocation, study further the following 2 options for SL Positioning resource (pre-)configuration:
Option 1: Dedicated resource pool for SL-PRS
   Include in the study at least the following aspects:
      which slots can be used, SL frame structure, SL positioning slot structure, multiplexing of SL-PRS with control information (if included in the same slot)
      positioning measurement report
      whether a dedicated frequency allocation (e.g., layer/BWP) is needed for SL PRS
      resource allocation procedure(s) of SL-PRS
      This option may or may not include control information (i.e., configuration/activation/deactivation/triggering of SL-PRS) for the purpose of SL positioning operation
Option 2: Shared resource pool with sidelink communication.
   Include in the study at least the following aspects:
      co-existence between SL communication and SL positioning, backward compatibility
      Multiplexing considerations of SL-PRS with other PHY channels (PSCCH, PSSCH, PSFCH) and any modifications in the SL-slot structure Agreement
         With regards to the SL-PRS resource allocation, study the following two schemes:
Scheme 1: Network-centric operation SL-PRS resource allocation (e.g. similar to a legacy Mode 1 solution)
   The network (e.g. gNB, LMF, gNB & LMF) allocates resources for SL-PRS
Scheme 2: UE autonomous SL-PRS resource allocation (e.g. similar to legacy Mode 2 solution)
   At least one of the UE(s) participating in the sidelink positioning operation allocates resources for SL-PRS
   Applicable regardless of the network coverage

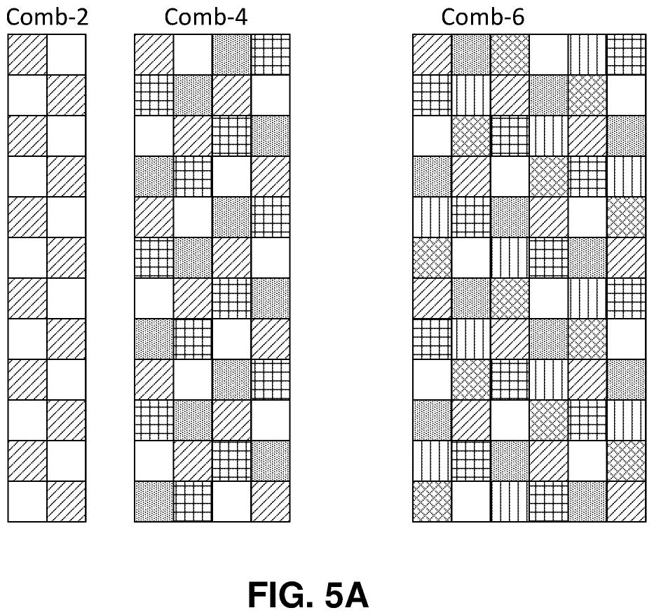

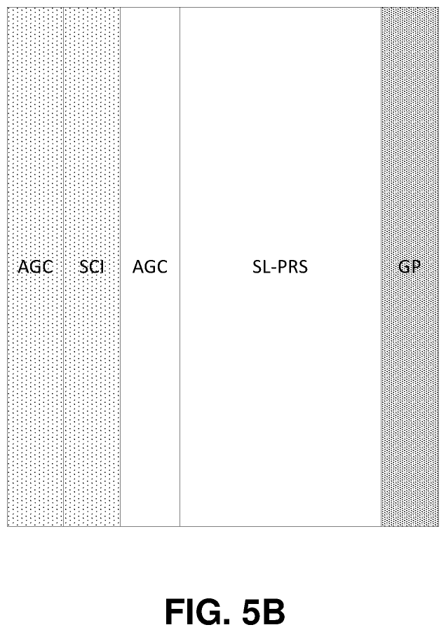

Sidelink positioning is discussed in R1-2203566. Notably, FIG. 1 of Section 3.3 of R1-2203566, entitled “The DL-PRS pattern”, is reproduced herein as FIG. 5A. FIG. 2 of Section 3.4 of R1-2203566, entitled “the slot format of SL-PRS”, is reproduced herein as FIG. 5B.

### 2.1 Rel-16 Positioning Techniques

In this section, we evaluate whether those methodologies can be solutions for SL positioning of relative positioning, ranging, and absolute positioning.

TABLE 1
The positioning techniques for achieving relative positioning, ranging,
and absolute positioning

| | | ranging | ranging | |
|---|---|---|---|---|
| | relative | for | for | |
| | positioning | distance | angle | absolute positioning |
| RTT | x | ✓ | x | x |
| Multi-RTT | | | x | ✓ when multiple nodes' |
| | | | | locations (i.e., RSU) |
| | | | | can be known |
| TDOA | | | x | ✓ when multiple nodes' |
| | | | | locations (i.e., RSU) can |
| | | | | be known |
| AoA | | | ✓ | |
| AoD | | | ✓ | |
| RTT + AoA | ✓ | ✓ | ✓ | ✓ when one UE's location |
| | | | | is known |
| RTT with | ✓ | ✓ | ✓ | |
| Multi-panel | | | | |

### 3.3 SL-PRS Pattern

Secondly, in Rel-16, the pattern of DL PRS can be referred, including the comb size K_{comb}^{PRS}∈ {2, 4, 6, 12} as the following FIG. 3, and the combination { L_{PRS}, K_{comb}^{PRS}} is one of {2, 2}, {4, 2}, {6, 2}, {12, 2}, {4, 4}, {12, 41, 16, 6}, {12, 6} and {12, 12}.

### FIG. 1 the DL-PRS Pattern

For us, reusing one or more comb sizes of DL-PRS for SL-PRS is reasonable. In addition, considering SL structure (e.g, excluding the PSCCH symbol, AGC, or GP symbol for SL-PRS transmission), the number of PRS (ie. L_{PRS} ∈ {2, 4, 6, 12}) may need to be enhanced for SL-PRS transmission. For example, 12 symbols are impossible for SL-PRS transmission if 2 or more symbols are assumed to be PSCCH, AGC and GP. And given the limited communication range between UEs for SL positioning, we think partial staggered pattern can be supported in SL-PRS.

### Proposal 3:

Support reuse of one or more comb sizes of DL-PRS for the SL-PRS pattern.
Partial staggered pattern can be considered for SL-PRS pattern considering SL structure (e.g, excluding the PSCCH symbol, AGC, or GP symbol for SL-PRS transmission)

### 3.4 SL-PRS Format

With the analysis of SL-PRS, multiplexing SL-PRS onto PSSCH will reduce the positioning performance. Transmitting SL-PRS within PSSCH bandwidth is also difficult to guarantee the positioning accuracy. So, we prefer to transmit SL-PRS without PSSCH transmission in the resource pool.
In this case, we provide a potential slot format for SL-PRS design as FIG. 2. Considering autonomous resource allocation, the SCI at least for sensing should be transmitted with SL-PRS, which would reduce the probability of collision with other transmissions. And the receiver can receive the PRS according to the scheduling of the SCI.

### FIG. 2 the Slot Format of SL-PRS

In legacy NR sidelink, only slot level transmission is supported. In our opinion, the slot level SL PRS transmission should be supported at least as the baseline. Therefore, we propose

### Proposal 5:

SL PRS can be transmitted without PSSCH transmission in the resource pool.
SCI should be transmitted with the associated SL PRS.
Slot level SL PRS transmission should be supported.

### 3.5 Resource Pool for SL-PRS

For the resource pool or BWP of SL PRS, we think it should be discussed. In NR SL, only one SL BWP is supported on a carrier. And resource pool is configured in the BWP. In our opinion, the SL PRS is transmitted in the BWP, and restricted in a resource pool. There are the following alternatives for SL PRS transmission in a resource pool.
Alt 1. Dedicated resource pool for SL PRS and potential associated PSCCH.
Alt 2. Shared resource pool for SL PRS and legacy PSCCH/PSSCH/PSFCH, etc.
   For Alt 1, it would be straightforward for SL PRS transmission, and the impact on the R16/R17 SL transmission is small. However, it might decrease the frequency efficiency on that SL carrier. For Alt 2, the backward compatibility for legacy SL transmission should be considered. The bandwidth of SL PRS may exceed the bandwidth of the PSSCH in order to satisfy the positioning accuracy, which would have an impact on the legacy SL transmission. Considering both alternatives having pros and cons, we slightly prefer alt 1 for SL PRS transmission.

### Proposal 6:

A dedicated resource pool should be studied for SL PRS transmission in Rel-18.

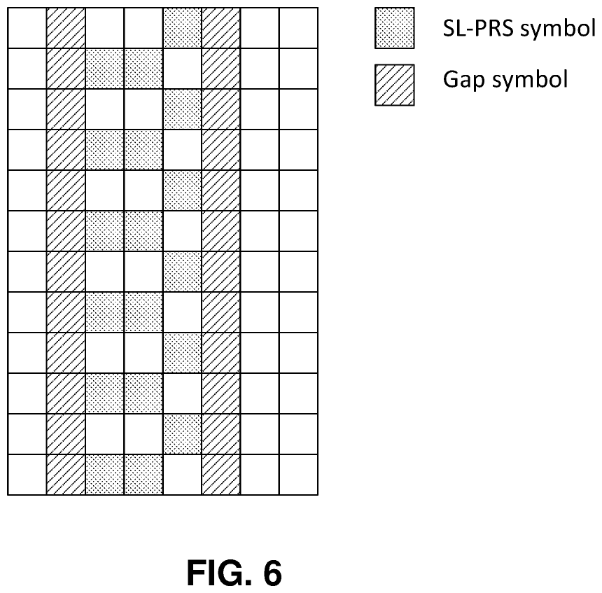

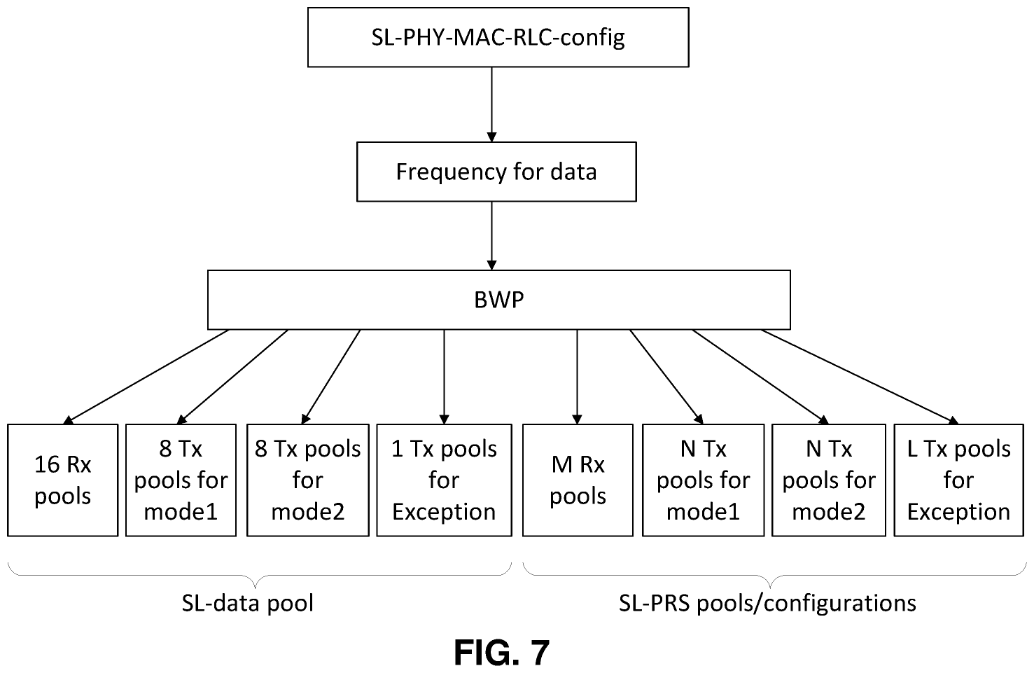

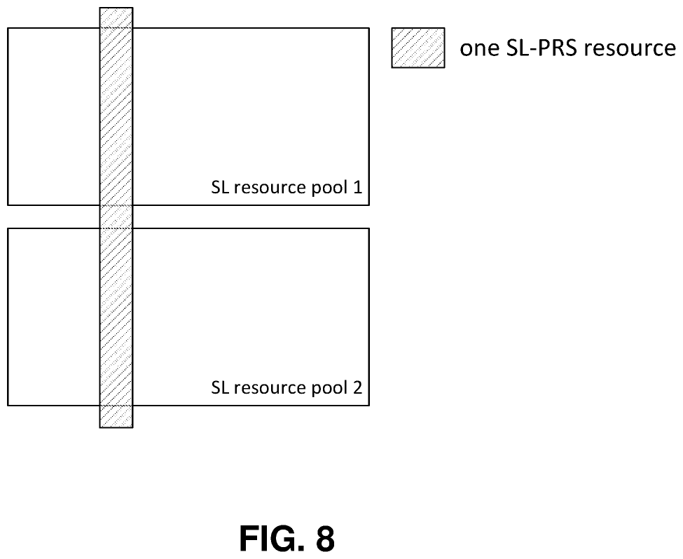

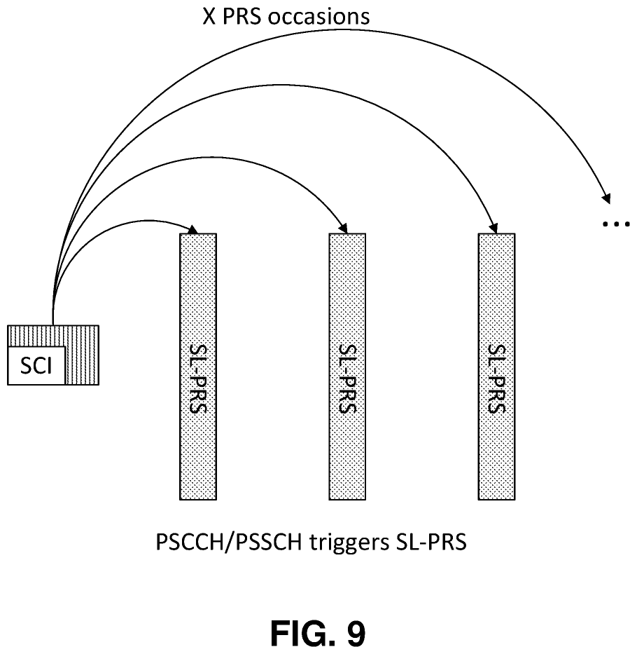

Sidelink positioning is discussed in R1-2203624. Notably, FIG. 2.2.1-2 of Section 2.2.1 of R1-2203624, entitled “one example of SL-PRS pattern (comb-2; 2+3 symbols)”, is reproduced herein as FIG. 6. FIG. 2.2.2-1 of Section 2.2.2 of R1-2203624, entitled “Dedicated SL-PRS configuration—resource pool level”, is reproduced herein as FIG. 7. FIG. 2.2.2-2 of Section 2.2.2 of R1-2203624, entitled “Extending SL-PRS outside the SL resource pool”, is reproduced herein as FIG. 8. FIG. 2.2.2-3 of Section 2.2.2 of R1-2203624, entitled “SCI triggers X SL-PRS occasions”, is reproduced herein as FIG. 9.

### 2.2 Reference Signals for SL Positioning

### 2.2.1 RS Design

The design of SL-PRS (sidelink positioning reference signal) is one of an essential and key part of the NR sidelink positioning system. In order to meet the positioning accuracy requirement and reduce complexity, DL-PRS like signals can be considered. Specifically, the following aspects should be considered for SL-PRS design referring to the DL-PRS configuration [5]:
Sequence: gold sequence or ZC (Zadoff-Chu) sequence
   Gold sequence is preferable to align with sidelink CSI-RS design.
SL-PRS Pattern
   Comb size
   Number of OFDM symbols within a slot
Periodicity: specify the periodicity of SL-PRS and the modification based on the DL-PRS's periodicity.
Repetition
   Proposal 2: For SL-PRS design, consider DL-PRS like signals to reduce the specification complexity.
   In addition, like other sidelink channel design, gap symbol(s) may be needed before and/or after SL-PRS symbols for Rx/Tx switch. Moreover, in comparison to the SL-data/PSSCH, the transmit power and power control of the SL-PRS may be different. Considering the AGC issue, one AGC symbol is also needed before the SL-PRS symbols and after the gap symbol before SL-PRS if configured to assist the UE receiver's AGC tuning, this AGC symbol is a repetition of the first SL-PRS symbol which is the actual starting symbol. To sum up, we can consider adding extra symbols (AGC symbol and gap symbol) for SL-PRS. The number of SL-PRS symbols within a slot can be flexibly configured: {2+⅔, 4+⅔, 6+⅔, 12+⅔, . . . }. One example of SL-PRS pattern considering comb size and symbol numbers are shown in FIG. 2.2.1-2.

### FIG. 2.2.1-2: One Example of SL-PRS Pattern (Comb-2; 2+3 Symbols)

Proposal 4: For the number of OFDM symbols within a slot for SL-PRS, consider adding AGC symbol for power adjustment and gap symbol(s) for Rx/Tx switch.

### 2.2.2 SL-PRS Configuration

It is well known that large bandwidth is required for high-accuracy positioning if timing based positioning methods are used, in other words, the larger the bandwidth, the higher the positioning accuracy. However, current sidelink RS in Rel-15/16 is always configured and limited within the bandwidth of PSSCH/SL-data resource pool. If the SL-PRS is configured similarly as current sidelink RS within the frequency range of PSSCH, it is difficult to satisfy the positioning requirement. Therefore, we need to consider solutions for large bandwidth SL-PRS configuration.
Observation 2: If the SL-PRS is configured within the bandwidth of PSSCH, it is difficult to satisfy the positioning requirement.
In Rel-15/16, NR sidelink resource pool is a set of time and frequency resources that can be used for sidelink transmission and/or reception. A UE can be (pre)configured by higher layers with one or more sidelink resource pool. The hierarchical sidelink resource configuration is SL Frequency-->SL BWP-->SL resource pool according to TS 38.331 [6]. Moreover, only one BWP is allowed to be configured on one carrier frequency for NR sidelink communication and this particular one BWP is used for both transmission and reception.
For SL-PRS resources (pre)configuration, in our understanding, there are two options as below.

### (1) Dedicated SL-PRS Configuration

In this option, SL-PRS resources can be (pre)configured separately from SL resource pool on the carrier frequency level or BWP level or resource pool level. For carrier frequency level or BWP level SL-PRS resource configuration, we can separately define carrier frequency for SL-PRS and BWP for SL-PRS like as Rel-16/17 DL-PRS frequency layer. This may not be necessary since currently there is only one carrier frequency and one BWP supported for data in order to avoid the situation that one UE has to transmit or receive sidelink data on multiple BWPs simultaneously since group-cast and broadcast is supported. For resource pool level configuration as shown in FIG. 2.2.2-1, the SL-PRS and SL-data belong to the same BWP but different resource pool configuration. Each pool/configuration can occupy a part of the BWP resource including time and frequency resources.

### FIG. 2.2.2-1: Dedicated SL-PRS Configuration—Resource Pool Level

If dedicated SL-PRS configuration is applied, we can allocate larger frequency bandwidth for SL-PRS for positioning accuracy improvement. In this case, the frequency range of SL-PRS can be larger than PSSCH, one SL-PRS resource may be associated with one or more SL-data resource(s). There are some relationships between SL-PRS resource configuration and SL-data resource pools need further be considered as SL-PRS may be triggered by SCI.

### (2) Configure SL-PRS in SL Resource Pool

SL-PRS resources can also be configured in SL resource pool, in other words, SL-PRS and SL-data transmission/reception share the same resource pools and same logic slots. However, as we clarified in the beginning of this section, large bandwidth is required for high-accuracy positioning. Therefore, extending SL-PRS outside the SL resource pool in terms of frequency domain should be considered to satisfy the positioning accuracy requirement. FIG. 2.2.2-2 shows that even though the SL-PRS is configured in one SL resource pool, the frequency domain range of SL-PRS can be larger than two (or one or several) SL resource pools.

### FIG. 2.2.2-2: Extending SL-PRS Outside the SL Resource Pool

Proposal 5: For SL-PRS resource configuration, we are open to study the following options:
Alt 1: Dedicated SL-PRS configuration
   SL-PRS configuration is separate from SL resource pool.
Alt 2: SL-PRS is configured in SL resource pool
   Therefore, in our understanding, using SCI to schedule SL-PRS is preferred. A UE can use SCI to request or transmit SL-PRS configuration to other UE. A UE can detect SCI to further obtain the SL-PRS related information and one SCI may schedule multiple SL-PRS occasions for overhead reduction as shown in FIG. 2.2.2-3. Also, we need consider 2 cases if SCI triggering SL-PRS is supported: SCI can schedule both SL-PRS and SL-data; SCI can either schedule SL-PRS or SL-data.

### FIG. 2.2.2-3 SCI Triggers X SL-PRS Occasions

Proposal 6: Support using SCI to trigger SL-PRS and consider the following 2 cases:
SCI can schedule both SL-PRS and SL-data;
SCI can either schedule SL-PRS or SL-data.

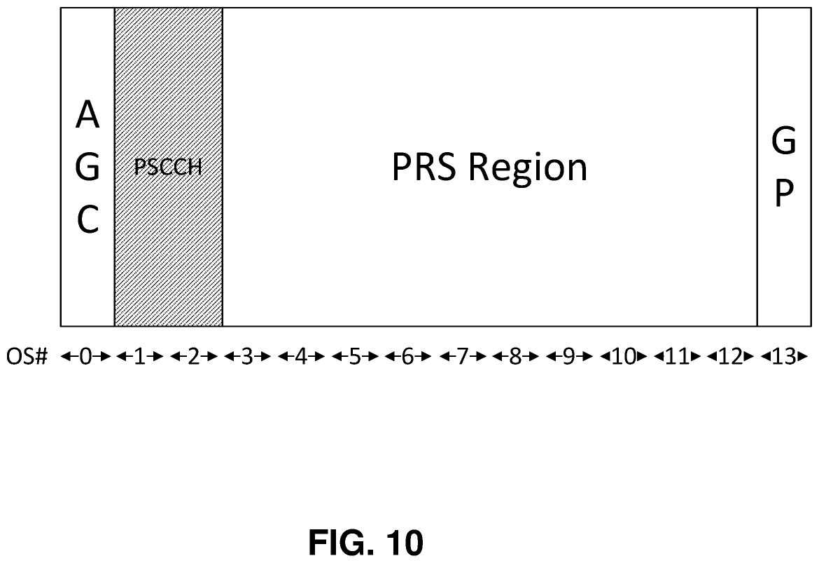

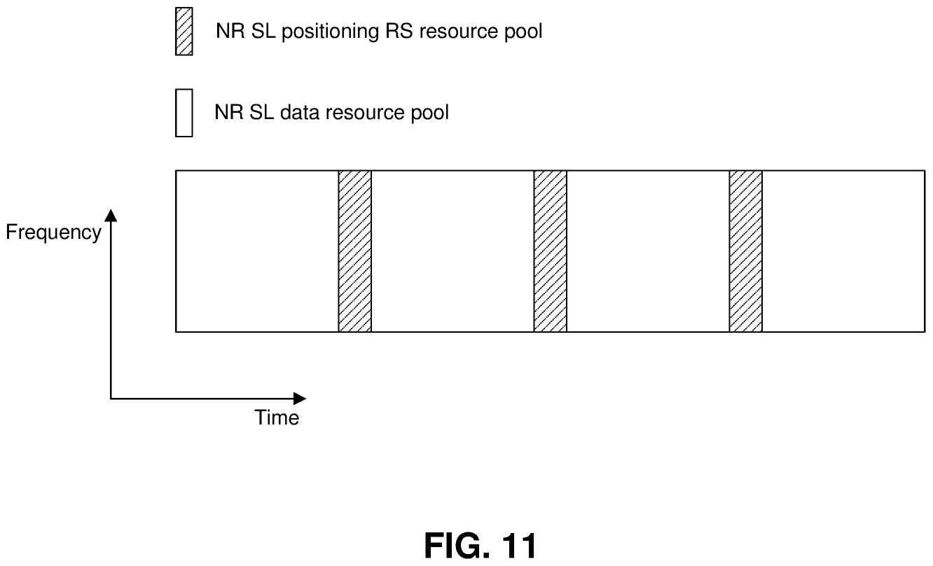

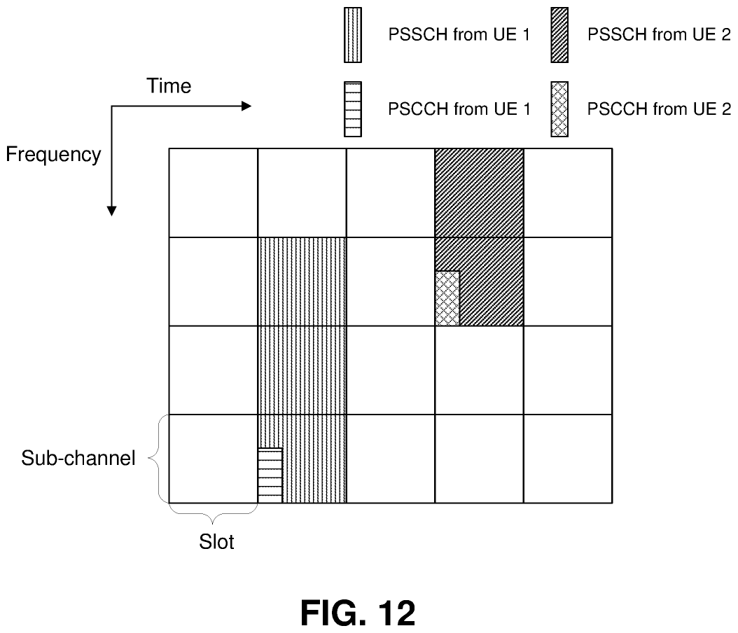

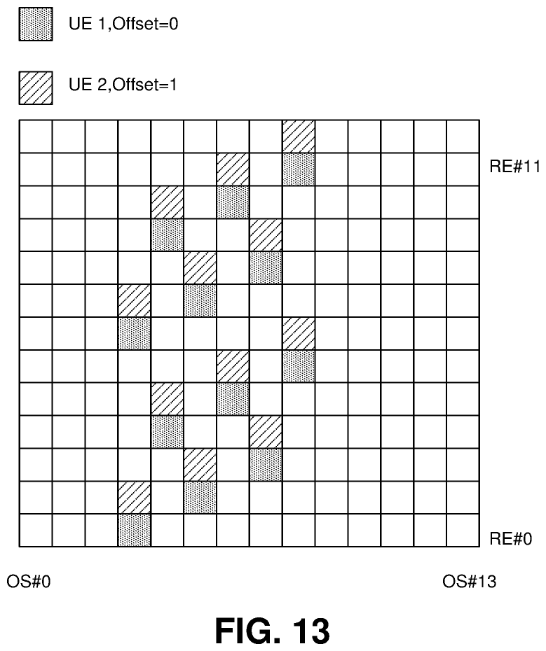

Sidelink positioning is discussed in R1-2204310. Notably, FIG. 5 of Section 3 of R1-2204310, entitled “Potential slot structure of SL positioning RS slot”, is reproduced herein as FIG. 10. FIG. 6 of Section 3 of R1-2204310, entitled “TDM resource pool configuration b/w data and positioning RS”, is reproduced herein as FIG. 11. FIG. 7 of Section 3 of R1-2204310, entitled “Illustration of PSCCH and PSSCH resource in NR sidelink”, is reproduced herein as FIG. 12. FIG. 8 of Section 3 of R1-2204310, entitled “Illustration for RE level multiplexing b/w positioning RS from different UEs”, is reproduced herein as FIG. 13.

### 3. Sidelink Positioning RS

### Design Baseline (PRS or SRS-Pos)

In Uu positioning, PRS is transmitted in downlink and used by UE to do measurement for the purpose of positioning; SRS-Pos is transmitted in uplink and used by TRP to do measurement for positioning. The advantage of using PRS is that it follows the design principle of using downlink signals as reference in NR sidelink; however, the advantage of using SRS-Pos is that it can provide lower PAPR. Thus, from our point of view, neither of these two should be precluded at this stage, RAN1 should further study which one should be used as design baseline for sidelink positioning RS. Another aspect should be considered is that which type of RS in time domain should be supported in Rel-18, including periodic, semi-persistent, and aperiodic.
Proposal 5: RAN1 should further study which signal should be used as design baseline for sidelink positioning RS, b/w PRS and SRS-Pos.
Proposal 6: RAN1 should further study which type of RS in time domain should be supported in Rel-18, including periodic, semi-persistent, and aperiodic.

### PHY Structure of Sidelink Positioning RS

In a NR sidelink slot, for each sidelink signal/channel, the first symbol is a copy of the second one for the purpose of AGC. Besides, the last symbol is used as a guard for Tx/Rx switching. Moreover, PSCCH may be needed in a SL positioning RS transmission slot, which will be introduced in latter part of this tdoc, 2 or 3 symbols are needed due to resource pool configuration, then, the remaining symbols can be regarded as candidate for sidelink positioning RS.

### FIG. 3 Potential Slot Structure of SL Positioning RS Slot

Proposal 7: Slot structure in NR sidelink should be reused as much as possible for sidelink positioning RS slot, which including AGC symbol, GP symbol and the potential PSCCH symbols, the remaining symbols can be regarded as candidates for positioning RS.
For positioning RS, the design in sidelink cannot be supported as so much flexible as NR Uu, because without gNB scheduling, some big issues may be caused such as resource collision, AGC performance degradation, and so on. This issue may have bad impacts on the positioning performance. Therefore, we propose to live the parameters of SL positioning RS, e.g., number of symbols, RS comb size, and RS BW, with resource pool level configuration. Furthermore, for the RS BW, RAN1 should further evaluate whether it should be directly equal to the bandwidth of the BWP or resource pool, in order to provide higher positioning accuracy. On the other hand, since there is only one BWP can be supported in sidelink, the configuration of SL positioning RS should be tied to BWP.
Proposal 8: Parameters of SL positioning RS, e.g., number of symbols, RS comb size, and RS BW, should be (pre)configured on resource pool level.
Proposal 9: Configuration of SL positioning RS should be tied to BWP.
In NR sidelink, available resources are restricted by resource pool. If SL positioning RS can be multiplexed with data in a same resource pool, more collision will be additionally caused due to resource overlap b/w RS and data. Therefore, it is more appropriate to configure a separate resource pool for SL positioning RS from our point of views. Moreover, to avoid introducing the issue for processing data and positioning RS simultaneously again in Rel-18, we propose to only support TDM configuration b/w SL data resource pool and positioning RS resource pool.

### FIG. 4 TDM Resource Pool Configuration b/w Data and Positioning RS

Proposal 10: In Rel-18, dedicated resource pool for SL positioning RS should be (pre)configured other than multiplexing with data in a same resource pool, and only TDM configuration is supported for SL data and positioning RS resource pools.

### Resource Allocation for Sidelink Positioning RS

As aforementioned, a dedicated resource pool is (pre-)configured for SL positioning RS. In such a case, one open issue is whether the SL positioning RS is a standalone RS as defined in Uu positioning, or transmitted along with PSCCH as defined in NR sidelink. In our views, the transmission of sidelink positioning RS should inherit the framework of NR sidelink. The reasons are twofold. First, SL positioning RS associated with PSCCH can make the design for both Model and Mode 2 resource allocation mechanisms unified. In addition, the associated PSCCH of PSSCH can be used to reserve further resources and mitigate the resource collision possibility by performing resource selection procedure; otherwise, resource collision b/w different UEs' positioning RS may also happen frequently if only standalone RS is transmitted.
Proposal 11: SL positioning RS should also be transmitted along with PSCCH to reserve further resources and mitigate the resource collision possibility.
In NR sidelink, the starting position of the frequency domain of the PSCCH is the lowest PRB of the lowest sub-channel of the scheduled PSSCH, thus a relationship between PSCCH and PSSCH resource is established. However, RE level resource multiplexing is supported in frequency domain for the positioning RS defined in NR positioning, which is quite different from the framework in NR sidelink where only sub-channel level multiplexing is supported. Then, multiplexing rule b/w PSCCH and positioning RS resources may need to be re-designed for NR SL positioning.

### FIG. 5 Illustration of PSCCH and PSSCH Resource in NR Sidelink

FIG. 6 Illustration for RE Level Multiplexing b/w Positioning RS from Different UEs

Proposal 12: Multiplexing rule b/w PSCCH and positioning RS resources may need to be re-designed for NR SL positioning.

In New Radio (NR) Release 17 (Rel-17), positioning on Uu interface, between network and device, is discussed and/or introduced. Reference Signals (RSs) may be used for supporting one or more NR features. Downlink (DL) Positioning Reference Signal (PRS), and Uplink (UL) Sounding Reference Signal-Positioning (SRS-Pos) may be indicated and/or used as Positioning RS for supporting NR positioning functionality. Some positioning methods are introduced, such as Time Difference of Arrival (TDOA), Round Trip Time (RTT), Angle of Arrival (AoA), and/or Angle of Departure (AoD). For time-based positioning methods, larger bandwidth for PRS (which may also be referred to as Positioning RS) may be required for higher accuracy positioning.

In NR Release 18 (Rel-18), a study on “NR Positioning Enhancements” may investigate higher accuracy, lower latency location, high integrity and/or reliability requirements resulting from new applications and industry verticals for 5G (discussed in RP-213588, for example). NR Rel-18 may (also) study feasibility of potential solutions for Sidelink (SL) positioning, considering relative positioning, ranging and/or absolute positioning, wherein the SL positioning may be operated in device-to-device interface (e.g., PC5-interface between device and device). The device may correspond to a User Equipment (UE).

In RAN1 #109-e meeting discussed in RAN1 Chair's Notes of 3GPP TSG RAN WG1 #109-e, RAN1 may study RTT-type solutions using SL, SL-AoA, SL-TDOA, SL-AoD with regard to Positioning methods supported using SL measurements. Accordingly, a reference signal (e.g., a new reference signal) for SL positioning/ranging may be introduced based on DL PRS design and/or UL SRS-Pos design and/or SL design framework (e.g., the DL PRS design, the UL SRS-Pos design and/or the SL design framework may be used as a starting point for the reference signal). The reference signal (e.g., the new reference signal) for SL positioning/ranging may be noted as SL PRS.

For sidelink design in NR Rel-16 and/or Rel-17, sidelink slots can be utilized for transmission and/or reception of Physical Sidelink Broadcast Channel (PSBCH) and/or transmission and/or reception of Physical Sidelink Control Channel (PSCCH)/Physical Sidelink Shared Channel (PSSCH)/Physical Sidelink Feedback Channel (PSFCH). In the present disclosure, the term “PSCCH/PSSCH/PSFCH” may refer to PSCCH, PSSCH and/or PSFCH. In some examples, PSBCH may be multiplexed (e.g., time division multiplexed (TDMed)), in slot level, from PSCCH/PSSCH/PSFCH (which may mean that sidelink slots, excluding slots for PSBCH, can be utilized for PSCCH/PSSCH/PSFCH transmission/reception). Alternatively and/or additionally, concept of sidelink resource pool with sidelink communication may be utilized for PSCCH/PSSCH and/or/PSFCH transmission/reception. A sidelink resource pool may comprise a set of sidelink slot (except slots for PSBCH) and a set of frequency resources. Different sidelink resource pools may be multiplexed (e.g., TDMed and/or frequency division multiplexed (FDMed)). In an example, a PSCCH in a sidelink resource pool (e.g., one sidelink resource pool) can schedule PSSCH resource(s) (e.g., only PSSCH resource(s)) in the same sidelink resource pool (e.g., the one sidelink resource pool). In some examples, a PSCCH in a sidelink resource pool (e.g., one sidelink resource pool) is not able to schedule PSSCH resource(s) in other sidelink resource pool. For a PSCCH/PSSCH, associated PSFCH (e.g., a PSFCH associated with the PSCCH/PSSCH) may be in the same sidelink resource pool (as the PSCCH/PSSCH, for example), instead of in different sidelink resource pools.

A sidelink resource pool (e.g., one sidelink resource pool) may comprise multiple sub-channels in frequency domain, wherein a sub-channel comprises multiple contiguous Physical Resource Blocks (PRBs) in frequency domain. A PRB (e.g., one PRB) may comprise multiple Resource Elements (REs) (e.g., a PRB (e.g., one PRB) may consist of 12 REs). A configuration of the sidelink resource pool may indicate the number of PRBs of each sub-channel in the (corresponding) sidelink resource pool. Sub-channel based resource allocation in frequency domain may be supported for PSSCH. For a PSSCH resource scheduled by a PSCCH in the same sidelink slot, a fixed relationship between the PSCCH and the PSSCH resource may be indicated (e.g., specified) and/or defined, which may mean that the PSCCH may be located in the lowest sub-channel (e.g., sub-channel with lowest index) of the scheduled PSSCH resource. Thus, when a Receiver UE (RX UE) receives a PSCCH in a sub-channel of a sidelink resource pool (e.g., one sub-channel of one sidelink resource pool), starting frequency position of scheduled PSSCH resource in the same sidelink slot will be the one sub-channel. As for scheduled PSSCH resource in different slot(s), starting frequency position of the scheduled PSSCH resource will be scheduled/indicated by sidelink control information, instead of fixed relationship.

In some examples, in sidelink design of NR Rel-16 and/or Rel-17, a sidelink control information (SCI) (e.g., one SCI) may indicate at most three PSSCH resources via Frequency resource assignment and/or Time resource assignment in the SCI. The SCI may comprise a 1st stage SCI and a 2nd stage SCI. The 1st stage SCI may be transmitted via PSCCH. The 2nd stage SCI may be transmitted via multiplexed with a scheduled PSSCH resource (e.g., scheduled via the 1st stage SCI and/or other signal) in the same sidelink slot (e.g., the same slot as the 1st stage SCI). In an example, the scheduled PSSCH resource may correspond to a first PSSCH resource of the at most three PSSCH resources. For example, the SCI may schedule at most two PSSCH resources (e.g., a second PSSCH resource and/or a third PSSCH resource) in later sidelink slots (e.g., one or more slots after the slot in which the 1st stage SCI and/or the 2nd stage SCI are transmitted). The at most three PSSCH resources may be in different slots in a sidelink resource pool. The at most three PSSCH resources may be within 32 consecutive slots in a sidelink resource pool (e.g., a difference in time between an initial PSSCH resource of the three PSSCH resources and a last PSSCH resource of the three PSSCH resource may not be over a time period corresponding to 32 consecutive slots). The at most three PSSCH resources may be associated with a same data packet, e.g., a same Transport Block (TB) and/or a same Medium Access Control (MAC) Protocol/Packet Data Unit (PDU).

When a RX UE receives the SCI (e.g., the one SCI) in a slot (e.g., a defined and/or specific slot), the slot (e.g., the defined and/or specific slot) may be a reference slot for determining the 32 consecutive slots in a sidelink resource pool. In an example, the slot (e.g., the defined and/or specific slot) may correspond to an initial slot of the 32 consecutive slots. The first PSSCH resource is in the slot (e.g., the defined and/or specific slot) where the SCI (e.g., the one SCI) is received. A starting sub-channel of the first PSSCH resource may be the sub-channel in which the PSCCH is received. Time resource assignment in the SCI may indicate a time resource indicator value (TRIV). Frequency resource assignment may indicate a frequency resource indicator value (FRIV). In an example in which a configuration of maximum number per reserve is 2 (e.g., maximum number of resources reserved by a resource reservation may be 2), a FRIV (e.g., one FRIV) may provide information of one starting sub-channel (for the second PSSCH resource, for example) and a number of sub-channel L_{subCH} (for each of the two PSSCH resources, for example). In an example in which a configuration of maximum number per reserve is 3 (e.g., maximum number of resources reserved by a resource reservation may be 3), a FRIV (e.g., one FRIV) may provide information of one or two starting sub-channels (for the second PSSCH resource and/or the third PSSCH resource respectively, for example) and a number of sub-channels L_{subCH} (for each of the three PSSCH resources, for example).

In NR sidelink resource allocation mode 1, the network node may transmit a sidelink grant (e.g., Downlink Control Information (DCI) format 3_0 on Uu interface) for indicating at most three PSSCH resources (for a same data packet, for example). The sidelink grant may comprise a “time gap” field and/or one or more “Lowest index of the subchannel allocation to the initial transmission” fields for indicating the first PSSCH resource and/or the PSCCH resource in the defined slot. The sidelink grant may (e.g., also) comprise a “Frequency resource assignment” field and/or a “Time resource assignment” field for indicating the second PSSCH resource and/or the third PSSCH resource (if any).

Alternatively and/or additionally, resource reservation for a TB (e.g., another TB) by a SCI may be configured (e.g., pre-configured) with enabled or not enabled or not configured in a sidelink resource pool (e.g., resource reservation for the TB may be enabled and/or configured for the sidelink resource pool and/or resource reservation for the TB may not be enabled and/or may not be configured for the sidelink resource pool). In some examples, in a sidelink resource pool, whether resource reservation by a SCI for another TB is enabled, is not enabled or is not configured, may be configured (e.g., whether the resource reservation is enabled, not enabled or not configured for the sidelink resource pool may be pre-configured for the sidelink resource pool). When a sidelink resource pool is configured (e.g., pre-configured) with enablement of such resource reservation (e.g., when the resource reservation is enabled for the sidelink resource pool), the sidelink resource pool is configured with a set of reservation period values. In an example, the set of reservation period values (e.g., a set of one or more reservation period values) may comprise 0 milliseconds, 1:99 milliseconds (e.g., a value in the range of at least 1 millisecond to at most 99 milliseconds, 100 milliseconds, 200 milliseconds, 300 milliseconds, 400 milliseconds, 500 milliseconds, 600 milliseconds, 700 milliseconds, 800 milliseconds, 900 milliseconds, and/or 1000 milliseconds. In some examples, a resource reservation period field in a SCI in the sidelink resource pool may indicate one or more reservation period values for one or more resource reservations (e.g., the resource reservation period field may be indicative of which reservation period value to use for a future resource reservation). In some examples, a size of the set of reservation period values (e.g., a number of values of the set of reservation period values) may be from 1 to 16 (e.g., the set of reservation period values may comprise at most 16 reservation period values).

A new reference signal for SL positioning/ranging, noted as SL PRS, may be introduced for NR positioning enhancements (as described in the foregoing description, for example). For supporting time-based positioning methods, larger bandwidth for SL PRS may be required for higher accuracy positioning. It may be possible that the required bandwidth for SL PRS may be 10 megahertz (MHz), 20 MHz, or even more. Such a larger bandwidth will be hard to be multiplexed with PSCCH/PSSCH, and even hard to be confined within a sidelink resource pool (e.g., one sidelink resource pool) with PSCCH/PSSCH resources. Thus, with regard to the SL Positioning resource allocation (discussed in RAN1 Chair's Notes of 3GPP TSG RAN WG1 #109-e, for example), RAN1 may study (e.g., further study) (i) Option 1: Dedicated resource pool for SL PRS and (ii) Option 2: Shared resource pool with sidelink communication (e.g., PSCCH, PSSCH and/or PSFCH). Alternatively and/or additionally, some sidelink control information may be provided by Transmitter UE (TX UE) for scheduling/indicating/allocating SL PRS resources, in order to let RX UE know where and/or when to receive and/or measure corresponding SL PRS. In the present disclosure, the term “scheduling/indicating/allocating” may refer to scheduling, indicating and/or allocating. The sidelink control information for scheduling/indicating/allocating SL PRS resources may be multiplexed in the dedicated resource pool for SL PRS of Option 1, and/or be transmitted on PSCCH in other sidelink resource pool with sidelink communication.

Alternatively and/or additionally, given a larger bandwidth requirement of SL PRS, Comb-N SL PRS design may be supported for providing more available SL PRS resources, and/or a configured and/or adjusted symbol number (e.g., adjustable and/or configurable symbol number) may be supported as one SL PRS occasion. According to RAN1 #109-e (discussed in RAN1 Chair's Notes of 3GPP TSG RAN WG1 #109-e, for example), at least some possible designs of SL PRS pattern, given M symbols and comb-N, are as follows: (i) Fully staggered SL PRS pattern, wherein M=N and/or wherein at each symbol a different RE offset is used, (ii) Partially staggered SL PRS pattern, wherein M<N and/or wherein at each symbol a different RE offset is used, and/or (iii) Unstaggered SL PRS patterns, wherein N>1 and/or wherein at each symbol a same RE offset is used.

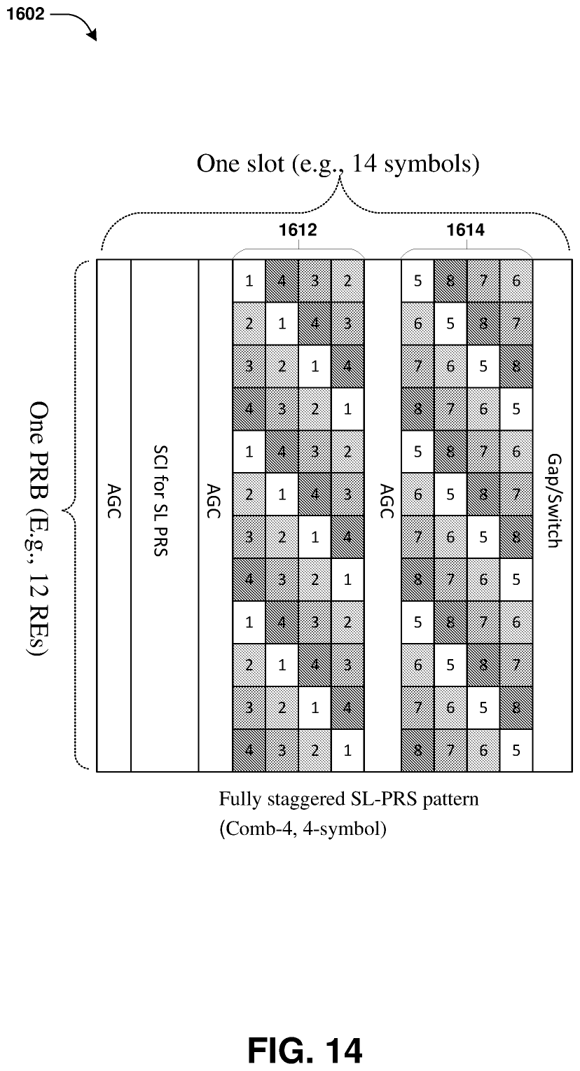

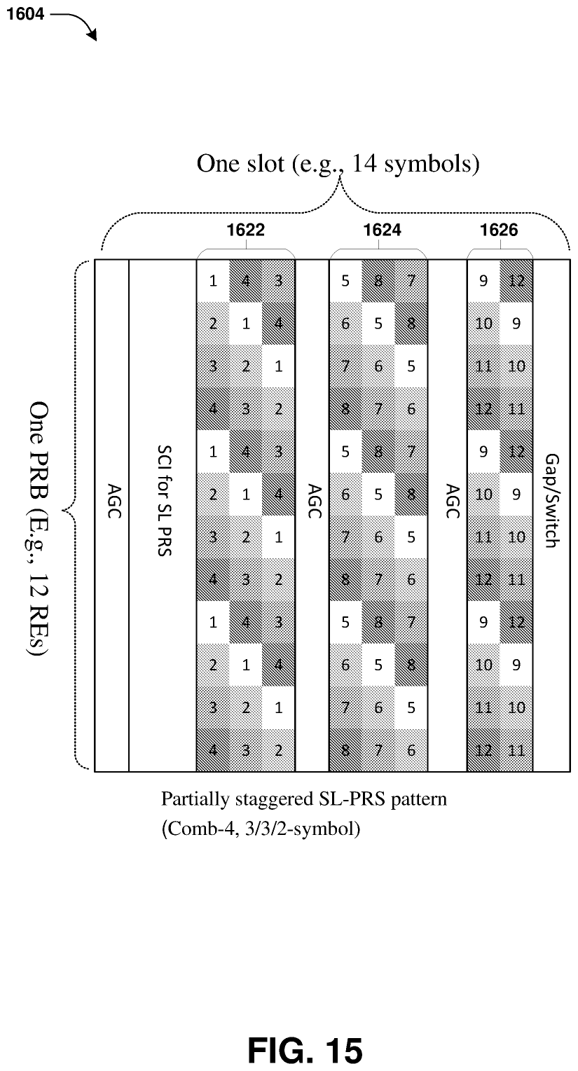

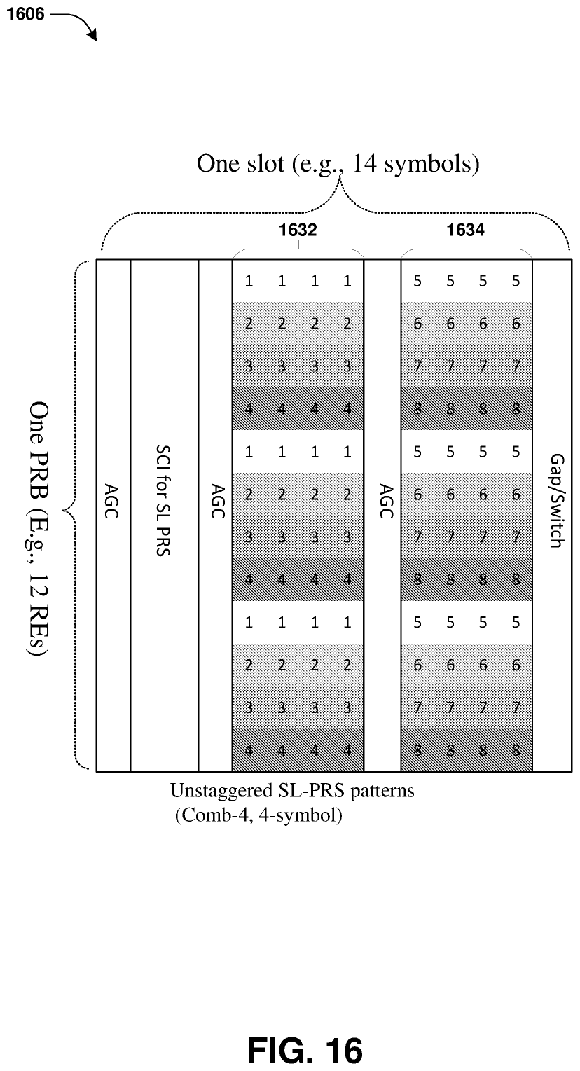

FIGS. 14-16 illustrate diagrams associated with different SL PRS patterns for Option 1, for example). FIG. 14 illustrates a diagram 1602 associated with a fully staggered SL PRS pattern. FIG. 15 illustrates diagram 1604 associated with a partially staggered SL PRS pattern. FIG. 16 illustrates diagram 1606 associated with an unstaggered SL PRS pattern. In some examples, such as examples shown in FIGS. 14-16 (for Option 1, for example), multiple SL PRSs may be multiplexed within a PRB (e.g., one PRB) and a slot (e.g., one slot). In some examples, a SL PRS (e.g., one SL PRS) may occupy contiguous PRBs (e.g., a lot of contiguous PRBs), such as 50 PRBs for 10 MHz bandwidth with 15 kHz subcarrier spacing. In some examples, FIGS. 14-16 illustrate SL PRS patterns within one PRB. In some examples, a first symbol (e.g., an initial symbol of the one slot shown in FIGS. 14-16) may be utilized for Automatic Gain Control (AGC). For a SL PRS pattern (e.g., one SL PRS pattern), a preceding symbol (e.g., a symbol preceding, such as immediately preceding, the SL PRS pattern) may or may not be utilized for AGC. A last symbol (e.g., a last symbol of the one slot shown in FIGS. 14-16) may be utilized as a gap symbol for possible TX/RX switch (e.g., switch between transmitting and receiving). For a SL PRS pattern (e.g., one SL PRS pattern), a preceding symbol (e.g., a symbol preceding, such as immediately preceding, the SL PRS pattern) may or may not be utilized for possible TX/RX switch, depending on future design. In some examples, 0˜3 symbols (i.e., 0 symbols, 1 symbol, 2 symbols and/or 3 symbols) may be utilized for transmitting SCI for SL PRS (depending on design for transmitting the SCI for SL PRS, for example). In a scenario in which there is no symbol for transmitting SCI for SL PRS in the dedicated resource pool for SL PRS, the SCI for SL PRS may be transmitted on PSCCH in other sidelink resource pool with sidelink communication.

In an example with respect to the diagram 1602 shown in FIG. 14, when a fully staggered SL PRS pattern with M=N=4 is applied for SL PRS pattern, and when there are two SL PRS occasions within one slot, 8 SL PRSs may be multiplexed with different indexes 1˜8. Each SL PRS (of the 8 SL PRSs, for example) may be determined (e.g., derived) based on associated frequency offset (in units of REs, for example). For the former (e.g., prior and/or further left) SL PRS occasion 1612, 4 SL PRSs with indexes 1˜4 may be determined (e.g., derived) based on associated frequency offset. For example, SL PRS with index 4 may be determined (e.g., derived) based on frequency offset=0. SL PRS with index 2 may be determined (e.g., derived) based on frequency offset=2. For the later (e.g., subsequent and/or further right) SL PRS occasion 1614 (after the former SL PRS occasion 1612, for example), 4 SL PRSs with indexes 5˜8 may be determined (e.g., derived) based on associated frequency offset. For example, SL PRS with index 8 is determined (e.g., derived) based on frequency offset=0. SL PRS with index 5 is determined (e.g., derived) based on frequency offset=3.

In an example with respect to the diagram 1604 shown in FIG. 15, when a partially staggered SL PRS pattern of N=4, and/or M=3/3/2 for three SL PRS occasions (e.g., SL PRS occasion 1622, SL PRS occasion 1624 and/or SL PRS occasion 1626) is applied for SL PRS pattern, 12 SL PRSs may be multiplexed with different indexes 1˜12. Each SL PRS may be determined (e.g., derived) based on associated frequency offset (in units of REs, for example).

In an example with respect to the diagram 1606 shown in FIG. 16, when unstaggered SL PRS pattern of N=4, M=4 is applied for SL PRS pattern, and when there are two SL PRS occasions within one slot (e.g., SL PRS occasion 1632 and/or SL PRS occasion 1634), 8 SL PRSs may be multiplexed with different indexes 1˜8. Each SL PRS may be determined (e.g., derived) based on associated frequency offset (in units of REs, for example). For example, SL PRS with index 4 is determined (e.g., derived) based on frequency offset=0 in the former SL PRS occasion 1632. SL PRS with index 2 may be determined (e.g., derived) based on frequency offset=2 in the former SL PRS occasion 1632. For example, SL PRS with index 8 may be determined (e.g., derived) based on frequency offset=0 in the later SL PRS occasion 1634. SL PRS with index 7 is determined (e.g., derived) based on frequency offset=1 in the later SL PRS occasion 1634.

In some examples, for comb-N SL PRS design/structure, possible frequency offsets may be a value from at least 0 to at most (N−1).

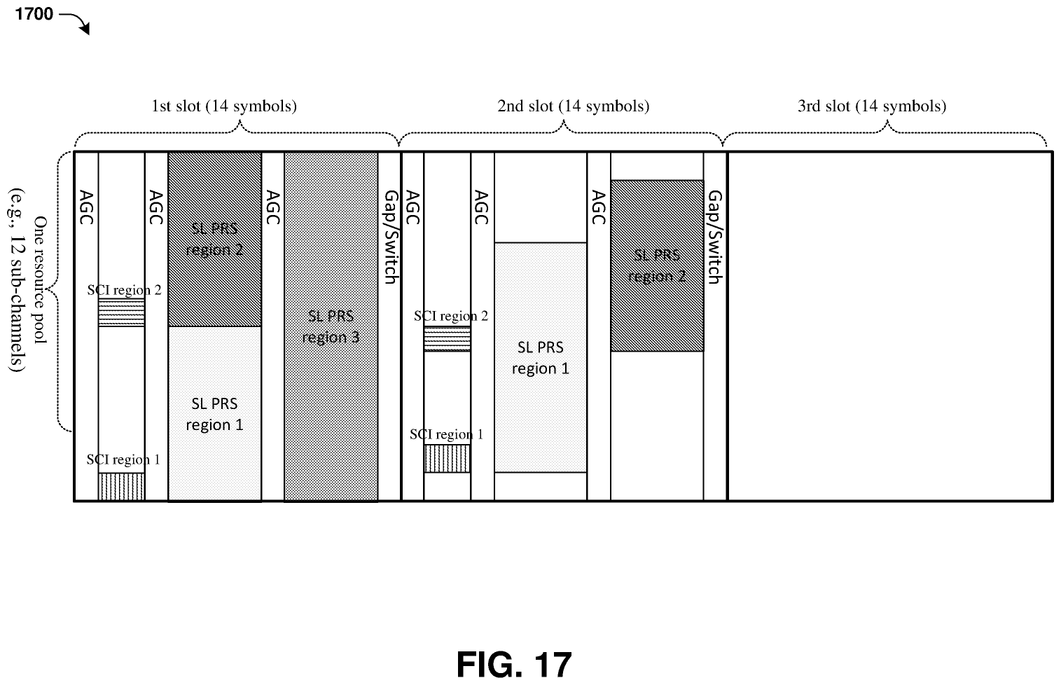

FIG. 17 illustrates a diagram 1700 associated with a dedicated resource pool for SL PRS. The dedicated resource pool for SL PRS may comprise (e.g., consist of) 12 sub-channels in frequency domain. Embodiments are contemplated in which the dedicated resource pool for SL PRS comprise another number of sub-channels in frequency domain other than 12. A sub-channel (e.g., one sub-channel) may comprise 10 PRBs, depending on pool configuration. If the fixed relationship between the PSCCH and the PSSCH resource is reutilized (e.g., the PSCCH may be located in a lowest sub-channel of the scheduled PSSCH resource, such as a sub-channel with a lowest index among sub-channels of the scheduled PSSCH resource), SCI for SL PRS may be located in the lowest sub-channel of the scheduled SL PRS resource (e.g., the lowest sub-channel may correspond to a sub-channel with a lowest index among sub-channels of the scheduled SL PRS resource). As shown in 1st slot of the diagram 1700 in FIG. 17, SL PRS 1 occupying (and/or covering) at least some of SL PRS region 1 may be associated with SCI 1 in SCI region 1. SL PRS 2 occupying (and/or covering) at least some of SL PRS region 2 may be associated with SCI 2 in SCI region 2. However, according to such relationship, SL PRS 3 occupying (and/or covering) at least some of SL PRS region 3 will be associated with SCI 3 in SCI region 1, which will be overlapped and/or conflicted with SCI 1 (since comb-structure is not applied to SCI and/or PSCCH, for example). Alternatively and/or additionally, considering there may be multiple SL PRS covered and/or multiplexed in SL PRS region 1 due to comb-structure, multiple SCIs (e.g., multiple associated SCIs) may be overlapped and/or conflicted in the SCI region 1. Such overlapping and/or conflict may impact (e.g., severely impact) reception and decoding of RX UE, and one or more RX UEs may not know how one or more SL PRSs is scheduled/allocated due to un-decodable SCI. Another issue is that flexible SL PRS resource scheduling/allocation may induce some vacant resources, as shown in 2nd slot of the diagram 1700 of FIG. 17. Since SL PRS may have requirement of minimum bandwidth depending on targeted positioning accuracy, such vacant resources may be un-utilizable, which may waste resources and/or lower spectrum efficiency.

One or more of the above issues may be handled (e.g., solved and/or avoided) and/or improved using one or more embodiments, concepts, mechanisms, methods, etc. provided herein.

Concept A

Multiple SL PRSs may be multiplexed in a SL PRS occasion (e.g., one SL PRS occasion). For example, it may be assumed that multiple SL PRSs are multiplexed in the SL PRS occasion (e.g., the one SL PRS occasion). The multiple SL PRSs may be in the same resource pool. The multiple SL PRSs may occupy (e.g., cover) the same bandwidth or the same frequency resources for SL PRS. In some examples, the multiple SL PRSs may occupy (e.g., cover) the same PRBs or the same sub-channels or the same frequency units for SL PRS. In some examples, the multiple SL PRSs may be non-overlapped with each other in time and frequency domain (e.g., the multiple SL PRSs may not overlap with each other in time domain and frequency domain). In some examples, the multiple SL PRSs may be associated with different indexes/identities/parameters. In the present disclosure, the term “index/identity/parameter” may refer to an index, an identity and/or a parameter.

Concept A may be that for a SCI/PSCCH associated with a SL PRS (e.g., one SL PRS) among the multiple SL PRS, a frequency resource of the SCI/PSCCH may be determined (e.g., derived) based on index/identity/parameter of the SL PRS (e.g., the one SL PRS) (and/or based on other information in addition to the index/identity/parameter of the SL PRS). In the present disclosure, the term “SCI/PSCCH” may refer to SCI and/or PSCCH. For different SL PRSs among the multiple SL PRSs, associated SCIs/PSCCHs may be located in different (non-overlapped, for example) frequency resources (since indexes/identities/parameters of the different SL PRSs are different, for example). In an example, a size (e.g., a number of PRBs) of the frequency resource of the SCI/PSCCH may be configured (e.g., pre-configured), e.g., configured in the resource pool configuration. Starting location (e.g., starting PRB) of the frequency resource of the SCI/PSCCH may be determined (e.g., derived) based on index/identity/parameter of the SL PRS (e.g., the one SL PRS). In some examples, starting location (e.g., starting PRB) of the frequency resource of the SCI/PSCCH may be determined (e.g., derived) based on index/identity/parameter of the SL PRS (e.g., the one SL PRS) and starting location of the bandwidth or the frequency resources for the SL PRS (e.g., the one SL PRS). In some examples, the starting location of the bandwidth or the frequency resources for the SL PRS (e.g., the one SL PRS) may be any of a PRB, a sub-channel or a frequency unit for SL PRS.

From TX UE aspect, the TX UE may determine (e.g., derive) one SL PRS with an index/identity/parameter. The TX UE may determine (e.g., derive) frequency resource of associated SCI/PSCCH based on the index/identity/parameter of the SL PRS (e.g., the one SL PRS) and starting location of bandwidth and/or frequency resources for the SL PRS (e.g., the one SL PRS). The TX UE may perform sensing on SL resource pool for SL PRS. The TX UE receives or monitors SCI/PSCCH from other UEs in the SL resource pool for SL PRS. Alternatively and/or additionally, the TX UE receives or monitors SCI/PSCCH from other UEs in another SL resource pool comprising SCI/PSCCH with an association to SL resource pool for SL PRS. Before TX UE performs SL PRS transmission, TX UE may perform sensing in SL resource pool for SL PRS. Based on sensing result of (received/monitored) SCI/PSCCH (and association of SCI/PSCCH and SL PRS resource, for example) (and/or association of SCI/PSCCH and frequency offset/comb offset), the TX UE may determine (e.g., identify) possible/candidate resources for transmitting SL PRS(s).

From RX UE aspect, the RX UE may determine (e.g., derive) some possible/candidate starting locations of SL PRS. The RX UE may determine (e.g., derive) some possible/candidate starting locations of bandwidth and/or frequency resources for SL PRS(s). The RX UE may determine (e.g., derive) some possible/candidate indexes/identities/parameters of SL PRS. In some examples, the RX UE may determine (e.g., derive) some possible/candidate frequency resources of SCI/PSCCH, based on the some possible/candidate indexes/identities/parameters of the SL PRS (e.g., the one SL PRS) and the some possible/candidate starting location of SL PRS. The RX UE may blindly decode the some possible/candidate frequency resources of SCI/PSCCH. When the RX UE successfully decodes one SCI/PSCCH (from one of the some possible/candidate frequency resources of SCI/PSCCH), the SCI may indicate/schedule/allocate an index/identity/parameter of one SL PRS and/or bandwidth and/or frequency resources for the SL PRS (e.g., the one SL PRS). In some examples, the SCI may (also) indicate/schedule/allocate (starting location of) the SL PRS (e.g., the one SL PRS). Alternatively and/or additionally, the SCI may not indicate/schedule/allocate (starting location of) the SL PRS (e.g., the one SL PRS). The RX UE may determine (e.g., derive) (starting location of) the SL PRS (e.g., the one SL PRS) based on the index/identity/parameter of the SL PRS (e.g., the one SL PRS) and/or frequency resource of the decoded one SCI/PSCCH. The RX UE may measure the SL PRS (e.g., the one SL PRS) based on at least some of the aforementioned information (e.g., the index/identity/parameter of the one SL PRS, the bandwidth or the frequency resources for the one SL PRS, and/or the starting location of the one SL PRS).

In some examples, the association between SCI/PSCCH resource and index/identity/parameter of SL PRS may be defined (e.g., predefined), fixed and/or specified. Alternatively and/or additionally, the association between SCI/PSCCH resource and index/identity/parameter of SL PRS may be configured (e.g., pre-configured), e.g., configured in the resource pool configuration.

In one embodiment, the multiple SL PRSs are multiplexed based on comb-structure. In some examples, multiple SL PRSs are multiplexed/separated in RE level. The multiple SL PRSs are associated with different frequency offsets (in units of REs, for example). One frequency offset or one comb offset may determine one corresponding RE pattern for one SL PRS. In some examples, the comb-structure may be any one of fully staggered SL PRS pattern, partially staggered SL PRS pattern, or unstaggered SL PRS patterns. For a SCI/PSCCH associated with one SL PRS among the multiple SL PRS, frequency resource of the SCI/PSCCH is determined (e.g., derived) (at least) based on frequency offset of the SL PRS (e.g., the one SL PRS). In some examples, starting location (e.g., starting PRB or starting sub-channel) of the frequency resource of the SCI/PSCCH may be determined (e.g., derived) based on the frequency offset or comb offset of the SL PRS (e.g., the one SL PRS) and/or starting location of (the bandwidth or the frequency resources for) the SL PRS (e.g., the one SL PRS). In some examples, starting location (e.g., starting sub-channel index/number or starting PRB index/number) of the frequency resource of the SCI/PSCCH may be determined (e.g., derived) based on information of the frequency offset or comb offset of the SL PRS (e.g., the one SL PRS) and/or starting location of (the bandwidth or the frequency resources for) the SL PRS (e.g., the one SL PRS). In some examples, information of the frequency offset or comb offset may be in unit of sub-channel index, and frequency offset or comb offset is in unit of RE. In some examples, for same starting frequency location (e.g., same starting sub-channel or same starting PRB) of SL PRS in same SL PRS region, frequency offset or comb offset may be used for associating starting frequency location of associated SCI/PSCCH. In some examples, for same starting frequency location (e.g., same starting sub-channel or same starting PRB) of SL PRS in different SL PRS regions or different SL PRS occasions, SL PRS region index/offset, SL PRS occasion index (e.g., for SL PRS occasions within one slot), frequency offset, or comb offset may be used for associating (starting) frequency location of associated SCI/PSCCH. In some examples, a starting PRB/sub-channel of SL PRS may associate with SCI/PSCCH with different starting PRB/sub-channel. In some examples, the number of available frequency resources of SCIs/PSCCHs in a sidelink resource pool for SL PRS in one slot may be noted as N_{SCI}. In some examples, different SL PRSs in same SL PRS region associate with different SCIs/PSCCHs among N_{SCI} SCI/PSCCHs. In some examples, different SL PRSs in different SL PRS regions/occasions associate with different SCI/PSCCHs among N_{SCI} SCI/PSCCHs.

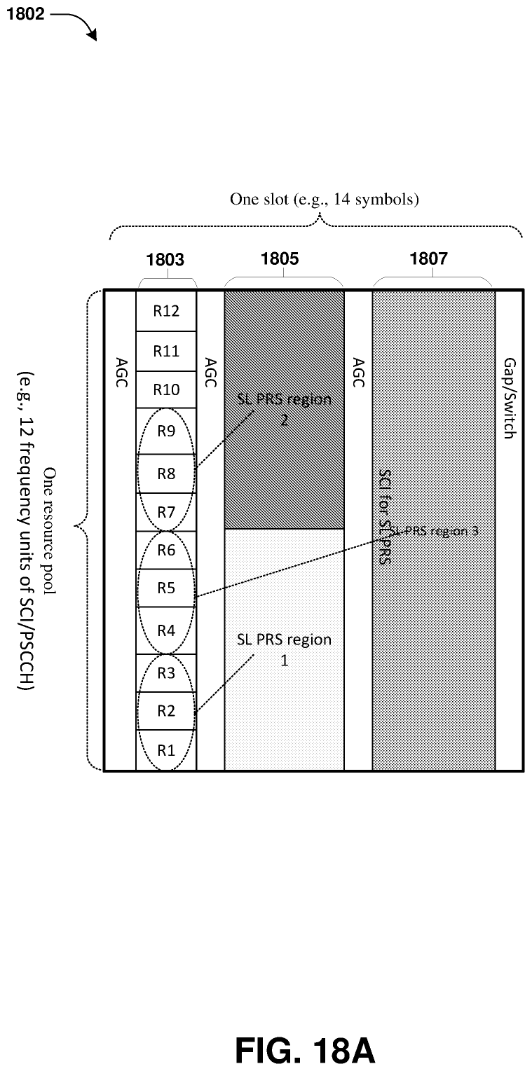

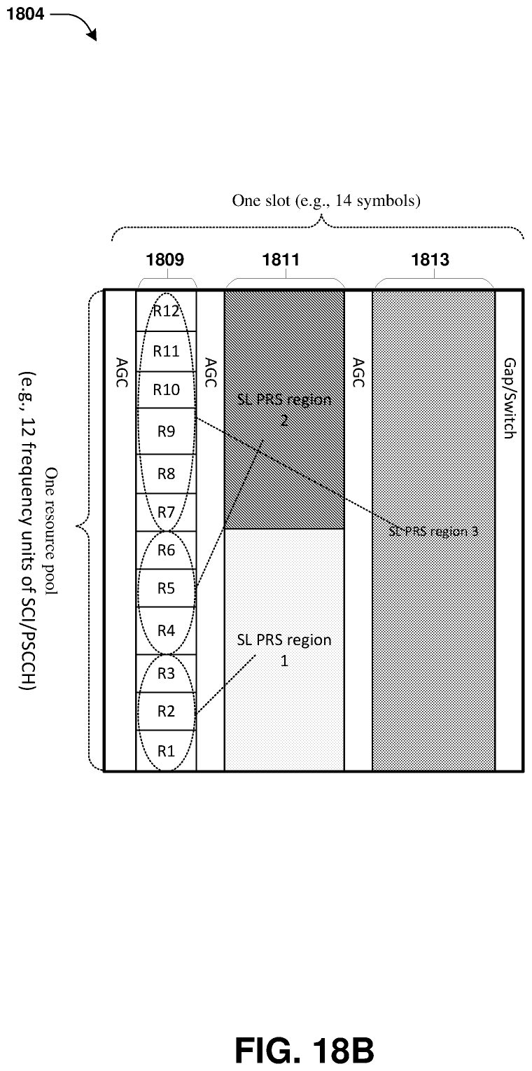

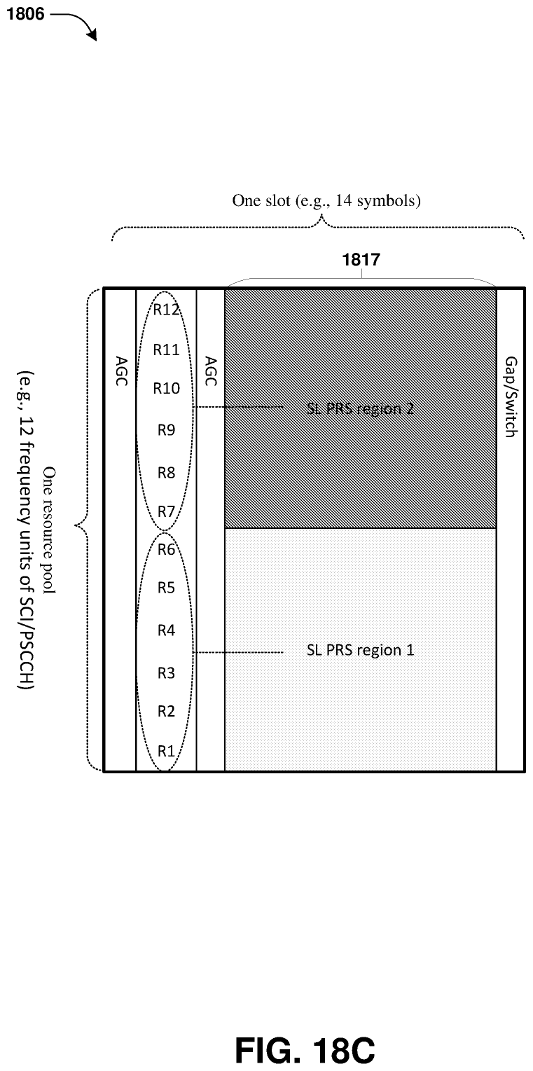

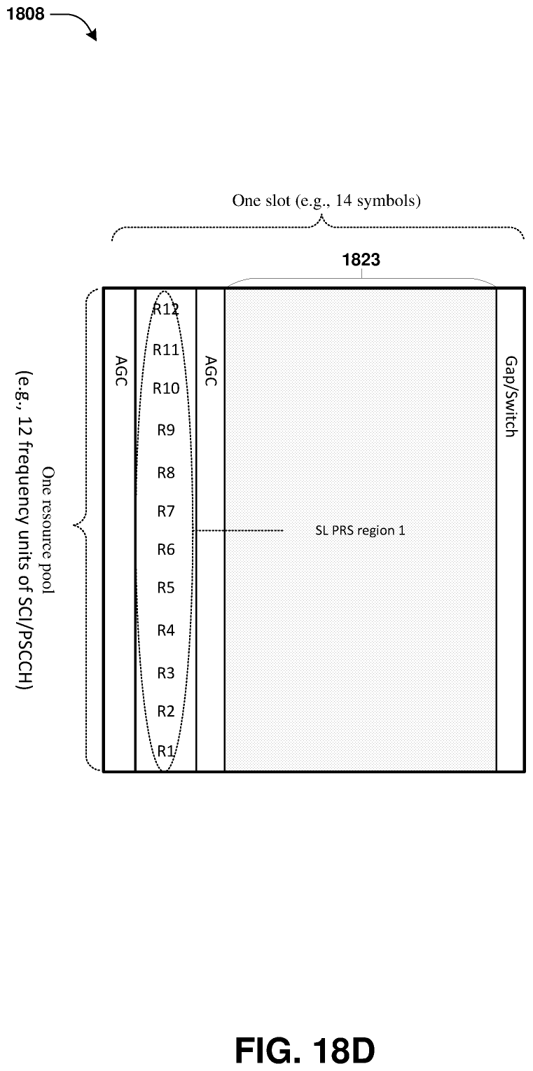

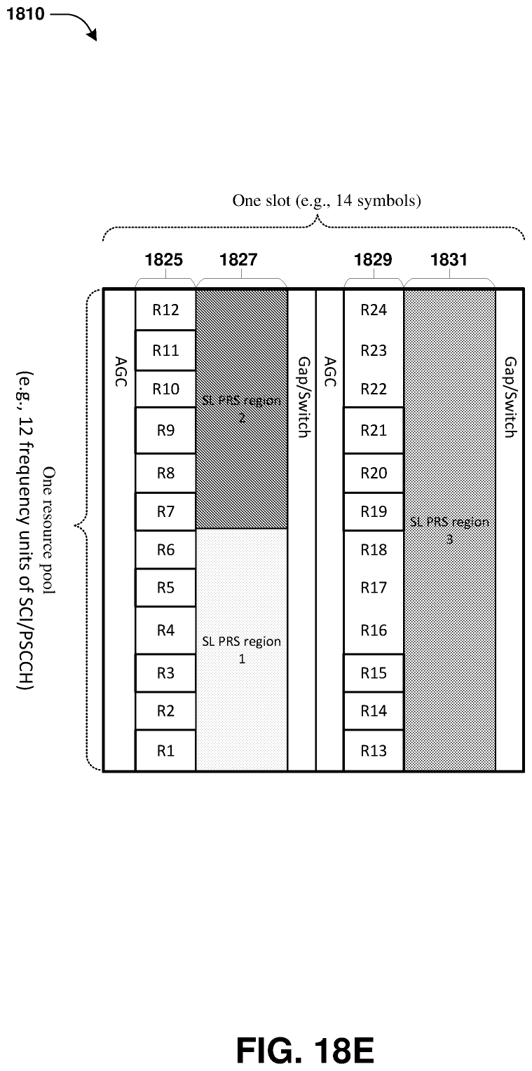

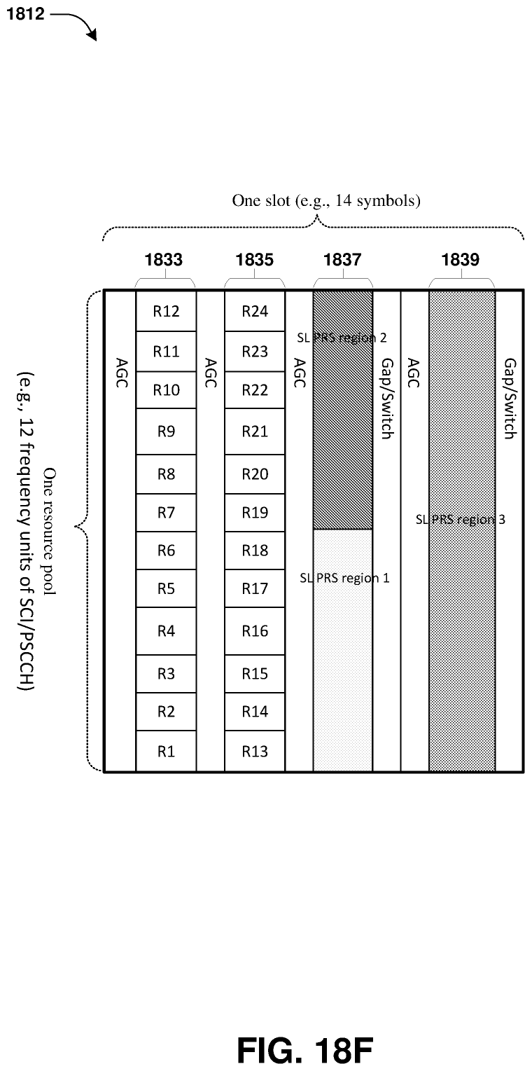

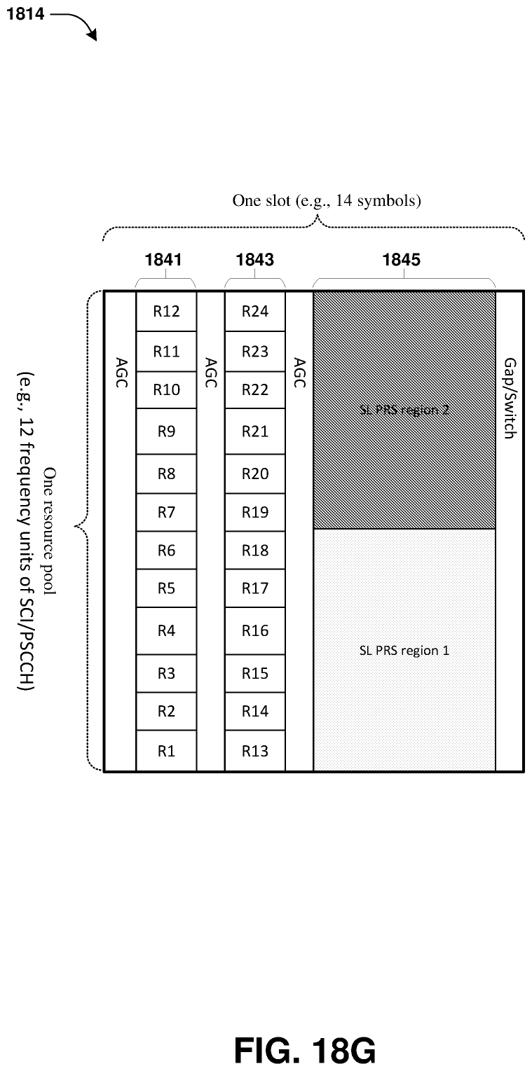

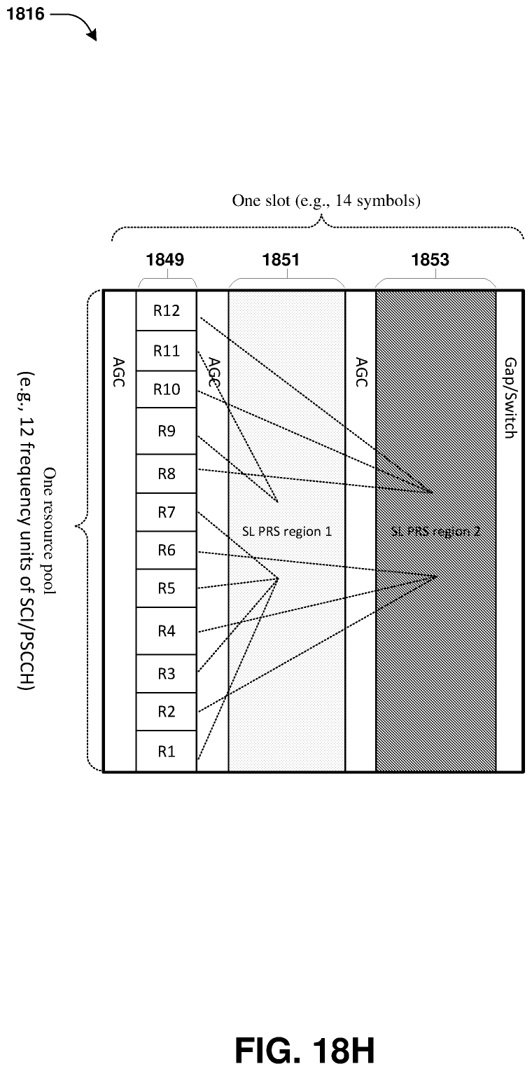

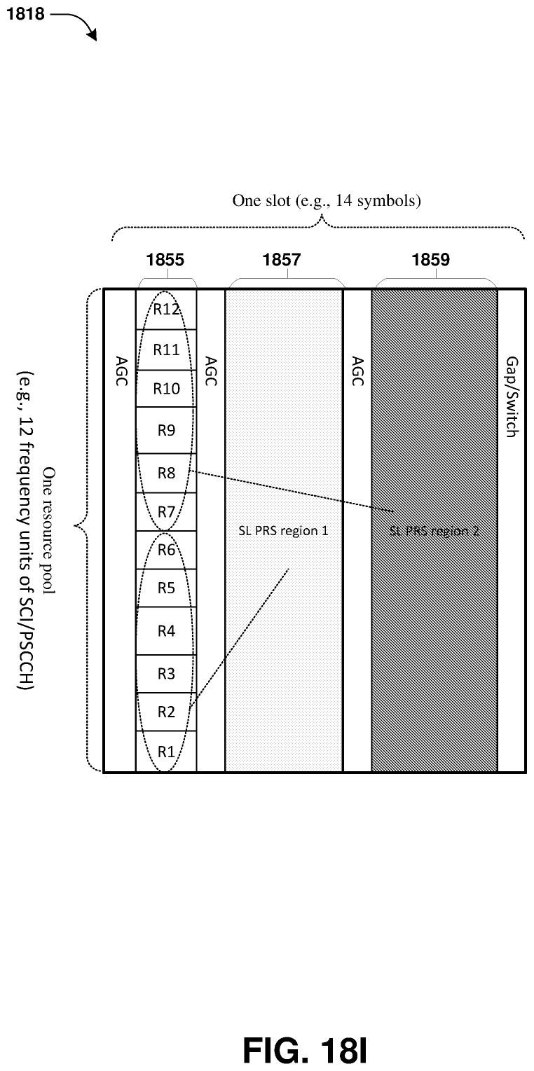

FIGS. 18A-18I provide diagrams of various example structures (e.g., designs) of SCI/PSCCH and SL PRS. In some examples, frequency resource of the SCI/PSCCH may be determined (e.g., derived) based on frequency offset of the one SL PRS, a starting location of the one SL PRS (e.g., a starting location of the bandwidth or the frequency resources for the one SL PRS) and/or SL PRS occasion of the one SL PRS (within one slot, for example).

In an example with respect to an example structure 1808 shown in FIG. 18D, comb-12 structure (comb-N, N=12) may be applied for SL PRSs with the same bandwidth and/or frequency resources for SL PRSs covering/occupying the SL PRS region 1 in a SL PRS occasion 1823 (e.g., one SL PRS occasion 1823). In some examples, there may be at most 12 SL PRSs multiplexed within the SL PRS region 1. In the present disclosure, the term “covering/occupying” may refer to covering and/or occupying. Each SL PRS may be associated with one frequency offset value (e.g., among 0˜11). Within the same frequency resources (e.g., PRBs, or sub-channels) of SL PRS region 1, there may be 12 available frequency resources of SCI/PSCCH in SCI/PSCCH occasion/symbols, e.g., R1˜R12. The 12 available frequency resources of SCI/PSCCH may be determined based on (e.g., derived from) starting location of the SL PRS region 1. For one SL PRS of the 12 SL PRS, UE may determine (e.g., derive) corresponding frequency resource of the SCI/PSCCH, among R1-R12, based on frequency offset value of the one SL PRS. For example, SL PRS with frequency offset=0 may be associated with SCI/PSCCH in R1, SL PRS with frequency offset=1 may be associated with SCI/PSCCH in R2, and/or SL PRS with frequency offset=11 may be associated with SCI/PSCCH in R12. In some examples, association between SCI/PSCCH resource R-X (e.g., R1, R2 . . . , R12) and frequency offset value Y may be determined (e.g., derived) based on a rule or formula. The number of available frequency resources of SCI/PSCCH may be noted as N_{SCI}. In some examples, X=(Y+1) or X=(Y mod N_{SCI})+1. In some examples, X=(Y+p) mod N_{SCI}+1, wherein p is a configured (e.g., pre-configured) value and/or is determined (e.g., derived) based on TX UE's identity or pool-specific identity. In some examples, association between X and Y (or R-X and Y) may be derived/determined based on a specified or configured (e.g., pre-configured) mapping.

Alternatively and/or additionally, in an example with respect to the example structure 1808 shown in FIG. 18D, comb-6 structure (comb-N, N=6) may be applied for SL PRSs with the same bandwidth and/or frequency resources for SL PRSs covering/occupying the SL PRS region 1 in the SL PRS occasion 1823 (e.g., the one SL PRS occasion 1823). In some examples, there may be at most 6 SL PRSs multiplexed within the SL PRS region 1. Each SL PRS may be associated with one frequency offset value (e.g., among 0˜5). Within the same frequency resources (e.g., PRBs, or sub-channels) of SL PRS region 1, there may be 12 available frequency resources of SCI/PSCCH in SCI/PSCCH occasion/symbols, e.g., R1˜R12. The 12 available frequency resources of SCI/PSCCH may be determined based on (e.g., derived from) starting location of the SL PRS region 1. For one SL PRS of the 6 SL PRS, UE may determine (e.g., derive) corresponding frequency resource of the SCI/PSCCH, among R1-R12, based on frequency offset value of the one SL PRS. For example, SL PRS with frequency offset=0 may be associated with SCI/PSCCH in R1, SL PRS with frequency offset=1 may be associated with SCI/PSCCH in R3, and/or SL PRS with frequency offset=5 may be associated with SCI/PSCCH in R11. In some examples, association between SCI/PSCCH resource R-X (e.g., R1, R2 . . . , R12) and frequency offset value Y may be determined (e.g., derived) based on a rule or formula. The number of available frequency resources of SCI/PSCCH may be noted as N_{SCI}. In some examples, X=(2Y+1) or X=(2Y mod N_{SCI})+1. In some examples, X=(2Y+p) mod N_{SCI}+1, wherein p is a configured (e.g., pre-configured) value and/or is determined (e.g., derived) based on TX UE's identity or pool-specific identity. In some examples, X=(ceil(N_{SCI}/N)*Y+1) or X=(ceil(N_{SCI}/N)*Y mod N_{SCI})+1. In some examples, X=(ceil(N_{SCI}/N)*Y+p) mod N_{SCI}+1, wherein p is a configured (e.g., pre-configured) value and/or is determined (e.g., derived) based on TX UE's identity or pool-specific identity. In some examples, X=(floor(N_{SCI}/N)*Y+1) or X=(floor(N_{SCI}/N)*Y mod N_{SCI})+1. In some examples, X=(floor(N_{SCI}/N)*Y+p) mod N_{SCI}+1, wherein p is a configured (e.g., pre-configured) value and/or is determined (e.g., derived) based on TX UE's identity or pool-specific identity. In some examples, association between X and Y may be derived/determined based on a specified or configured (e.g., pre-configured) mapping. Alternatively and/or additionally, there may be 6 available frequency resources of SCI/PSCCH in SCI/PSCCH occasion/symbols, e.g., R1˜R6. The 6 available frequency resources of SCI/PSCCH may be determined based on (e.g., derived from) starting location of the SL PRS region 1. In some examples, amount/number of R-X is determined based on comb-N structure. In this example, when N=6, there may be 6 available frequency resources of SCI/PSCCH in SCI/PSCCH occasion/symbols. In some examples, the 6 available frequency resources of SCI/PSCCH in SCI/PSCCH occasion/symbols may be R1˜R6 (e.g., no further use of R7-R12 in the example structure 1808 shown in FIG. 18D). In some examples, the 6 available frequency resources of SCI/PSCCH in SCI/PSCCH occasion/symbols may be R1″˜R6″, wherein Ri″ comprises R(2i) and R(2i−1) in the example structure 1808 shown in FIG. 18D. In some examples, one Ri″ may comprise one or more frequency resources of SCI/PSCCH. In some examples, one Ri″ may comprise one or more frequency units of SCI/PSCCH. In some examples, based on any of mentioned association through this disclosure, the UE may determine one Ri″ associated with one SL PRS. In some examples, the UE may determine which frequency resource of SCI/PSCCH among the one Ri″ with SCI/PSCCH associated with the one SL PRS. In some examples, the number of available frequency resources of SCI/PSCCH in Ri″ may be noted as N″_{SCI}. In some examples, Ri″ comprises R-X (e.g., R(2i), R(2i−1), or X=2i, or 2i−1). In some examples, i=(Y+1) or i=(Y mod N″_{SCI})+1. In some examples, i=(Y+p) mod N″_{SCI}+1. In some examples, Z is starting index of R-X of Ri″. In some examples, R-Z is R(2i−1). In some examples, Z is ending index of R-X of Ri″. In some examples, R-Z is R(2i). In some examples, Z=(2Y+1) or Z=2·(Y mod N″_{SCI})+1. In some examples, Z=2·(Y+p) mod N″_{SCI}+1. In some examples, p is a configured (e.g., pre-configured) value and/or is determined (e.g., derived) based on TX UE's identity or pool-specific identity. In some examples, both R(2i) and R(2i−1) are associated with one SL PRS. In some examples, when a UE transmits the one SL PRS, the UE may transmit SCI/PSCCH duplicated on both R(2i) and R(2i−1). In some examples, the UE may transmit one SCI/PSCCH on R(2i) and R(2i−1). In some examples, granularity of SCI/PSCCH in frequency domain may be more than one R-X. For example, granularity of SCI/PSCCH in frequency domain for sidelink resource pool for data or communication may be 1 sub-channel, while granularity of SCI/PSCCH in frequency domain for sidelink resource pool for SL PRS may be 1 or more than 1 sub-channel. In some examples, granularity of SCI/PSCCH in frequency domain for sidelink resource pool for SL PRS may be determined based on (i) number of SL PRS region, (ii) comb-N, (iii) total number of SL PRS in one slot/scheduling time unit, and/or (iv) bandwidth of the resource pool. In some examples, for sidelink resource pool for SL PRS, number of symbol in a slot for SCI/PSCCH may be 1. In some examples, for sidelink resource pool for SL PRS, number of symbol in a slot for SCI/PSCCH merely may be 2 or 3 (and/or number of symbol in a slot for SCI/PSCCH merely may not be 1). In some examples, when number of SL PRS in a slot (considering in same and different SL PRS region) is smaller than a threshold, legacy SCI/PSCCH (in pool for data) with ⅔ symbol and 1 sub-channel may be enhanced by SCI/PSCCH (in pool for SL PRS) with 1 symbol and more than 1 sub-channel. One motivation may be when capacity for SL PRS in a slot may not require too much SCI/PSCCH, SCI/PSCCH capacity may also reduce. In some examples, for SCI/PSCCH (in pool for data), when PSSCH comprises more than 1 sub-channel, PSSCH may comprise sub-channel(s) other than SCI/PSCCH in symbol of SCI/PSCCH. In some examples, for SCI/PSCCH (in pool for SL PRS), since there is no mechanism for reusing sub-channel resource other than sub-channel for SCI/PSCCH in symbol of SCI/PSCCH, frequency resource may be wasted without proper design. In some examples, benefit is to reuse currently unused frequency resource/sub-channel (when SCI/PSCCH capacity is enough or not require too much) which may reduce time domain resource consumption for SCI/PSCCH.

In an example with respect to an example structure 1806 shown in FIG. 18C, comb-12 structure (comb-N, N=12) may be applied for SL PRSs with the same bandwidth and/or frequency resources for SL PRSs covering/occupying the SL PRS region 1 in a SL PRS occasion 1817 (e.g., one SL PRS occasion 1817). In some examples, there may be at most 12 SL PRSs multiplexed within the SL PRS region 1. Each SL PRS within the SL PRS region 1 may be associated with one frequency offset value (e.g., among 0˜11). Within the same frequency resources (e.g., PRBs, or sub-channels) of SL PRS region 1, there may be 6 available frequency resources of SCI/PSCCH in SCI/PSCCH occasion/symbols, e.g., R1˜R6. The 6 available frequency resources of SCI/PSCCH may be determined based on (e.g., derived from) starting location of the SL PRS region 1. For one SL PRS of the 12 SL PRS, UE may determine (e.g., derive) corresponding frequency resource of the SCI/PSCCH, among R1˜R6, based on frequency offset value of the one SL PRS. In some examples, since number of available frequency resources of SCI/PSCCH is smaller than number of available SL PRS (i.e., 6<12), there may be at most 6 SL PRSs being usable. For example, TX UE may be able to use SL PRSs with frequency offset values 0, 2, 4, 6, 8, 10, and not able to use SL PRSs with frequency offset values 1, 3, 5, 7, 9, 11, (and vice versa, for example). For example, SL PRS with frequency offset=0 may be associated with SCI/PSCCH in R1, SL PRS with frequency offset=2 may be associated with SCI/PSCCH in R2, and/or SL PRS with frequency offset=10 may be associated with SCI/PSCCH in R6. In some examples, association between SCI/PSCCH resource R-X (e.g., R1, R2 . . . , R6) and frequency offset value Y may be determined (e.g., derived) based on a rule or formula (for SL PRS region 1). In some examples, association between SCI/PSCCH resource R-X (e.g., R7(R′1), R8(R′2) . . . , R12(R′6)) and frequency offset value Y may be determined (e.g., derived) based on a rule or formula (for SL PRS region 2). The number of available frequency resources of SCI/PSCCH may be noted as N_{SCI}. In some examples, X=(Y/2+1) or X=(Y/2) mod N_{SCI}+1. In some examples, X=(Y/2+p) mod N_{SCI}+1, wherein p is a configured (e.g., pre-configured) value and/or is determined (e.g., derived) based on TX UE's identity or pool-specific identity. In some examples, X=(floor(Y/2)+1) or X=(floor(Y/2) mod N_{SCI})+1. In some examples, X=(floor(Y/2)+p) mod N_{SCI}+1, wherein p is a configured (e.g., pre-configured) value and/or is determined (e.g., derived) based on TX UE's identity or pool-specific identity. In some examples, X=(ceil(Y/2)+1) or X=(ceil(Y/2) mod N_{SCI})+1. In some examples, X=(ceil(Y/2)+p) mod N_{SCI}+1, wherein p is a configured (e.g., pre-configured) value and/or is determined (e.g., derived) based on TX UE's identity or pool-specific identity. In some examples, X=(floor(N_{SCI}/N)+j*floor(N_{SCI}/#SL PRS region)+1), wherein j corresponds to 0 or 1 associated with SL PRS region number/index (e.g., SL PRS region 1, SL PRS region 2). In some examples, floor(N_{SCI}/#SL PRS region) may be replaced by or correspond to a SL PRS region index/offset, and/or floor(N_{SCI}/#SL PRS region) is used for illustrating the concept of SL PRS region index/offset which is not limited to being based on this formula. In some examples, frequency offset 0 of SL PRS in SL PRS region 2 may be associated with R-X with lowest starting sub-channel index/PRB of R-X and overlapping with SL PRS region 2. In some examples, when SL PRS region 2 starts from R10, frequency offset 0 in SL PRS region 2 may associate with R10. In some examples, SL PRS region 2 correspond to R10˜R12. In some examples, SL PRS region 1 starts from R1, frequency offset 0 in SL PRS region 1 may associate with R1. In some examples, SL PRS region 1 correspond to R1˜R9. In some examples, association between X and Y may be derived/determined based on a specified or configured (e.g., pre-configured) mapping.

In an example with respect to the example structure 1806 shown in FIG. 18C, comb-12 structure (comb-N, N=12) may be applied for SL PRSs with the same bandwidth and/or frequency resources for SL PRSs covering/occupying the SL PRS region 2 in the SL PRS occasion 1817 (e.g., the one SL PRS occasion 1817). In some examples, there may be at most 12 SL PRSs multiplexed within the SL PRS region 2. Each SL PRS within the SL PRS region 2 may be associated with one frequency offset value (e.g., among 0˜11). Within the same frequency resources (e.g., PRBs, or sub-channels) of SL PRS region 2, there may be 6 available frequency resources of SCI/PSCCH in SCI/PSCCH occasion/symbols, e.g., R7-R12 (which may also be noted as R′1-R′6). The 6 available frequency resources of SCI/PSCCH may be determined based on (e.g., derived from) starting location of the SL PRS region 2. For one SL PRS of the 12 SL PRS, UE may determine (e.g., derive) corresponding frequency resource of the SCI/PSCCH, among R7-R12 (R′1-R′6), based on frequency offset value of the one SL PRS. In some examples, since number of available frequency resources of SCI/PSCCH is smaller than number of available SL PRS (i.e., 6<12), there may be at most 6 SL PRSs being usable. For example, TX UE may be able to use SL PRSs with frequency offset values 0, 2, 4, 6, 8, 10, and not able to use SL PRSs with frequency offset values 1, 3, 5, 7, 9, 11, (and vice versa, for example). For example, SL PRS with frequency offset=0 may be associated with SCI/PSCCH in R7 (R′1), SL PRS with frequency offset=2 may be associated with SCI/PSCCH in R8 (R′2), and/or SL PRS with frequency offset=10 may be associated with SCI/PSCCH in R12 (R′6). In some examples, association between SCI/PSCCH resource R′-X and frequency offset value Y may be determined (e.g., derived) based on a rule or formula. The number of available frequency resources of SCI/PSCCH may be noted as N_{SCI}. In some examples, X=(Y/2+1) or X=(Y/2) mod N_{SCI}+1. In some examples, X=(Y/2+p) mod N_{SCI}+1, wherein p is a configured (e.g., pre-configured) value and/or is determined (e.g., derived) based on TX UE's identity or pool-specific identity. In some examples, association between X and Y may be derived/determined based on a specified or configured (e.g., pre-configured) mapping. In some examples, there may be ceil or floor function for operation of “Y/2”. In some examples, the denominator of 2 is determined based on N_{SCI}/N (with ceil or floor function, for example). In some examples, the denominator of 2 may be determined (e.g., derived) based on N_{SCI}/K (with ceil or floor function, for example), wherein K is the number of SL PRS regions or the number of SL PRS occasions in the slot.

Alternatively and/or additionally, in an example with respect to the example structure 1806 shown in FIG. 18C, assuming comb-6 structure (comb-N, N=6) is applied for SL PRSs with the same bandwidth and/or frequency resources for SL PRSs covering/occupying the SL PRS region 2 in the SL PRS occasion 1817 (e.g., the one SL PRS occasion 1817). In some examples, there may be at most 6 SL PRSs multiplexed within the SL PRS region 2. Each SL PRS within the SL PRS region 2 may be associated with one frequency offset value (e.g., among 0˜5). Within the same frequency resources (e.g., PRBs, or sub-channels) of SL PRS region 2, there may be 6 available frequency resources of SCI/PSCCH in SCI/PSCCH occasion/symbols, e.g., R7-R12 (or noted as R′1-R′6). The 6 available frequency resources of SCI/PSCCH may be determined based on (e.g., derived from) starting location of the SL PRS region 2. For one SL PRS of the 6 SL PRS, UE may determine (e.g., derive) corresponding frequency resource of the SCI/PSCCH, among R7-R12 (R′1-R′6), based on frequency offset value of the one SL PRS. For example, SL PRS with frequency offset=0 may be associated with SCI/PSCCH in R7 (R′1), SL PRS with frequency offset=1 may be associated with SCI/PSCCH in R8 (R′2), and/or SL PRS with frequency offset=5 may be associated with SCI/PSCCH in R12 (R′6). In some examples, association between SCI/PSCCH resource R′-X and frequency offset value Y may be determined (e.g., derived) based on a rule, formula. The number of available frequency resources of SCI/PSCCH may be noted as N_{SCI}. In some examples, X=(Y+1) or X=Y mod N_{SCI}+1. In some examples, X=(Y+p) mod N_{SCI}+1, wherein p is a configured (e.g., pre-configured) value and/or is determined (e.g., derived) based on TX UE's identity or pool-specific identity. In some examples, association between X and Y may be derived/determined based on a specified or configured (e.g., pre-configured) mapping.

In an example with respect to an example structure 1814 shown in FIG. 18G, comb-12 structure (comb-N, N=12) may be applied for SL PRSs with the same bandwidth and/or frequency resources for SL PRSs covering/occupying the SL PRS region 1 in a SL PRS occasion 1845 (e.g., one SL PRS occasion 1845). In some examples, there may be at most 12 SL PRSs multiplexed within the SL PRS region 1. Each SL PRS within the SL PRS region 1 may be associated with one frequency offset value (e.g., among 0˜11). Within the same frequency resources (e.g., PRBs, or sub-channels) of SL PRS region 1, there may be 12 available frequency resources of SCI/PSCCH in the former SCI/PSCCH occasion/symbols 1841, e.g., R1˜R12. The 12 available frequency resources of SCI/PSCCH may be determined based on (e.g., derived from) starting location of the SL PRS region 1. For one SL PRS of the 12 SL PRS, UE may determine (e.g., derive) corresponding frequency resource of the SCI/PSCCH, among R1-R12, based on frequency offset value of the one SL PRS. For example, SL PRS with frequency offset=0 may be associated with SCI/PSCCH in R1, SL PRS with frequency offset=1 may be associated with SCI/PSCCH in R2, and/or SL PRS with frequency offset=11 may be associated with SCI/PSCCH in R12. In some examples, association between SCI/PSCCH resource R-X and frequency offset value Y may be determined (e.g., derived) based on a rule or formula. The number of available frequency resources of SCI/PSCCH may be noted as N_{SCI}. In some examples, X=(Y+1) or X=Y mod N_{SCI}+1. In some examples, X=(Y+p) mod N_{SCI}+1, wherein p is a configured (e.g., pre-configured) value and/or is determined (e.g., derived) based on TX UE's identity or pool-specific identity. In some examples, association between X and Y may be derived/determined based on a specified or configured (e.g., pre-configured) mapping.

In an example with respect to the example structure 1814 shown in FIG. 18G, comb-12 structure (comb-N, N=12) may be applied for SL PRSs with the same bandwidth and/or frequency resources for SL PRSs covering/occupying the SL PRS region 2 in the SL PRS occasion 1845 (e.g., the one SL PRS occasion 1845). In some examples, there may be at most 12 SL PRSs multiplexed within the SL PRS region 2. Each SL PRS within the SL PRS region 2 may be associated with one frequency offset value (e.g., among 0˜11). Within the same frequency resources (e.g., PRBs, or sub-channels) of SL PRS region 2, there may be 12 available frequency resources of SCI/PSCCH in the later SCI/PSCCH occasion/symbols 1843, e.g., R13-R24 (or noted as R′1-R′12). The 12 available frequency resources of SCI/PSCCH may be determined based on (e.g., derived from) starting location of the SL PRS region 2. For one SL PRS of the 12 SL PRS, UE may determine (e.g., derive) corresponding frequency resource of the SCI/PSCCH, among R13-R24 (R′1-R′12), based on frequency offset value of the one SL PRS. For example, SL PRS with frequency offset=0 may be associated with SCI/PSCCH in R13 (R′1), SL PRS with frequency offset=1 may be associated with SCI/PSCCH in R14 (R′2), and/or SL PRS with frequency offset=11 may be associated with SCI/PSCCH in R24 (R′12). In some examples, association between SCI/PSCCH resource R′-X and frequency offset value Y may be determined (e.g., derived) based on a rule or formula. The number of available frequency resources of SCI/PSCCH may be noted as N_{SCI}. In some examples, X=(Y+1) or X=Y mod N_{SCI}+1. In some examples, X=(Y+p) mod N_{SCI}+1, wherein p is a configured (e.g., pre-configured) value and/or is determined (e.g., derived) based on TX UE's identity or pool-specific identity. In some examples, association between X and Y may be derived/determined based on a specified or configured (e.g., pre-configured) mapping.

In the example structure 1814 shown in FIG. 18G, two SCI/PSCCH occasions in time domain may be associated with two SL PRS regions (separately and/or respectively, for example). For example, within a slot (e.g., one slot) of a dedicated resource pool for SL PRS (and in accordance with the example structure 1814, for example), two SCI/PSCCH occasions in time domain may be associated with two SL PRS regions (separately and/or respectively, for example).

In an example with respect to an example structure 1810 shown in FIG. 18E and/or an example structure 1812 shown in FIG. 18F, comb-6 structure (comb-N, N=6) may be applied for SL PRSs with the same bandwidth and/or frequency resources for SL PRSs covering/occupying the SL PRS region 1 in the former SL PRS occasion (e.g., one SL PRS occasion). The former SL PRS occasion (e.g., one SL PRS occasion) may be SL PRS occasion 1827 in FIG. 18E or SL PRS occasion 1837 in FIG. 18F. In some examples, there may be at most 6 SL PRSs multiplexed within the SL PRS region 1. Each SL PRS within the SL PRS region 1 may be associated with one frequency offset value (e.g., among 0˜5). Within the same frequency resources (e.g., PRBs, or sub-channels) of SL PRS region 1, there may be 6 available frequency resources of SCI/PSCCH in the former SCI/PSCCH occasion/symbols (e.g., SCI/PSCCH occasion/symbols 1825 in FIG. 18E or SCI/PSCCH occasion/symbols 1833 in FIG. 18F), e.g., R1˜R6. The 6 available frequency resources of SCI/PSCCH may be determined based on (e.g., derived from) starting location of the SL PRS region 1. For one SL PRS of the 6 SL PRS, UE may determine (e.g., derive) corresponding frequency resource of the SCI/PSCCH, among R1˜R6, based on frequency offset value of the one SL PRS. For example, SL PRS with frequency offset=0 may be associated with SCI/PSCCH in R1, SL PRS with frequency offset=1 may be associated with SCI/PSCCH in R2, and/or SL PRS with frequency offset=5 may be associated with SCI/PSCCH in R6. In some examples, association between SCI/PSCCH resource R-X and frequency offset value Y may be determined (e.g., derived) based on a rule or formula. The number of available frequency resources of SCI/PSCCH may be noted as N_{SCI}. In some examples, X=(Y+1) or X=Y mod N_{SCI}+1. In some examples, X=(Y+p) mod N_{SCI}+1, wherein p is a configured (e.g., pre-configured) value and/or is determined (e.g., derived) based on TX UE's identity or pool-specific identity. In some examples, association between X and Y may be derived/determined based on a specified or configured (e.g., pre-configured) mapping.

In an example with respect to the example structure 1810 shown in FIG. 18E and/or the example structure 1812 shown in FIG. 18F, comb-6 structure (comb-N, N=6) may be applied for SL PRSs with the same bandwidth and/or frequency resources for SL PRSs covering/occupying the SL PRS region 2 in the former SL PRS occasion (e.g., one SL PRS occasion) (e.g., SL PRS occasion 1827 in FIG. 18E or SL PRS occasion 1837 in FIG. 18F). In some examples, there may be at most 6 SL PRSs multiplexed within the SL PRS region 2. Each SL PRS within the SL PRS region 2 may be associated with one frequency offset value (e.g., among 0˜5). Within the same frequency resources (e.g., PRBs, or sub-channels) of SL PRS region 2, there may be 6 available frequency resources of SCI/PSCCH in the former SCI/PSCCH occasion/symbols (e.g., SCI/PSCCH occasion/symbols 1825 in FIG. 18E or SCI/PSCCH occasion/symbols 1833 in FIG. 18F), e.g., R7-R12 (or noted as R′1-R′6). The 6 available frequency resources of SCI/PSCCH may be determined based on (e.g., derived from) starting location of the SL PRS region 2. For one SL PRS of the 6 SL PRS, UE may determine (e.g., derive) corresponding frequency resource of the SCI/PSCCH, among R7-R12 (R′1-R′6), based on frequency offset value of the one SL PRS. For example, SL PRS with frequency offset=0 may be associated with SCI/PSCCH in R7 (R′1), SL PRS with frequency offset=1 may be associated with SCI/PSCCH in R8 (R′2), and/or SL PRS with frequency offset=5 may be associated with SCI/PSCCH in R12 (R′6). In some examples, association between SCI/PSCCH resource R′-X and frequency offset value Y may be determined (e.g., derived) based on a rule or formula. The number of available frequency resources of SCI/PSCCH may be noted as N_{SCI}. In some examples, X=(Y+1) or X=Y mod N_{SCI}+1. In some examples, X=(Y+p) mod N_{SCI}+1, wherein p is a configured (e.g., pre-configured) value and/or is determined (e.g., derived) based on TX UE's identity or pool-specific identity. In some examples, association between X and Y may be derived/determined based on a specified or configured (e.g., pre-configured) mapping.

In an example with respect to the example structure 1810 shown in FIG. 18E and/or the example structure 1812 shown in FIG. 18F, comb-12 structure (comb-N, N=12) may be applied for SL PRSs with the same bandwidth and/or frequency resources for SL PRSs covering/occupying the SL PRS region 3 in the later SL PRS occasion (e.g., one SL PRS occasion) (e.g., SL PRS occasion 1831 in FIG. 18E or SL PRS occasion 1839 in FIG. 18F). In some examples, there may be at most 12 SL PRSs multiplexed within the SL PRS region 3. Each SL PRS within the SL PRS region 3 may be associated with one frequency offset value (e.g., among 0˜11). Within the same frequency resources (e.g., PRBs, or sub-channels) of SL PRS region 3, there may be 12 available frequency resources of SCI/PSCCH in the later SCI/PSCCH occasion/symbols (e.g., SCI/PSCCH occasion/symbols 1829 in FIG. 18E or SCI/PSCCH occasion/symbols 1835 in FIG. 18F), e.g., R13-R24 (R″1-R″12). The 12 available frequency resources of SCI/PSCCH may be determined based on (e.g., derived from) starting location of the SL PRS region 3. For one SL PRS of the 12 SL PRS, UE may determine (e.g., derive) corresponding frequency resource of the SCI/PSCCH, among R13-R24 (R″1-R″12), based on frequency offset value of the one SL PRS. For example, SL PRS with frequency offset=0 may be associated with SCI/PSCCH in R13(R″1), SL PRS with frequency offset=1 may be associated with SCI/PSCCH in R14(R″2), and/or SL PRS with frequency offset=11 may be associated with SCI/PSCCH in R24(R″12). In some examples, association between SCI/PSCCH resource R″-X and frequency offset value Y may be determined (e.g., derived) based on a rule or formula. The number of available frequency resources of SCI/PSCCH may be noted as N_{SCI}. In some examples, X=(Y+1) or X=Y mod N_{SCI}+1. In some examples, X=(Y+p) mod N_{SCI}+1, wherein p is a configured (e.g., pre-configured) value and/or is determined (e.g., derived) based on TX UE's identity or pool-specific identity. In some examples, association between X and Y may be derived/determined based on a specified or configured (e.g., pre-configured) mapping.

In the example structure 1810 shown in FIG. 18E and/or the example structure 1812 shown in FIG. 18F, two SCI/PSCCH occasions in time domain may be associated with two SL PRS occasions (separately and/or respectively, for example). For example, within a slot (e.g., one slot) of a dedicated resource pool for SL PRS (and in accordance with the example structure 1810 and/or the example structure 1812, for example), two SCI/PSCCH occasions in time domain may be associated with two SL PRS occasions (separately and/or respectively, for example).

In the example structure 1810 shown in FIG. 18E and/or the example structure 1812 shown in FIG. 18F, two SCI/PSCCH occasions in time domain may be associated with two SL PRS regions (separately and/or respectively, for example). For example, within a slot (e.g., one slot) of a dedicated resource pool for SL PRS (and in accordance with the example structure 1810 and/or the example structure 1812, for example), two SCI/PSCCH occasions in time domain may be associated with two SL PRS regions (separately and/or respectively, for example).

In some examples, the example structure 1810 shown in FIG. 18E and/or the example structure 1812 shown in FIG. 18F may have different distributions of SCI/PSCCH occasions and SL PRS occasions.

In an example with respect to an example structure 1802 shown in FIG. 18A, comb-6 structure (comb-N, N=6) may be applied for SL PRSs with the same bandwidth and/or frequency resources for SL PRSs covering/occupying the SL PRS region 1 in the former SL PRS occasion 1805 (e.g., one SL PRS occasion 1805). In some examples, there may be at most 6 SL PRSs multiplexed within the SL PRS region 1. Each SL PRS within the SL PRS region 1 may be associated with one frequency offset value (e.g., among 0˜5). Within the same frequency resources (e.g., PRBs, or sub-channels) of SL PRS region 1, there may be 3 available frequency resources of SCI/PSCCH in the SCI/PSCCH occasion/symbols 1803, e.g., R1˜R3. The 3 available frequency resources of SCI/PSCCH may be determined based on (e.g., derived from) starting location of the SL PRS region 1 and/or corresponding SL PRS occasion (e.g., the SL PRS occasion 1805). For one SL PRS of the 6 SL PRS, UE may determine (e.g., derive) corresponding frequency resource of the SCI/PSCCH, among R1-R3, based on frequency offset value of the one SL PRS. In some examples, since number of available frequency resources of SCI/PSCCH is smaller than number of available SL PRS (i.e., 3<6), there may be at most 3 SL PRSs being usable. For example, TX UE may be able to use SL PRSs with frequency offset values 0, 2, 4, and not able to use SL PRSs with frequency offset values 1, 3, 5 (and vice versa, for example). For example, SL PRS with frequency offset=0 may be associated with SCI/PSCCH in R1, SL PRS with frequency offset=2 may be associated with SCI/PSCCH in R2, and/or SL PRS with frequency offset=4 may be associated with SCI/PSCCH in R3. In some examples, association between SCI/PSCCH resource R-X and frequency offset value Y may be determined (e.g., derived) based on a rule or formula. The number of available frequency resources of SCI/PSCCH may be noted as N_{SCI}. In some examples, X=(Y/2+1) or X=(Y/2) mod N_{SCI}+1. In some examples, X=(Y/2+p) mod N_{SCI}+1, wherein p is a configured (e.g., pre-configured) value and/or is determined (e.g., derived) based on TX UE's identity or pool-specific identity. In some examples, there may be ceil or floor function for operation of “Y/2”. In some examples, the denominator of 2 is determined based on N_{SCI}/N (with ceil or floor function, for example). In some examples, the denominator of 2 may be determined (e.g., derived) based on N_{SCI}/K (with ceil or floor function, for example), wherein K is the number of SL PRS regions or the number of SL PRS occasions in the slot. In some examples, association between X and Y may be derived/determined based on a specified or configured (e.g., pre-configured) mapping.

In an example with respect to the example structure 1802 shown in FIG. 18A, comb-6 structure (comb-N, N=6) may be applied for SL PRSs with the same bandwidth and/or frequency resources for SL PRSs covering/occupying the SL PRS region 2 in the former SL PRS occasion 1805 (e.g., the one SL PRS occasion 1805). In some examples, there may be at most 6 SL PRSs multiplexed within the SL PRS region 2. Each SL PRS within the SL PRS region 2 may be associated with one frequency offset value (e.g., among 0˜5). Within the same frequency resources (e.g., PRBs, or sub-channels) of SL PRS region 2, there may be 3 available frequency resources of SCI/PSCCH in the SCI/PSCCH occasion/symbols 1803, e.g., R7˜R9 (or noted as R′1-R′3). The 3 available frequency resources of SCI/PSCCH may be determined based on (e.g., derived from) starting location of the SL PRS region 2 and/or corresponding SL PRS occasion (e.g., the SL PRS occasion 1805). For one SL PRS of the 6 SL PRS, UE may determine (e.g., derive) corresponding frequency resource of the SCI/PSCCH, among R7˜R9 (R′1-R′3), based on frequency offset value of the one SL PRS. In some examples, since number of available frequency resources of SCI/PSCCH is smaller than number of available SL PRS (i.e., 3<6), there may be at most 3 SL PRSs being usable. For example, TX UE may be able to use SL PRSs with frequency offset values 0, 2, 4, and not able to use SL PRSs with frequency offset values 1, 3, 5 (and vice versa, for example). For example, SL PRS with frequency offset=0 may be associated with SCI/PSCCH in R7 (R′1), SL PRS with frequency offset=2 may be associated with SCI/PSCCH in R8 (R′2), and/or SL PRS with frequency offset=4 may be associated with SCI/PSCCH in R9 (R′3). In some examples, association between SCI/PSCCH resource R′-X and frequency offset value Y may be determined (e.g., derived) based on a rule or formula. The number of available frequency resources of SCI/PSCCH may be noted as N_{SCI}. In some examples, X=(Y/2+1) or X=(Y/2) mod N_{SCI}+1. In some examples, X=(Y/2+p) mod N_{SCI}+1, wherein p is a configured (e.g., pre-configured) value and/or is determined (e.g., derived) based on TX UE's identity or pool-specific identity. In some examples, there may be ceil or floor function for operation of “Y/2”. In some examples, the denominator of 2 is determined based on N_{SCI}/N (with ceil or floor function, for example). In some examples, the denominator of 2 may be determined (e.g., derived) based on N_{SCI}/K (with ceil or floor function, for example), wherein K is the number of SL PRS regions or the number of SL PRS occasions in the slot. In some examples, association between X and Y may be derived/determined based on a specified or configured (e.g., pre-configured) mapping.

In an example with respect to the example structure 1802 shown in FIG. 18A, comb-6 structure (comb-N, N=6) may be applied for SL PRSs with the same bandwidth and/or frequency resources for SL PRSs covering/occupying the SL PRS region 3 in the later SL PRS occasion 1807 (e.g., one SL PRS occasion 1807). In some examples, there may be at most 6 SL PRSs multiplexed within the SL PRS region 3. Each SL PRS within the SL PRS region 3 may be associated with one frequency offset value (e.g., among 0˜5). Within the same frequency resources (e.g., PRBs, or sub-channels) of SL PRS region 3, there may be 3 available frequency resources of SCI/PSCCH in the SCI/PSCCH occasion/symbols 1803, e.g., R4˜R6 (R″1-R″3). The 3 available frequency resources of SCI/PSCCH may be determined based on (e.g., derived from) starting location of the SL PRS region 3 and/or corresponding SL PRS occasion (e.g., the SL PRS occasion 1807). For one SL PRS of the 6 SL PRS, UE may determine (e.g., derive) corresponding frequency resource of the SCI/PSCCH, among R4˜R6 (R″1-R″3), based on frequency offset value of the one SL PRS. In some examples, since number of available frequency resources of SCI/PSCCH is smaller than number of available SL PRS (i.e., 3<6), there may be at most 3 SL PRSs being usable. For example, TX UE may be able to use SL PRSs with frequency offset values 0, 2, 4, and not able to use SL PRSs with frequency offset values 1, 3, 5 (and vice versa, for example). For example, SL PRS with frequency offset=0 may be associated with SCI/PSCCH in R4(R″1), SL PRS with frequency offset=2 may be associated with SCI/PSCCH in R5(R″2), and/or SL PRS with frequency offset=4 may be associated with SCI/PSCCH in R6(R″3). In some examples, association between SCI/PSCCH resource R″-X and frequency offset value Y may be determined (e.g., derived) based on a rule or formula. The number of available frequency resources of SCI/PSCCH may be noted as N_{SCI}. In some examples, X=(Y/2+1) or X=(Y/2) mod N_{SCI}+1. In some examples, X=(Y/2+p) mod N_{SCI}+1, wherein p is a configured (e.g., pre-configured) value and/or is determined (e.g., derived) based on TX UE's identity or pool-specific identity. In some examples, there may be ceil or floor function for operation of “Y/2”. In some examples, the denominator of 2 is determined based on N_{SCI}/N (with ceil or floor function, for example). In some examples, the denominator of 2 may be determined (e.g., derived) based on N_{SCI}/K (with ceil or floor function, for example), wherein K is the number of SL PRS regions or the number of SL PRS occasions in the slot. In some examples, association between X and Y may be derived/determined based on a specified or configured (e.g., pre-configured) mapping.

In the example structure 1802 shown in FIG. 18A, a SCU/PSCCH occasion (e.g., one SCI/PSCCH occasion) in time domain may be associated with two SL PRS occasions. For example, within a slot (e.g., one slot) of a dedicated resource pool for SL PRS (and in accordance with the example structure 1802, for example), a SCI/PSCCH occasion (e.g., one SCI/PSCCH occasion) in time domain may be associated with two SL PRS occasions.

In some examples, for the former SL PRS occasion, corresponding frequency resources of SCI/PSCCH may be determined based on (e.g., derived from) starting location of the SL PRS region (and/or starting location of the former SL PRS occasion). In some examples, for the later SL PRS occasion, corresponding frequency resources of SCI/PSCCH may be determined based on (e.g., derived from) starting location of the SL PRS region and a PRB/sub-channel offset. The PRB/sub-channel offset may be specified, configured (e.g., pre-configured), and/or determined (e.g., derived) based on corresponding SL PRS occasion and/or number of PRBs/sub-channels (e.g., total number of PRBs/sub-channels) of the dedicated resource pool.

In an example with respect to an example structure 1804 shown in FIG. 18B, comb-6 structure (comb-N, N=6) may be applied for SL PRSs with the same bandwidth and/or frequency resources for SL PRSs covering/occupying the SL PRS region 1 in the former SL PRS occasion 1811 (e.g., one SL PRS occasion 1811). In some examples, there may be at most 6 SL PRSs multiplexed within the SL PRS region 1. Each SL PRS within the SL PRS region 1 may be associated with one frequency offset value (e.g., among 0˜5). Within the same frequency resources (e.g., PRBs, or sub-channels) of SL PRS region 1, there may be 3 available frequency resources of SCI/PSCCH in the SCI/PSCCH occasion/symbols 1809, e.g., R1˜R3. The 3 available frequency resources of SCI/PSCCH may be determined based on (e.g., derived from) starting location of the SL PRS region 1 and/or corresponding SL PRS occasion (e.g., the SL PRS occasion 1811). For one SL PRS of the 6 SL PRS, UE may determine (e.g., derive) corresponding frequency resource of the SCI/PSCCH, among R1-R3, based on frequency offset value of the one SL PRS. In some examples, since number of available frequency resources of SCI/PSCCH is smaller than number of available SL PRS (i.e., 3<6), there may be at most 3 SL PRSs being usable. For example, TX UE may be able to use SL PRSs with frequency offset values 0, 2, 4, and not able to use SL PRSs with frequency offset values 1, 3, 5 (and vice versa, for example). For example, SL PRS with frequency offset=0 may be associated with SCI/PSCCH in R1, SL PRS with frequency offset=2 may be associated with SCI/PSCCH in R2, and/or SL PRS with frequency offset=4 may be associated with SCI/PSCCH in R3. In some examples, association between SCI/PSCCH resource R-X and frequency offset value Y may be determined (e.g., derived) based on a rule or formula. The number of available frequency resources of SCI/PSCCH may be noted as N_{SCI}. In some examples, X=(Y/2+1) or X=(Y/2) mod N_{SCI}+1. In some examples, X=(Y/2+p) mod N_{SCI}+1, wherein p is a configured (e.g., pre-configured) value and/or is determined (e.g., derived) based on TX UE's identity or pool-specific identity. In some examples, there may be ceil or floor function for operation of “Y/2”. In some examples, the denominator of 2 is determined based on N_{SCI}/N (with ceil or floor function, for example). In some examples, the denominator of 2 may be determined (e.g., derived) based on N_{SCI}/K (with ceil or floor function, for example), wherein K is the number of SL PRS regions or the number of SL PRS occasions in the slot. In some examples, association between X and Y may be derived/determined based on a specified or configured (e.g., pre-configured) mapping.

In an example with respect to the example structure 1804 shown in FIG. 18B, comb-6 structure (comb-N, N=6) is applied for SL PRSs with the same bandwidth and/or frequency resources for SL PRSs covering/occupying the SL PRS region 2 in the former SL PRS occasion 1811 (e.g., the one SL PRS occasion 1811). In some examples, there may be at most 6 SL PRSs multiplexed within the SL PRS region 2. Each SL PRS within the SL PRS region 2 may be associated with one frequency offset value (e.g., among 0˜5). Within the same frequency resources (e.g., PRBs, or sub-channels) of SL PRS region 2, there may be 3 available frequency resources of SCI/PSCCH in the SCI/PSCCH occasion/symbols 1809, e.g., R4˜R6 (or noted as R′1-R′3). The 3 available frequency resources of SCI/PSCCH may be determined based on (e.g., derived from) starting location of the SL PRS region 2 and/or corresponding SL PRS occasion (e.g., the one SL PRS occasion 1811). For one SL PRS of the 6 SL PRS, UE may determine (e.g., derive) corresponding frequency resource of the SCI/PSCCH, among R4˜R6 (R′1-R′3), based on frequency offset value of the one SL PRS. In some examples, since number of available frequency resources of SCI/PSCCH is smaller than number of available SL PRS (i.e., 3<6), there may be at most 3 SL PRSs being usable. For example, TX UE may be able to use SL PRSs with frequency offset values 0, 2, 4, and not able to use SL PRSs with frequency offset values 1, 3, 5 (and vice versa, for example). For example, SL PRS with frequency offset=0 may be associated with SCI/PSCCH in R4 (R′1), SL PRS with frequency offset=2 may be associated with SCI/PSCCH in R5 (R′2), and/or SL PRS with frequency offset=4 may be associated with SCI/PSCCH in R6 (R′3). In some examples, association between SCI/PSCCH resource R′-X and frequency offset value Y may be determined (e.g., derived) based on a rule or formula. The number of available frequency resources of SCI/PSCCH may be noted as N_{SCI}. In some examples, X=(Y/2+1) or X=(Y/2) mod N_{SCI}+1. In some examples, X=(Y/2+p) mod N_{SCI}+1, wherein p is a configured (e.g., pre-configured) value and/or is determined (e.g., derived) based on TX UE's identity or pool-specific identity. In some examples, there may be ceil or floor function for operation of “Y/2”. In some examples, the denominator of 2 is determined based on N_{SCI}/N (with ceil or floor function, for example). In some examples, the denominator of 2 may be determined (e.g., derived) based on N_{SCI}/K (with ceil or floor function, for example), wherein K is the number of SL PRS regions or the number of SL PRS occasions in the slot. In some examples, association between X and Y may be derived/determined based on a specified or configured (e.g., pre-configured) mapping.

In an example with respect to the example structure 1804 shown in FIG. 18B, comb-6 structure (comb-N, N=6) may be applied for SL PRSs with the same bandwidth and/or frequency resources for SL PRSs covering/occupying the SL PRS region 3 in the later one SL PRS occasion 1813 (e.g., one SL PRS occasion 1813). In some examples, there may be at most 6 SL PRSs multiplexed within the SL PRS region 3. Each SL PRS within the SL PRS region 3 may be associated with one frequency offset value (e.g., among 0˜5). Within the same frequency resources (e.g., PRBs, or sub-channels) of SL PRS region 3, there may be 6 available frequency resources of SCI/PSCCH in the SCI/PSCCH occasion/symbols 1809, e.g., R7-R12 (R″1-R″6). The 6 available frequency resources of SCI/PSCCH may be determined based on (e.g., derived from) starting location of the SL PRS region 3 and/or corresponding SL PRS occasion (e.g., the SL PRS occasion 1813). For one SL PRS of the 6 SL PRS, UE may determine (e.g., derive) corresponding frequency resource of the SCI/PSCCH, among R7-R12 (R″1-R″6), based on frequency offset value of the one SL PRS. For example, SL PRS with frequency offset=0 may be associated with SCI/PSCCH in R7(R″1), SL PRS with frequency offset=1 may be associated with SCI/PSCCH in R8(R″2), and/or SL PRS with frequency offset=5 may be associated with SCI/PSCCH in R12(R″6). In some examples, association between SCI/PSCCH resource R″-X and frequency offset value Y may be determined (e.g., derived) based on a rule or formula. The number of available frequency resources of SCI/PSCCH may be noted as N_{SCI}. In some examples, X=(Y+1) or X=Y mod N_{SCI}+1. In some examples, X=(Y+p) mod N_{SCI}+1, wherein p is a configured (e.g., pre-configured) value and/or is determined (e.g., derived) based on TX UE's identity or pool-specific identity. In some examples, association between X and Y may be derived/determined based on a specified or configured (e.g., pre-configured) mapping.

In the example structure 1804 shown in FIG. 18B, a SCI/PSCCH occasion (e.g., one SCI/PSCCH occasion) in time domain may be associated with two SL PRS occasions. For example, within a slot (e.g., one slot) of a dedicated resource pool for SL PRS (and in accordance with the example structure 1804, for example), a SCI/PSCCH occasion (e.g., one SCI/PSCCH occasion) in time domain may be associated with two SL PRS occasions.

In some examples, for the former SL PRS occasion, corresponding frequency resources of SCI/PSCCH may be restricted/limited/confined in first part of PRBs/sub-channels of the dedicated resource pool (e.g., half of PRBs/sub-channels with smaller PRBs/sub-channels index). In the present disclosure, the term “restricted/limited/confined” may refer to restricted, limited and/or confined. In some examples, for the later SL PRS occasion, corresponding frequency resources of SCI/PSCCH may be restricted/limited/confined in second part of PRBs/sub-channels of the dedicated resource pool (e.g., half of PRBs/sub-channels with larger PRBs/sub-channels index).

In some examples, corresponding frequency resources of SCI/PSCCH may be determined based on (e.g., derived from) starting location of the SL PRS region and a PRB/sub-channel offset. The PRB/sub-channel offset may be specified, configured (e.g., pre-configured), and/or determined (e.g., derived) based on corresponding SL PRS occasion and/or number of PRBs/sub-channels (e.g., total number of PRBs/sub-channels) of the dedicated resource pool.

In an example with respect to an example structure 1816 shown in FIG. 18H and/or an example structure 1818 shown in FIG. 18I, comb-12 structure (comb-N, N=12) may be applied for SL PRSs with the same bandwidth and/or frequency resources for SL PRSs covering/occupying the SL PRS region 1 in the former SL PRS occasion (e.g., one SL PRS occasion). The former SL PRS occasion (e.g., one SL PRS occasion) may be SL PRS occasion 1851 in FIG. 18H or SL PRS occasion 1857 in FIG. 18I. In some examples, there may be at most 12 SL PRSs multiplexed within the SL PRS region 1. Each SL PRS within the SL PRS region 1 may be associated with one frequency offset value (e.g., among 0˜11). In the example structure 1816 of FIG. 18H, within the same frequency resources (e.g., PRBs, or sub-channels) of SL PRS region 1, there may be 6 available frequency resources of SCI/PSCCH in the SCI/PSCCH occasion/symbols 1849, e.g., R1/R3/R5/R7/R9/R11 (which may also be noted as R′1-R′6). In the example structure 1818 of FIG. 18I, within the same frequency resources (e.g., PRBs, or sub-channels) of SL PRS region 1, there may be 6 available frequency resources of SCI/PSCCH in the SCI/PSCCH occasion/symbols 1855, e.g., R1˜R6 (which may also be noted as R′1-R′6). The 6 available frequency resources of SCI/PSCCH may be determined based on (e.g., derived from) starting location of the SL PRS region 1 and/or corresponding SL PRS occasion (e.g., the SL PRS occasion 1851 in FIG. 18H or the SL PRS occasion 1857 in FIG. 18I). For one SL PRS of the 12 SL PRS, UE may determine (e.g., derive) corresponding frequency resource of the SCI/PSCCH, among the 6 available frequency resources of SCI/PSCCH, based on frequency offset value of the one SL PRS. In some examples, since number of available frequency resources of SCI/PSCCH is smaller than number of available SL PRS (i.e., 6<12), there may be at most 6 SL PRSs being usable. For example, TX UE may be able to use SL PRSs with frequency offset values 0, 2, 4, 6, 8, 10 and not able to use SL PRSs with frequency offset values 1, 3, 5, 7, 9, 11 (and vice versa, for example). In an example with respect to an example structure 1816 shown in FIG. 18H, SL PRS with frequency offset=0 may be associated with SCI/PSCCH in R1 (which may also be referred to as R′1), SL PRS with frequency offset=2 may be associated with SCI/PSCCH in R3 (which may also be referred to as R′2), and/or SL PRS with frequency offset=10 may be associated with SCI/PSCCH in R11 (which may also be referred to as R′6). In an example with respect to an example structure 1818 shown in FIG. 18I, SL PRS with frequency offset=0 may be associated with SCI/PSCCH in R1 (which may also be referred to as R′1), SL PRS with frequency offset=2 may be associated with SCI/PSCCH in R2 (which may also be referred to as R′2), and/or SL PRS with frequency offset=10 may be associated with SCI/PSCCH in R6 (which may also be referred to as R′6). In some examples, association between SCI/PSCCH resource R′-X and frequency offset value Y may be determined (e.g., derived) based on a rule or formula. The number of available frequency resources of SCI/PSCCH may be noted as N_{SCI}. In some examples, X′=(Y/2+1) or X′=(Y/2) mod N_{SCI}+1. In some examples, X′=(Y/2+p) mod N_{SCI}+1, wherein p is a configured (e.g., pre-configured) value and/or is determined (e.g., derived) based on TX UE's identity or pool-specific identity. In some examples, there may be ceil or floor function for operation of “Y/2”. In some examples, the denominator of 2 is determined based on N_{SCI}/N (with ceil or floor function, for example). In some examples, the denominator of 2 may be determined (e.g., derived) based on N_{SCI}/K (with ceil or floor function, for example), wherein K is the number of SL PRS regions or the number of SL PRS occasions in the slot. In some examples, association between X and Y may be derived/determined based on a specified or configured (e.g., pre-configured) mapping.

In an example with respect to the example structure 1816 shown in FIG. 18H and/or the example structure 1818 shown in FIG. 18I, comb-12 structure (comb-N, N=12) may be applied for SL PRSs with the same bandwidth and/or frequency resources for SL PRSs covering/occupying the SL PRS region 2 in the later SL PRS occasion (e.g., one SL PRS occasion). The later SL PRS occasion (e.g., one SL PRS occasion) may be SL PRS occasion 1853 in FIG. 18H or SL PRS occasion 1859 in FIG. 18I. In some examples, there may be at most 12 SL PRSs multiplexed within the SL PRS region 2. Each SL PRS within the SL PRS region 2 may be associated with one frequency offset value (e.g., among 0˜11). In the example structure 1816 of FIG. 18H, within the same frequency resources (e.g., PRBs, or sub-channels) of SL PRS region 2, there may be 6 available frequency resources of SCI/PSCCH in the SCI/PSCCH occasion/symbols 1849, e.g., R2/R4/R6/R8/R10/R12 (which may also be noted as R″1-R″6). In the example structure 1818 of FIG. 18I, within the same frequency resources (e.g., PRBs, or sub-channels) of SL PRS region 2, there may be 6 available frequency resources of SCI/PSCCH in the SCI/PSCCH occasion/symbols 1855, e.g., R7-R12 (which may also be noted as R″1-R″6). The 6 available frequency resources of SCI/PSCCH may be determined based on (e.g., derived from) starting location of the SL PRS region 2 and/or corresponding SL PRS occasion (e.g., the SL PRS occasion 1853 in FIG. 18H or the SL PRS occasion 1859 in FIG. 18I). For one SL PRS of the 12 SL PRS, UE may determine (e.g., derive) corresponding frequency resource of the SCI/PSCCH, among the 6 available frequency resources of SCI/PSCCH, based on frequency offset value of the one SL PRS. In some examples, since number of available frequency resources of SCI/PSCCH is smaller than number of available SL PRS (i.e., 6<12), there may be at most 6 SL PRSs being usable. For example, TX UE may be able to use SL PRSs with frequency offset values 0, 2, 4, 6, 8, 10 and not able to use SL PRSs with frequency offset values 1, 3, 5, 7, 9, 11 (and vice versa, for example). In an example with respect to an example structure 1816 shown in FIG. 18H, SL PRS with frequency offset=0 may be associated with SCI/PSCCH in R2 (which may also be referred to as R″1), SL PRS with frequency offset=2 may be associated with SCI/PSCCH in R4 (which may also be referred to as R″2), and/or SL PRS with frequency offset=10 may be associated with SCI/PSCCH in R12 (which may also be referred to as R″6). In an example with respect to an example structure 1818 shown in FIG. 18I, SL PRS with frequency offset=0 may be associated with SCI/PSCCH in R7 (which may also be referred to as R″1), SL PRS with frequency offset=2 may be associated with SCI/PSCCH in R8 (which may also be referred to as R″2), and/or SL PRS with frequency offset=10 may be associated with SCI/PSCCH in R12 (which may also be referred to as R″6). In some examples, association between SCI/PSCCH resource R″-X and frequency offset value Y may be determined (e.g., derived) based on a rule or formula. The number of available frequency resources of SCI/PSCCH may be noted as N_{SCI}. In some examples, X=(Y/2+1) or X=(Y/2) mod N_{SCI}+1. In some examples, X=(Y/2+p) mod N_{SCI}+1, wherein p is a configured (e.g., pre-configured) value and/or is determined (e.g., derived) based on TX UE's identity or pool-specific identity. In some examples, there may be ceil or floor function for operation of “Y/2”. In some examples, the denominator of 2 is determined based on N_{SCI}/N (with ceil or floor function, for example). In some examples, the denominator of 2 may be determined (e.g., derived) based on N_{SCI}/K (with ceil or floor function, for example), wherein K is the number of SL PRS regions or the number of SL PRS occasions in the slot. In some examples, association between X and Y may be derived/determined based on a specified or configured (e.g., pre-configured) mapping.

In the example structure 1816 shown in FIG. 18H and/or the example structure 1818 shown in FIG. 18I, a SCI/PSCCH occasion (e.g., one SCI/PSCCH occasion) in time domain may be associated with two SL PRS occasions. For example, within a slot (e.g., one slot) of a dedicated resource pool for SL PRS (and in accordance with the example structure 1816 and/or the example structure 1818, for example), a SCI/PSCCH occasion (e.g., one SCI/PSCCH occasion) in time domain may be associated with two SL PRS occasions. In some examples, there may be one SL PRS region (e.g., only one SL PRS region) in one SL PRS occasion.

In some examples, for the former SL PRS occasion, corresponding frequency resources of SCI/PSCCH may be restricted/limited/confined in first part of PRBs/sub-channels of the dedicated resource pool (e.g., half of PRBs/sub-channels with smaller PRBs/sub-channels index such as shown with respect to the example structure 1818 of FIG. 18I, or candidate/available frequency resources of SCI/PSCCH with odd index such as shown with respect to the example structure 1816 of FIG. 18H). In some examples, for the later SL PRS occasion, corresponding frequency resources of SCI/PSCCH may be restricted/limited/confined in second part of PRBs/sub-channels of the dedicated resource pool (e.g., half of PRBs/sub-channels with larger PRBs/sub-channels index such as shown with respect to the example structure 1818 of FIG. 18I, or candidate/available frequency resources of SCI/PSCCH with even index such as shown with respect to the example structure 1816 of FIG. 18H). In the present disclosure, the term “candidate/available” may refer to candidate and/or available. In an example, a candidate/available frequency resource may correspond to a candidate frequency resource that may be available (e.g., available for use, such as transmission and/or reception).

In some examples, corresponding frequency resources of SCI/PSCCH may be determined based on (e.g., derived from) starting of the SL PRS region/occasion and a PRB/sub-channel offset. The PRB/sub-channel offset may be specified, configured (e.g., pre-configured), and/or determined (e.g., derived) based on corresponding SL PRS occasion and/or number of PRBs/sub-channels (e.g., total number of PRBs/sub-channels) of the dedicated resource pool.

In some examples, different slots in sidelink resource pool for SL PRS may have different associations between SCI/PSCCH and SL PRS. In some examples, there may be time domain characteristic for determining association between SCI/PSCCH and SL PRS in addition to aforementioned association between SCI/PSCCH and SL PRS. In an example with respect to the example structure 1818 shown in FIG. 18I, for slot i, SL PRS region 1 maps to lower frequency resource (e.g., R1˜R6) and SL PRS region 2 maps to higher frequency resource (e.g., R7-R12), and for slot j, SL PRS region 1 maps to higher frequency resource (e.g., R7-R12) and SL PRS region 2 maps to lower frequency resource (e.g., R1˜R6). In an example with respect to the example structure 1816 shown in FIG. 18H, there may be slot level change of association between SL PRS region and SCI/PSCCH frequency resource. In some examples, slot i may be with even slot index (e.g., logical slot index) in sidelink resource pool for SL PRS, and slot j may be with odd slot index (e.g., logical slot index) in sidelink resource pool for SL PRS. In some examples, slot i may be with even frame index (e.g., logical frame index) in sidelink resource pool for SL PRS, and slot j may be with odd frame index (e.g., logical frame index) in sidelink resource pool for SL PRS.

Concept B

In some examples, to satisfy positioning accuracy for different use cases, SL PRS may require larger bandwidths, e.g., 10, 20, 40 and 100 MHz in Frequency Range 1 (FR1) and/or 100, 200 and 400 MHz in Frequency Range 2 (FR2). For 10 MHz bandwidth with 15 kHz subcarrier spacing, 50 RPBs are required for a SL PRS. Accordingly, a resource pool (e.g., one resource pool) for SL PRS may be designed. At least some embodiments of Concept B (and/or a combination of embodiments of Concept B and/or other concepts and/or embodiments herein) may be implemented (as at least one of a design, a configuration, a restriction, etc.) to handle (e.g., solve and/or avoid) possible vacant resources issue (associated with the 2nd slot of the diagram 1700 of FIG. 17, for example).

### Embodiment 1

In Embodiment 1 (of Concept B), a resource pool for SL PRS may have one or more defined frequency locations (e.g., one or more predefined and/or specific frequency locations). A defined frequency location of the one or more defined frequency locations may be candidate/available starting location of SL PRS. In some examples, the candidate/available starting location of a SL PRS (e.g., one SL PRS) may be determined (e.g., derived) based on bandwidth and/or frequency resources of the one SL PRS. For example, candidate/available frequency resources of one SL PRS may be determined (e.g., derived) based on the bandwidth and/or the frequency resources of the SL PRS (e.g., the one SL PRS).

In some examples, the candidate/available starting location of one SL PRS may be determined (e.g., derived) based on a rule or formula. Assuming N_{PRS} frequency units for SL PRS in the resource pool for SL PRS are ordered with corresponding index of frequency unit. The 1^{st} frequency unit is with the lowest index of frequency unit. The N_{PRS}-th frequency unit is with the highest index of frequency unit. In some examples, when the bandwidth and/or frequency resources of the one SL PRS comprises i frequency units for SL PRS, total number of candidate/available starting location of one SL PRS may be [N_{PRS}/i]. The candidate/available starting location of one SL PRS may be 1st, (1+i)-th, (1+2i)-th, . . . , (1+(j−1)·i)-th frequency units, wherein 1≤j≤└N_{PRS}/i┘

In some examples, a SCI associated with one SL PRS may indicate/schedule/allocate the bandwidth and/or frequency resources of the one SL PRS, e.g., indicate/schedule/allocate i frequency units for SL PRS. In some examples, a SCI associated with one SL PRS may indicate/schedule/allocate starting location of the one SL PRS, e.g., indicate/schedule/allocate the value j or (1+(j-l)·i)-th frequency units.

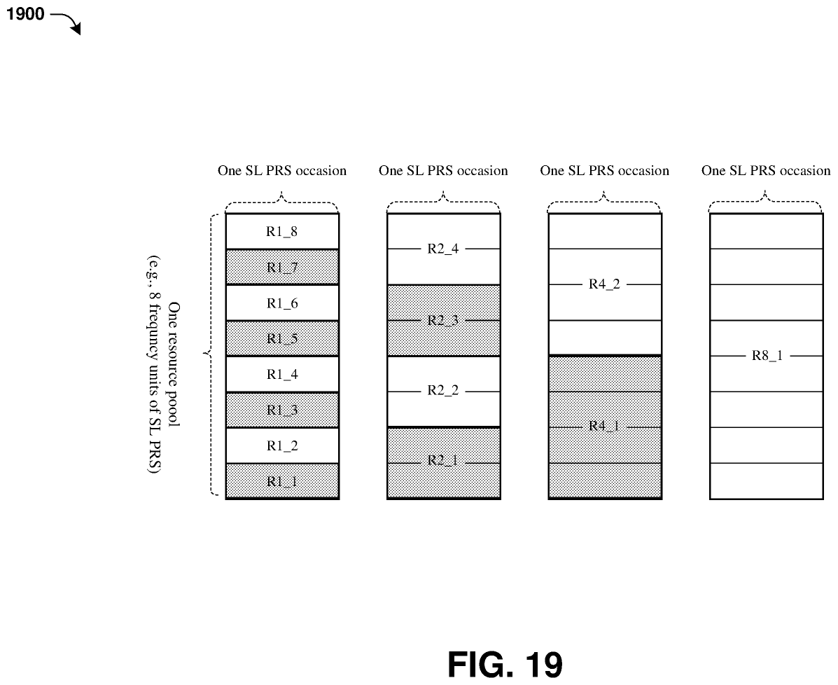

FIG. 19 illustrates a diagram 1900 of example candidate/available frequency resources of a SL PRS (e.g., one SL PRS) for different cases (e.g., four different scenarios). In some examples, one resource pool for SL PRS comprises 8 frequency units of SL PRS. Embodiments are contemplated in which one resource pool for SL PRS comprises a different number of frequency units different than 8. In some examples, one candidate/available frequency resources of one SL PRS with one candidate/available starting location of one SL PRS may be considered to be (e.g., regarded as) one SL PRS region. When a SL PRS comprises one frequency unit, candidate/available frequency resources of the SL PRS may be R1_1-R1_8. Each frequency unit may be candidate/available starting location of the SL PRS. When a SL PRS comprises two frequency units, candidate/available frequency resources of the SL PRS may be R2_1˜R2_4. Candidate/available starting location of the SL PRS may be the 1^{st}, 3^{rd}, 5^{th}, 7^{th} frequency unit. When a SL PRS comprises four frequency units, candidate/available frequency resources of the SL PRS may be R4_1˜R4_2. Candidate/available starting location of the SL PRS may be the 1^{st} and 5^{th} frequency unit. R4_1 may be the SL PRS region 1, such as shown in example structures provided in FIGS. 18A, 18B, 18C, 18E, 18F and 18G. R4_2 may be the SL PRS region 2, such as shown in example structures provided in FIGS. 18A, 18B, 18C, 18E, 18F, and 18G. When a SL PRS comprises eight frequency units, candidate/available frequency resources of the SL PRS may be R8_1. Candidate/available starting location of the SL PRS may be the 1^{st} frequency unit. R8_1 may be the SL PRS region 3, such as shown in example structures provided in FIGS. 18A, 18B, 18E, and/or 18G. R8_1 may be the SL PRS region 1 in an example shown in FIG. 18D.

In some examples, such restriction of frequency location (e.g., specific frequency location) may mitigate the vacant resources issue. For example, one unrestricted SL PRS may comprise the 2^{nd}˜5^{th} frequency unit and/or may block possible usages of R1_2˜R1_5, R2_1˜R2_3, R4_2, and R8_1. While one restricted SL PRS comprises the 1^{nd}˜4^{th} frequency unit, it may block possible usages of R1_1˜R1_4, R2_1˜R2_2, and R8_1, which give two more available usages.

### Embodiment 2

In Embodiment 2 (of Concept B), a resource pool for SL PRS may configure available/usable bandwidth and/or frequency resources of one SL PRS. In some examples, the resource pool for SL PRS may configure one or more number of frequency units of one SL PRS. In an example with respect to FIG. 19, one resource pool for SL PRS may (be assumed to) comprise 8 frequency units of SL PRS. If the resource pool configures available/usable bandwidth and/or frequency resources of one SL PRS as 1, 2, 4, or 8 frequency units for SL PRS (e.g., i={1, 2, 4, 8}), candidate/available frequency resources of the SL PRS may be R1_1˜R1_8, R2_1˜R2_4, R4_1˜R4_2, and R8_1. If the resource pool configures available/usable bandwidth and/or frequency resources of one SL PRS as 2, 4 frequency units for SL PRS (e.g., i={2, 4), candidate/available frequency resources of the SL PRS may be R2_1˜R2_4 and R4_1˜R4_2 (which may mean that R1_1˜R1_8 and R8_1 are not candidate/available frequency resources of the SL PRS in the resource pool, for example). If the resource pool configures available/usable bandwidth and/or frequency resources of one SL PRS as 2 frequency units for SL PRS (e.g., i={2), candidate/available frequency resources of the SL PRS may be R2_1-R2_4 (which may mean that R1_1˜R1_8, R4_1˜R4_2, and R8_1 are not candidate/available frequency resources of the SL PRS in the resource pool, for example).

Alternatively and/or additionally, one resource pool for SL PRS may limit/restrict one available/usable bandwidth and/or frequency resources of one SL PRS. In some examples, the resource pool for SL PRS may not have a configuration for available/usable bandwidth and/or frequency resources of one SL PRS.

In some examples, one resource pool for SL PRS may limit/restrict one available/usable bandwidth and/or frequency resources of one SL PRS, wherein the available/usable bandwidth and/or frequency resources of one SL PRS is one frequency unit for SL PRS. The one resource pool for SL PRS may configure the frequency unit for SL PRS, e.g., the first number of (contiguous) PRBs. The available/usable bandwidth and/or frequency resources of one SL PRS will be the first number of (contiguous) PRBs. In an example with respect to FIG. 19, assuming one resource pool for SL PRS comprises 8 frequency units of SL PRS. Candidate/available frequency resources of the SL PRS may be R1_1˜R1_8 (which may mean that R2_1˜R2_4, R4_1˜R4_2, and R8_1 are not candidate/available frequency resources of the SL PRS, for example).

Alternatively and/or additionally, one resource pool for SL PRS may limit/restrict one available/usable bandwidth and/or frequency resources of one SL PRS, wherein the available/usable bandwidth and/or frequency resources of one SL PRS is full bandwidth of the one resource pool. The one resource pool for SL PRS may configure a third number of (contiguous) PRBs comprised in the one resource pool. The available/usable bandwidth and/or frequency resources of one SL PRS will be the third number of (contiguous) PRBs. In an example with respect to FIG. 19, candidate/available frequency resources of the SL PRS may be R8_1 (which may mean that R1_1˜R1_8, R2_1˜R2_4, and R4_1˜R4_2 are not candidate/available frequency resources of the SL PRS, for example).

### Embodiment 3

In Embodiment 3 (of Concept B), a resource pool for SL PRS may comprise (e.g., include and/or have) one or more SL PRS occasions (in time domain) within one slot. One SL PRS occasion may comprise M (consecutive) symbols in the resource pool. For SL PRS with comb-N structure/design, M may be smaller than or equal to N. In some examples, the SL PRS with comb-N structure/design may be any of fully staggered SL PRS pattern, partially staggered SL PRS pattern, or unstaggered SL PRS pattern. Considering one slot may comprise 14 symbols, it may increase resource utilization efficiency by allowing one slot of the resource pool for SL PRS to comprise one or more SL PRS occasions within one slot. In some examples, the resource pool for SL PRS may comprise (e.g., include and/or have)up to two SL PRS occasions within one slot.

In some examples, the resource pool for SL PRS may configure a number of (consecutive) symbols for one SL PRS occasion. In some examples, the resource pool for SL PRS may configure a number of (consecutive) symbols for one SL PRS occasion and a starting symbol for the one SL PRS occasion. In some examples, the one or more SL PRS occasions within one slot may comprise the same number of (consecutive) symbols. Alternatively and/or additionally, the one or more SL PRS occasions within one slot may comprise different numbers of (consecutive) symbols. In some examples, the one or more SL PRS occasions within one slot may comprise non-overlapped symbols in time domain.

In some examples, the frequency unit of one SL PRS may be the same for the one or more SL PRS occasions within one slot. Alternatively and/or additionally, the frequency unit of one SL PRS may be different for the one or more SL PRS occasions within one slot.

In some examples, the available/usable bandwidth and/or frequency resources of one SL PRS may be the same for the one or more SL PRS occasions within one slot. Alternatively and/or additionally, the available/usable bandwidth and/or frequency resources of one SL PRS may be different for the one or more SL PRS occasions within one slot.

In some examples, the one or more SL PRS occasions within one slot may be associated with the same SCI/PSCCH occasion (within the one slot), e.g., shown in the example structure 1802 shown in FIG. 18A and/or the example structure 1804 shown in FIG. 18B. Alternatively and/or additionally, the one or more SL PRS occasions within one slot may be associated with different SCI/PSCCH occasions (within the one slot), e.g., shown in the example structure 1810 shown in FIG. 18E and/or the example structure 1812 shown in FIG. 18F. The association between SL PRS occasion and SCI/PSCCH occasion (within one slot) may be defined (e.g., predefined), fixed and/or specified.

### Embodiment 4

In Embodiment 4 (of Concept B), a resource pool for SL PRS may have one or more SCI/PSCCH occasions (in time domain) within one slot. One SL PRS occasion may comprise M_{SCI} (consecutive) symbols in the resource pool. Considering one SL PRS (resource) may need one associated SCI/PSCCH and SCI/PSCCH may not support comb-structure/design, it may increase resource capability by allowing one slot of the resource pool for SL PRS to comprise one or more SCI/PSCCH occasions within one slot. In some examples, the resource pool for SL PRS may comprise (e.g., include and/or have) up to two SCI/PSCCH occasions within one slot.

In some examples, the resource pool for SL PRS may configure a number of (consecutive) symbols for one SCI/PSCCH occasion. In some examples, the number may be any of one or two or three. In some examples, the resource pool for SL PRS may configure a number of (consecutive) symbols for one SCI/PSCCH occasion and a starting symbol for the one SCI/PSCCH occasion. In some examples, the one or more SCI/PSCCH occasions within one slot may comprise the same number of (consecutive) symbols. Alternatively and/or additionally, the one or more SCI/PSCCH occasions within one slot may comprise different numbers of (consecutive) symbols. In some examples, the one or more SCI/PSCCH occasions within one slot may comprise non-overlapped symbols in time domain.

In some examples, the frequency unit for SCU/PSCCH may be the same for the one or more SL PRS occasions within one slot. Alternatively and/or additionally, the frequency unit for SCI/PSCCH may be different for the one or more SL PRS occasions within one slot.

In some examples, the one or more SCI/PSCCH occasions within one slot may be associated with the same SL PRS occasion (within the one slot), e.g., shown in the example structure 1814 shown in FIG. 18G. Alternatively and/or additionally, the one or more SCI/PSCCH occasions within one slot may be associated with different SL PRS occasions (within the one slot), e.g., shown in the example structure 1810 shown in FIG. 18E and/or the example structure 1812 shown in FIG. 18F. The association between SCI/PSCCH occasion and SL PRS occasion (within one slot) may be defined (e.g., predefined), fixed and/or specified.

### Embodiment 5

In Embodiment 5 (of Concept B), with regard to a resource pool for SL PRS, when a UE transmits a SCI/PSCCH in one slot or in one scheduling/allocation time unit, the UE (must or mandatory to) transmit (at least) a SL PRS, associated with the SCI/PSCCH, in the one slot or in the one scheduling/allocation time unit. In some examples, when a UE transmits a SCI/PSCCH in one slot or in one scheduling/allocation time unit, the UE is not allowed to not transmit (at least) a SL PRS, associated with the SCI/PSCCH, in the one slot or in the one scheduling/allocation time unit. In some examples, when a UE transmits a SCI/PSCCH in one SCI/PSCCH occasion, the UE (must or mandatory to) transmit (at least) a SL PRS in a SL PRS occasion associated with the one SCI/PSCCH occasion. In some examples, when a UE transmits a SCI/PSCCH in one SCI/PSCCH occasion, the UE is not allowed to receive SL PRS in SL PRS occasion associated with the one SCI/PSCCH occasion.

One, some and/or all of the foregoing examples, concepts, techniques and/or embodiments can be formed and/or combined to a new embodiment.

In some examples, embodiments disclosed herein, such as embodiments described with respect to Concept A, Concept B, Embodiment 1, Embodiment 2, Embodiment 3, Embodiment 4 and Embodiment 5 may be implemented independently and/or separately. Alternatively and/or additionally, a combination of embodiments described herein, such as embodiments described with respect to Concept A, Concept B, Embodiment 1, Embodiment 2, Embodiment 3, Embodiment 4 and/or Embodiment 5, may be implemented. Alternatively and/or additionally, a combination of embodiments described herein, such as embodiments described with respect to Concept A, Concept B, Embodiment 1, Embodiment 2, Embodiment 3, Embodiment 4 and/or Embodiment 5, may be implemented concurrently and/or simultaneously.

Various techniques, embodiments, methods and/or alternatives of the present disclosure may be performed independently and/or separately from one another. Alternatively and/or additionally, various techniques, embodiments, methods and/or alternatives of the present disclosure may be combined and/or implemented using a single system. Alternatively and/or additionally, various techniques, embodiments, methods and/or alternatives of the present disclosure may be implemented concurrently and/or simultaneously.

With respect to one or more embodiments herein, such as one or more techniques, devices, concepts, methods, example scenarios and/or alternatives described above, in some examples, a symbol (e.g., one symbol) between a SCI/PSCCH occasion and a subsequent SL PRS occasion (e.g., the subsequent SL PRS occasion may correspond a next and/or closest SL PRS occasion following the SCI/PSCCH occasion) may be utilized for AGC. Alternatively and/or additionally, there may be no AGC symbol (e.g., no symbol utilized for AGC) between the SCI/PSCCH occasion and the subsequent SL PRS occasion.

With respect to one or more embodiments herein, in some examples, one symbol between two SL PRS occasions (e.g., two adjacent/neighboring SL PRS occasions) may be utilized for AGC. In some examples, two symbols between two SL PRS occasions (e.g., two adjacent/neighboring SL PRS occasions) may be utilized for Gap/TX-RX_Switch and AGC (respectively). Alternatively and/or additionally, there may be no AGC/Gap/TX-RX_Switch symbol between two SL PRS occasions (e.g., two adjacent/neighboring SL PRS occasions).

With respect to one or more embodiments herein, in some examples, the first/initial symbol of one slot or one scheduling/allocation time unit may be utilized for AGC. In some examples, the last symbol of one slot or one scheduling/allocation time unit may be utilized as gap symbol for possible TX-RX switch.

With respect to one or more embodiments herein, in some examples, other example structures other than those explicitly shown in the drawings of the present disclosure are within the scope of the present disclosure. Some embodiments within the scope of the present disclosure may have differences with the example structures shown in the drawings of the present disclosure, wherein the differences may comprise one or more differences associated with distribution of AGC, SCI/PSCCH, SL PRS, Gap, TX-RX switch, and/or resource pool configuration (e.g., the one or more differences may depend on future design).

With respect to one or more embodiments herein, in some examples, the SCI/PSCCH associated with SL PRS may comprise information for scheduling/indicating/allocating SL PRS resource. In some examples, the SCI/PSCCH in the resource pool for SL PRS may not comprise information for PSSCH/PSFCH. In some examples, the SCI/PSCCH in the resource pool for SL PRS may be different from another SCI/PSCCH in a resource pool with sidelink communication (e.g., PSSCH and/or PSFCH). In some examples, the SCI/PSCCH associated with SL PRS may be different from another SCI/PSCCH associated with PSSCH and/or PSFCH.

With respect to one or more embodiments herein, in some examples, the SCI associated with SL PRS may be transmitted/delivered via PSCCH. In some examples, the SCI associated with SL PRS may correspond to (e.g., may be) one-stage SCI. In some examples, the SCI associated with SL PRS may not be (and/or may not comprise) two-stage SCI. In some examples, the SCI associated with SL PRS may not be transmitted/delivered via 1st stage SCI and 2nd stage SCI.

With respect to one or more embodiments herein, in some examples, sidelink control information for PSSCH may be transmitted/delivered via 1st stage SCI and 2nd stage SCI. In some examples, the sidelink control information for PSSCH may be delivered at least in PSCCH. In some examples, the sidelink control information for PSSCH may comprise 1st stage SCI. In some examples, the 1st stage SCI may be transmitted via PSCCH. In some examples, the sidelink control information for PSSCH may comprise 2nd stage SCI. In some examples, the 2nd stage SCI may be transmitted via multiplexed with PSSCH. In some examples, the SCI format 1 or SCI format 1-X is 1st stage SCI. In some examples, the SCI format 2-A or 2-B or 2-C or 2-X is a 2nd stage SCI.

With respect to one or more embodiments herein, in some examples, for transmitting PSSCH in a slot or subslot, TX UE needs to transmit SCI in the slot or the subslot for scheduling the PSSCH.

With respect to one or more embodiments herein, in some examples, the resource pool for SL PRS may be a dedicated resource pool for SL PRS. In some examples, the resource pool for SL PRS may be a dedicated resource pool for sidelink reference signal and/or sidelink control information.

With respect to one or more embodiments herein, in some examples, the resource pool for SL PRS may not be a resource pool with sidelink communication (e.g., PSCCH/PSSCH and/or PSFCH). Alternatively and/or additionally, the resource pool for SL PRS may be a shared resource pool with sidelink communication. The resource pool for SL PRS may comprise PSSCH and/or PSFCH resources.

With respect to one or more embodiments herein, in some examples, the SL PRS may be applied/utilized for (absolute and/or relative) positioning and/or ranging.

With respect to one or more embodiments herein, in some examples, the SL PRS may be applied/utilized for any of time-based positioning/ranging methods and/or angle-based positioning/ranging methods. In some examples, the SL PRS may be applied/utilized for any of TDOA, RTT-based positioning/ranging, AoA, AoD, or carrier phase measurement based positioning.

With respect to one or more embodiments herein, in some examples, one, some and/or all embodiments (e.g., implementations and/or techniques) provided herein (in Concept A and/or Concept B, for example) with respect to SL PRS may be applied for other reference signal (e.g., a different type of reference signal other than SL PRS, for example).

With respect to one or more embodiments herein, in some examples, one, some and/or all embodiments (e.g., implementations and/or techniques) provided herein (in Concept A and/or Concept B, for example) with respect to SL PRS may be applied for SL Channel State Information based Reference Signal (CSI-RS) (for beam management, for example). In an example, one, some and/or all instances of the term “SL PRS” in the present disclosure may be replaced with “CSI-RS”.

With respect to one or more embodiments herein, in some examples, one, some and/or all embodiments (e.g., implementations and/or techniques) provided herein (in Concept A and/or Concept B, for example) with respect to SL PRS may be applied for reference signal for localization (e.g., High-Resolution localization). In an example, one, some and/or all instances of the term “SL PRS” in the present disclosure may be replaced with “reference signal for localization” and/or “reference signal for High-Resolution localization”.

With respect to one or more embodiments herein, in some examples, one, some and/or all embodiments (e.g., implementations and/or techniques) provided herein (in Concept A and/or Concept B, for example) with respect to SL PRS may be applied for reference signal for sensing (e.g., High-Resolution sensing). In an example, one, some and/or all instances of the term “SL PRS” in the present disclosure may be replaced with “reference signal for sensing” and/or “reference signal for High-Resolution sensing”.

With respect to one or more embodiments herein, in some examples, one, some and/or all embodiments (e.g., implementations and/or techniques) provided herein (in Concept A and/or Concept B, for example) with respect to SL PRS may be applied for reference signal for imaging (e.g., High-Resolution imaging). In an example, one, some and/or all instances of the term “SL PRS” in the present disclosure may be replaced with “reference signal for imaging” and/or “reference signal for High-Resolution imaging”.

With respect to one or more embodiments herein, in some examples, the slot may correspond to (e.g., may be and/or may refer to) a sidelink slot. In some examples, the slot may be represented as and/or replaced with a Transmission Time Interval (TTI). In some examples, in the present disclosure, one, some and/or all instances of the term “slot” may be replaced with the term “TTI”.

With respect to one or more embodiments herein, in some examples, the sidelink slot may correspond to (e.g., may be and/or may refer to) slot for sidelink. In some examples, a TTI may be a subframe (for sidelink, for example), a slot (for sidelink, for example) or a sub-slot (for sidelink, for example). In some examples, a TTI comprises multiple symbols, e.g., 12, 14 or other number of symbols. In some examples, a TTI may be a slot comprising sidelink symbols (e.g., the slot may fully/partially comprise the sidelink symbols). In some examples, a TTI may correspond to (e.g., may be and/or may refer to) a transmission time interval for a sidelink transmission (e.g., a sidelink data transmission). In some examples, a sidelink slot (e.g., a slot for sidelink) may comprise orthogonal frequency-division multiplexing (OFDM) symbols (e.g., all OFDM symbols) available for sidelink transmission. In some examples, a sidelink slot (e.g., a slot for sidelink) may comprise a set of contiguous (e.g., consecutive) symbols that are available for sidelink transmission. In some examples, a sidelink slot (e.g., a slot for sidelink) may correspond to (e.g., may be and/or may refer to) a slot that is included in a sidelink resource pool.

With respect to one or more embodiments herein, in some examples, the symbol may correspond to (e.g., may be and/or may refer to) a symbol indicated/configured for sidelink.

With respect to one or more embodiments herein, in some examples, the slot may correspond to (e.g., may comprise and/or may refer to) a sidelink slot associated with the resource pool (e.g., the sidelink resource pool). In some examples, the slot may not correspond to (e.g., may not comprise and/or may not refer to) a sidelink slot associated with a different resource pool (e.g., a second sidelink resource pool different than the sidelink resource pool).

With respect to one or more embodiments herein, in some examples, the contiguous/consecutive slots may mean contiguous sidelink slots in/for the (sidelink) resource pool.

With respect to one or more embodiments herein, in some examples, the contiguous/consecutive slots may or may not be contiguous/consecutive in physical slots. In some examples, there may be one or more resource pools (e.g., one or more sidelink resource pools) in a sidelink Bandwidth Part (BWP) and/or a sidelink carrier/cell.

With respect to one or more embodiments herein, in some examples, a sub-channel is a unit for sidelink resource allocation and/or scheduling (e.g., sidelink resource allocation and/or scheduling for PSSCH). In some examples, a sub-channel may comprise multiple contiguous Physical Resource Blocks (PRBs) in frequency domain. In some examples, the number of PRBs for each sub-channel may be configured (e.g., pre-configured) for a sidelink resource pool. In some examples, a sidelink resource pool configuration (e.g., a sidelink resource pool pre-configuration) may indicate and/or configure the number of PRBs for each sub-channel. In some examples, the number of PRBs for a sub-channel (e.g., each sub-channel of one, some and/or all sub-channels of the sidelink resource pool) may be 10, 12, 15, 20, 25, 50, 75, 100, and/or other value. In some examples, a sub-channel may be represented as a unit for sidelink resource allocation and/or scheduling. In some examples, a sub-channel may correspond to (e.g., may be and/or may refer to) a set of contiguous (e.g., consecutive) PRBs in frequency domain. In some examples, a sub-channel may correspond to (e.g., may be and/or may refer to) a set of contiguous (e.g., consecutive) resource elements in frequency domain.

With respect to one or more embodiments herein, in some examples, the first UE may have (and/or may maintain and/or establish) multiple sidelink links/connections on PC5 interface. For different sidelink links/connections, the first UE may perform sidelink transmission/reception to/from different paired UE(s).

With respect to one or more embodiments herein, in some examples, the first UE may have (and/or may maintain and/or establish) a first sidelink link/connection and a second sidelink link/connection. A first paired UE of the first sidelink link/connection (e.g., the first UE may communicate with the first paired UE using the first sidelink link/connection) may be different from a second paired UE of the second sidelink link/connection (e.g., the first UE may communicate with the second paired UE using the second sidelink link/connection). In some examples, one or more sidelink logical channels associated with the first sidelink link/connection (e.g., one or more sidelink logical channels associated with the first paired UE of the first sidelink link/connection) are separate and/or independent from one or more sidelink logical channels associated with the second sidelink link/connection (e.g., one or more sidelink logical channels associated with the second paired UE of the second sidelink link/connection).

With respect to one or more embodiments herein, in some examples, the UE may be and/or comprise a device.

With respect to one or more embodiments herein, in some examples, the sidelink transmission and/or reception may be UE-to-UE transmission and/or reception. The sidelink transmission and/or reception may be device-to-device transmission and/or reception, may be Vehicle-to-Everything (V2X) transmission and/or reception, and/or may be Pedestrian-to-Everything (P2X) transmission and/or reception. In some examples, the sidelink transmission and/or reception may be on a PC5 interface.

With respect to one or more embodiments herein, in some examples, the PC5 interface may be a wireless interface for communication between a device and a device. The PC5 interface may be a wireless interface for communication between devices and/or between UEs. The PC5 interface may be a wireless interface for V2X and/or P2X communication. The Uu interface may be a wireless interface for communication between a network node and a device. The Uu interface may be a wireless interface for communication between a network node and a UE.

With respect to one or more embodiments herein, in some examples, the first UE may be a first device. The first UE may be a vehicle UE and/or a V2X UE.

With respect to one or more embodiments herein, in some examples, the second UE may be a second device. The second UE may be a vehicle UE and/or a V2X UE.

With respect to one or more embodiments herein, in some examples, the first UE and the second device are different devices.

In some examples, in the present disclosure, one, some and/or all instances of the term “frequency offset” may be replaced with the term “comb-offset” (e.g., 0-N−1).

With respect to one or more embodiments herein, in some examples, different R-X (e.g., different SCI/PSCCH resources R-X) in FIGS. 18A-18I may comprise different number of frequency resources (e.g., PRBs) for SCI/PSCCH.

With respect to one or more embodiments herein, in some examples, (for FIGS. 18A-18I, for example) R1 may comprise more number of PRBs than R12.

With respect to one or more embodiments herein, in some examples, for bandwidth of sidelink resource pool cannot be equally divided into multiple frequency resources of SCI/PSCCH, Ri may comprise more number of PRBs than Rj or the same number of PRBs as Rj, wherein j is larger than i.

With respect to one or more embodiments herein, in some examples, in FIGS. 18A-18I, bandwidth or occupied PRBs of R1-R12 may be smaller than or equal to bandwidth or occupied PRBs of the sidelink resource pool (e.g., the one sidelink resource pool) for SL PRS.

With respect to one or more embodiments herein, in some examples, different SL PRS region may be configured with different comb-N. In some examples, SL PRS region index/offset j (for determining associated SCI/PSCCH resource) is derived/determined based on comb-N of SL PRS region j−1, wherein j=1, 2, . . . .

With respect to one or more embodiments herein, in some examples, each/one of SL PRS region may be configured (e.g., pre-configured) with one SL PRS region (frequency) offset (for determining associated SCI/PSCCH resource). In some examples, the SL PRS region frequency offset is applied with respect or referenced to starting sub-channel/PRB which is the lowest sub-channel/PRB of the SL PRS region. In some examples, the UE determines/derives association between SL PRS region and SCI/PSCCH resource based on (explicitly) configured (e.g., pre-configured) SL PRS region frequency offset.

With respect to one or more embodiments herein, in some examples, the UE determines/derives association between SL PRS region and SCI/PSCCH resource based on (implicitly) comb-N of SL PRS region with preceding SL PRS region index or 0 (in other words, implicit method does not need configured (e.g., pre-configured) SL PRS region offset). In some examples, the SL PRS region frequency offset is applied with respect or referenced to last SCI/PSCCH resource associated with SL PRS region with preceding SL PRS region index or 0.

With respect to one or more embodiments herein, in some examples, the UE may be (explicitly) configured (e.g., pre-configured) with a number of SCI/PSCCH resources for one SL PRS region. For example, in the example structure 1802 shown in FIG. 18A, SL PRS region may be configured (e.g., pre-configured) with 3.

For example, in the example structure 1802 shown in FIG. 18A, each SL PRS region may be configured (e.g., pre-configured) with SL PRS region index/offset. In some examples, SL PRS region index/offset is used for determining SCI/PSCCH for each SL PRS region. In some examples, SL PRS region index/offset is used for separation between different SL PRS region's SCI/PSCCH resource. In this example, SL PRS region 1 may be configured (e.g., pre-configured) with SL PRS region index/offset as 0. SL PRS region 2 may be configured (e.g., pre-configured) with SL PRS region index/offset as 0. Alternatively and/or additionally, SL PRS region 2 may be configured (e.g., pre-configured) with SL PRS region index/offset as 6 (with respect to R1). SL PRS region 3 may be configured (e.g., pre-configured) with SL PRS region index/offset as 3 (with respect to R1). In some examples, number of SCI/PSCCH resource associated with one SL PRS region may be unequal (e.g., comb-N with N-K associated SCI/PSCCH resource).

With respect to one or more embodiments herein, in some examples, for two SL PRS regions separated in different frequencies in a sidelink resource pool (Frequency Division Multiplexing (FDM) SL PRS region), bandwidth of one of two SL PRS regions may be different or the same than bandwidth of the other one of two SL PRS regions. For example, in FIGS. 18A-18I, SL PRS region 1 may comprise Q PRBs/sub-channels and SL PRS region 2 may comprise W PRBs/sub-channels. In some examples, Q is different or the same as W. In an example, W plus Q is equal to bandwidth of SL resource pool for SL PRS.

With respect to one or more embodiments herein, in some examples, SL PRS region may be replaced by one or more SL PRS(s), one or more SL PRS bandwidth(s), one or more SL PRS frequency occasion(s), or a group/set of SL PRS which may be multiplexed in (resource element level in) one PRB (especially in one occasion).

With respect to one or more embodiments herein, in some examples, one SL resource pool for SL PRS may comprise one or more SL PRS region(s). In some examples, one SL PRS occasion may comprise one or more SL PRS region(s). In some examples, for every slot in SL resource pool for SL PRS, same number of SL PRS region may be configured (e.g., pre-configured). In some examples, different slots in SL resource pool for SL PRS may comprise different numbers of SL PRS regions. In an example, SL PRS region may have periodicity in unit of slot or slot pattern in SL resource pool for SL PRS. For example, SL PRS region 1 may be in every slot in SL resource pool for SL PRS, while SL PRS region 2 may be with logical slot index i, i+P, i+2P, wherein P is periodicity for SL PRS region 2. In this example, for slots i, i+P, i+2P, . . . i+XP, there may be two SL PRS regions while for slots other than slots i, i+P, i+2P, . . . i+XP, there may be one SL PRS region.

With respect to one or more embodiments herein, in some examples, every slot in SL resource pool for SL PRS may correspond same number of occasions for SL PRS. In some examples, different slots in SL resource pool for SL PRS may correspond different numbers of occasions for SL PRS. For example, slot i comprises 2 occasion for SL PRS while slot j comprises 1 occasion for SL PRS. In some examples, the 1 occasion for SL PRS may be earlier one or latter one in slot j.

With respect to one or more embodiments herein, in some examples, one SL resource pool for SL PRS may comprise distribution of SL PRS occasion and/or SL PRS region (e.g., any combinations of one some and/or all example structures provided with respect to FIGS. 18A-18I). In an example, SL PRS region may have periodicity in unit of slot or slot pattern in SL resource pool for SL PRS, wherein the periodicity or the slot pattern is utilized for determining which slots apply in the example structure 1806 shown in FIG. 18C-similar distribution and which slots apply in the example structure 1808 shown in FIG. 18D-similar distribution and so on.

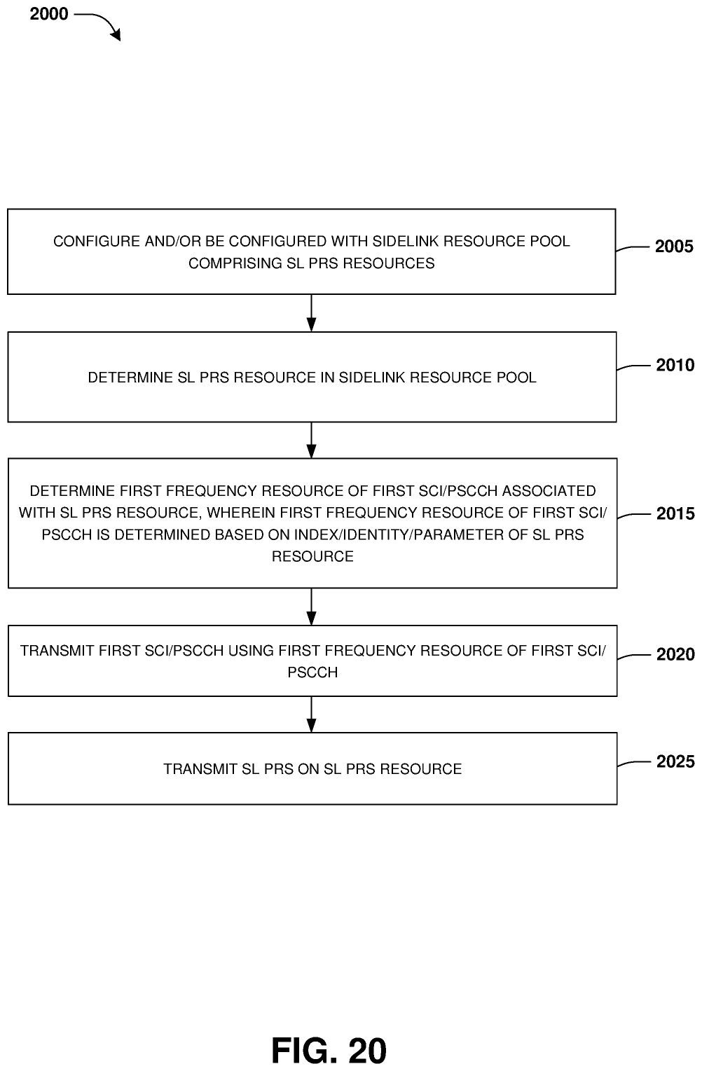

FIG. 20 is a flow chart 2000 according to one exemplary embodiment from the perspective of a first device. In step 2005, the first device configures and/or is configured with a sidelink resource pool comprising SL PRS resources. In step 2010, the first device determines (e.g., derives) a SL PRS resource (e.g., one SL PRS resource) in the sidelink resource pool. In step 2015, the first device determines (e.g., derives) a first frequency resource of a first SCI/PSCCH associated with the SL PRS resource (e.g., the one SL PRS resource), wherein the first frequency resource of the first SCI/PSCCH is determined (e.g., derived) based on an index/identity/parameter of the SL PRS resource (e.g., the one SL PRS resource). In step 2020, the first device transmits the first SCI/PSCCH using the first frequency resource of the first SCI/PSCCH (e.g., the first SCI/PSCCH may be transmitted in the first frequency resource). In step 2025, the first device transmits a SL PRS on the SL PRS resource (e.g., the one SL PRS resource).

In one embodiment, the index/identity/parameter of the SL PRS resource (e.g., the one SL PRS resource) comprises (and/or is) a frequency offset and/or comb offset of the SL PRS resource (e.g., the one SL PRS resource). In one embodiment, the frequency offset is in units of REs. In one embodiment, the index/identity/parameter of the SL PRS resource (e.g., the one SL PRS resource) comprises (and/or is) a starting location of a bandwidth and/or one or more frequency resources for the SL PRS resource (e.g., the one SL PRS resource). In one embodiment, the index/identity/parameter of the SL PRS resource (e.g., the one SL PRS resource) comprises (and/or is) a bandwidth and/or one or more frequency resources for the SL PRS resource (e.g., the one SL PRS resource). In one embodiment, the index/identity/parameter of the SL PRS resource (e.g., the one SL PRS resource) comprises (and/or is) a SL PRS region (e.g., a SL PRS region index) for the SL PRS resource (e.g., the one SL PRS resource) (within one slot, for example). In an example, the SL PRS region may be in one slot (and/or may not be in other slots in addition to the one slot). In one embodiment, the index/identity/parameter of the SL PRS resource (e.g., the one SL PRS resource) comprises (and/or is) a SL PRS occasion (e.g., a SL PRS occasion index) for the SL PRS resource (e.g., the one SL PRS resource) (within one slot, for example). In an example, the SL PRS occasion may be in one slot (and/or may not be in other slots in addition to the one slot).

In one embodiment, an index/identity/parameter of a second SL PRS resource (e.g., a possible/candidate SL PRS resource and/or a SL PRS resource of the sidelink resource pool) comprises (and/or is) a frequency offset and/or comb offset of the second SL PRS resource. In one embodiment, the frequency offset is in units of REs. In one embodiment, the index/identity/parameter of the second SL PRS resource comprises (and/or is) a starting location of a bandwidth and/or one or more frequency resources for the second SL PRS resource. In one embodiment, the index/identity/parameter of the second SL PRS resource comprises (and/or is) a bandwidth and/or one or more frequency resources for the second SL PRS resource. In one embodiment, the index/identity/parameter of the second SL PRS resource comprises (and/or is) a SL PRS region (e.g., a SL PRS region index) for the second SL PRS resource (within one slot, for example). In one embodiment, the index/identity/parameter of the second SL PRS resource comprises (and/or is) a SL PRS occasion (e.g., a SL PRS occasion index) for the second SL PRS resource (within one slot, for example).

Referring back to FIGS. 3 and 4, in one exemplary embodiment of a first device, the device 300 includes a program code 312 stored in the memory 310. The CPU 308 may execute program code 312 to enable the first device (i) to configure and/or be configured with a sidelink resource pool comprising SL PRS resources, (ii) to determine (e.g., derive) a SL PRS resource (e.g., one SL PRS resource) in the sidelink resource pool, (iii) to determine (e.g., derive) a first frequency resource of a first SCI/PSCCH associated with the SL PRS resource (e.g., the one SL PRS resource), wherein the first frequency resource of the first SCI/PSCCH is determined (e.g., derived) based on an index/identity/parameter of the SL PRS resource (e.g., the one SL PRS resource), (iv) to transmit the first SCI/PSCCH using the first frequency resource of the first SCI/PSCCH, and (v) to transmit SL PRS on the SL PRS resource (e.g., the one SL PRS resource). Furthermore, the CPU 308 can execute the program code 312 to perform one, some and/or all of the above-described actions and steps and/or others described herein.

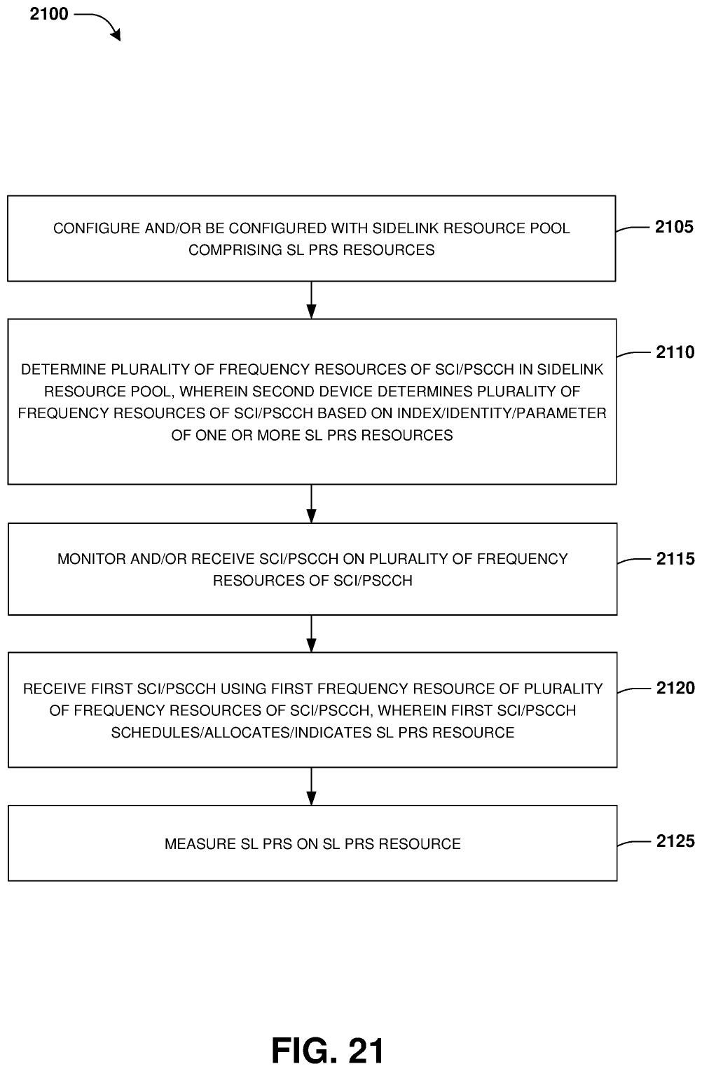

FIG. 21 is a flow chart 2100 according to one exemplary embodiment from the perspective of a second device. In step 2105, the second device configures and/or is configured with a sidelink resource pool comprising SL PRS resources. In step 2110, the second device determines (e.g., derives) a plurality of frequency resources (e.g., a plurality of possible/candidate frequency resources) of SCI/PSCCH in the sidelink resource pool, wherein the second device determines (e.g., derives) the plurality of frequency resources of SCI/PSCCH based on an index/identity/parameter of one or more SL PRS resources (e.g., one or more possible/candidate SL PRS resources). The one or more SL PRS resources may comprise one or more SL PRS resources of the sidelink resource pool. In step 2115, the second device monitors and/or receives SCI/PSCCH on the plurality of frequency resources of SCI/PSCCH. In some examples, the second device performs monitoring (e.g., monitors for SCI/PSCCH) in at least some of the plurality of frequency resources of SCI/PSCCH. In step 2120, the second device receives a first SCI/PSCCH using (e.g., from) a first frequency resource (e.g., one frequency resource) of the plurality of frequency resources of SCI/PSCCH (e.g., the first SCI/PSCCH may be received from the first frequency resource), wherein the first SCI/PSCCH indicates (and/or schedules and/or allocates) a SL PRS resource (e.g., one SL PRS resource). In step 2125, the second device measures SL PRS on the SL PRS resource. The first SCI/PSCCH (received using the first frequency resource, for example) schedules the SL PRS on the SL PRS resource (e.g., the one SL PRS resource).

Referring back to FIGS. 3 and 4, in one exemplary embodiment of a second device, the device 300 includes a program code 312 stored in the memory 310. The CPU 308 may execute program code 312 to enable the second device (i) to configure and/or be configured with a sidelink resource pool comprising SL PRS resources, (ii) to determine (e.g., derive) a plurality of frequency resources (e.g., a plurality of possible/candidate frequency resources) of SCI/PSCCH in the sidelink resource pool, wherein the second device determines (e.g., derives) the plurality of frequency resources of SCI/PSCCH based on an index/identity/parameter of one or more SL PRS resources (e.g., one or more possible/candidate SL PRS resources), (iii) to monitor and/or receive SCI/PSCCH on the plurality of frequency resources of SCI/PSCCH, (iv) to receive a first SCI/PSCCH using (e.g., from) a first frequency resource (e.g., one frequency resource) of the plurality of frequency resources of SCI/PSCCH (e.g., the first SCI/PSCCH may be received from the first frequency resource), wherein the first SCI/PSCCH indicates (and/or schedules and/or allocates) a SL PRS resource (e.g., one SL PRS resource), and (v) to measure SL PRS on the SL PRS resource (e.g., the one SL PRS resource). Furthermore, the CPU 308 can execute the program code 312 to perform one, some and/or all of the above-described actions and steps and/or others described herein.

With respect to FIGS. 20 and 21, in one embodiment, the first frequency resource of the first SCI/PSCCH is determined (e.g., derived) (by the first device, for example) based on one or more indexes/identities/parameters of the SL PRS resource (e.g., the one SL PRS resource).

In one embodiment, the plurality of frequency resources of SCI/PSCCH (e.g., the plurality of possible/candidate frequency resources of SCI/PSCCH) is determined (e.g., derived) (by the second device, for example) based on one or more indexes/identities/parameters of one or more SL PRS resources (e.g., one or more possible/candidate SL PRS resources), which may comprise one or more SL PRS resources of the sidelink resource pool and/or the SL PRS resource (e.g., the one SL PRS resource).

In one embodiment, multiple SL PRS resources with the same bandwidth are multiplexed based on comb-structure in the sidelink resource pool. In one embodiment, the comb-structure is at least one of fully staggered SL PRS pattern, partially staggered SL PRS pattern, unstaggered SL PRS pattern, or other SL PRS pattern.

In one embodiment, there are one or more SCI/PSCCH occasions in a slot (e.g., one slot) of the sidelink resource pool. In one embodiment, there are one or more SL PRS occasions in a slot (e.g., one slot) of the sidelink resource pool. In one embodiment, there are one or more SL PRS regions in a SL PRS occasion (e.g., one SL PRS occasion).

In one embodiment, a SCI/PSCCH occasion (e.g., one SCI/PSCCH occasion) is associated with a SL PRS occasion (e.g., one SL PRS occasion). In one embodiment, a SCI/PSCCH occasion (e.g., one SCI/PSCCH occasion) is associated with one or more SL PRS occasions. In one embodiment, a SL PRS occasion (e.g., one SL PRS occasion) is associated with one or more SCI/PSCCH occasions.

In one embodiment, a SCI/PSCCH transmission (e.g., one SCI/PSCCH transmission) on a frequency resource (e.g., one frequency resource) of SCI/PSCCH is associated with a SL PRS resource (e.g., one SL PRS resource) in a slot (e.g., one slot).

In one embodiment, when a first number of resources of a plurality of frequency resources of SCI/PSCCH (e.g., a plurality of possible/candidate frequency resources of SCI/PSCCH) is smaller than a second number of resources of a plurality of associated SL PRS resources (e.g., SL PRS resources associated with the plurality of frequency resources of SCI/PSCCH), the first device uses and/or is able to use (e.g., transmit and/or use for transmission) (associated) SL PRS resources (among the plurality of associated SL PRS resources) amounting to (up to) the first number of resources among the plurality of associated SL PRS resources. In some examples, the plurality of frequency resources of SCI/PSCCH may comprise frequency resources of SCI/PSCCH in one slot (e.g., the first number of resources may correspond to a number of frequency resources of SCI/PSCCH in the one slot), and/or the plurality of associated SL PRS resources may comprise SL PRS resources in the one slot (e.g., the second number of resources may correspond to a number of (associated) SL PRS resources in the one slot).

In one embodiment, when a first number of resources of a plurality of frequency resources of SCI/PSCCH (e.g., a plurality of possible/candidate frequency resources of SCI/PSCCH) is larger than a second number of resources of a plurality of associated SL PRS resources (e.g., SL PRS resources associated with the plurality of frequency resources of SCI/PSCCH), the first device uses and/or is able to use (e.g., transmit and/or use for transmission) frequency resources (among the plurality of frequency resources of SCI/PSCCH) amounting to (up to) the second number of resources. In some examples, the plurality of frequency resources of SCI/PSCCH may comprise frequency resources of SCI/PSCCH in one slot (e.g., the first number of resources may correspond to a number of frequency resources of SCI/PSCCH in the one slot), and/or the plurality of associated SL PRS resources may comprise SL PRS resources in the one slot (e.g., the second number of resources may correspond to a number of (associated) SL PRS resources in the one slot).

In one embodiment, a SL PRS resource (e.g., one SL PRS resource) is in a SL PRS occasion (e.g., one SL PRS occasion), and/or a SL PRS occasion (e.g., one SL PRS occasion) comprises one or more consecutive symbols in a slot and/or a scheduling/allocating time unit of the sidelink resource pool.

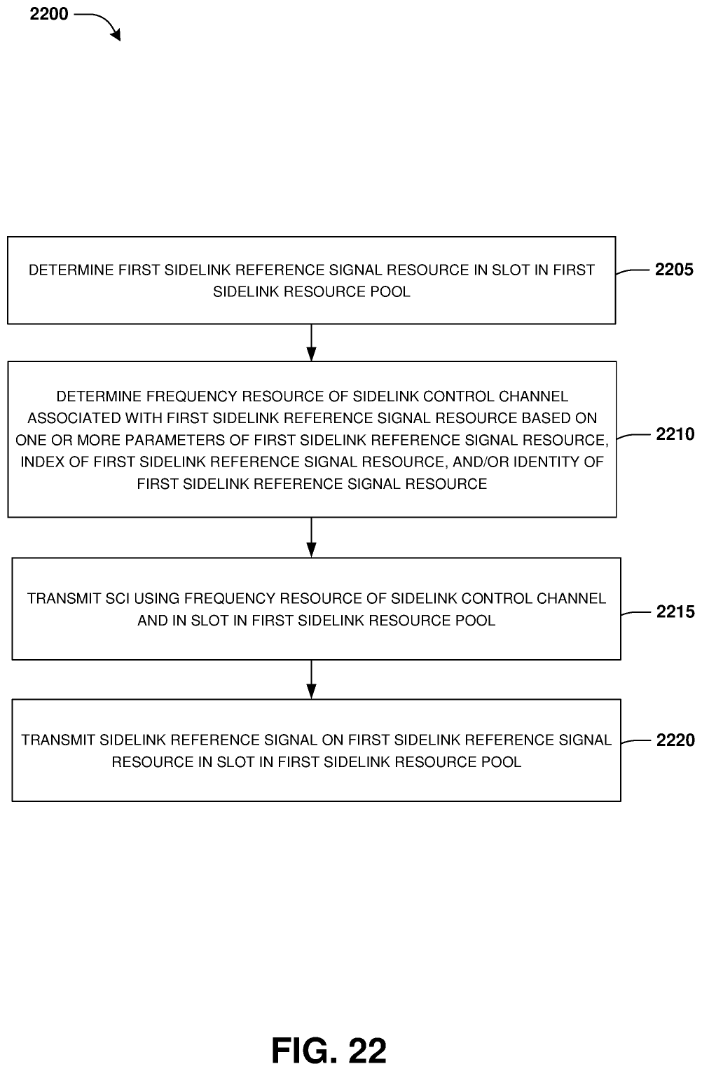

FIG. 22 is a flow chart 2200 according to one exemplary embodiment from the perspective of a first device. The first device has a configuration of a first sidelink resource pool comprising sidelink reference signal resources (e.g., the first device receives the configuration of the first sidelink resource pool). In step 2205, the first device determines (e.g., derives) a first sidelink reference signal resource in a slot in the first sidelink resource pool. In some examples, the first sidelink resource pool comprises the first sidelink reference signal resource. The first device may determine (e.g., derive) the first sidelink reference signal resource based on the first sidelink resource pool. In step 2210, the first device determines (e.g., derives) a frequency resource of a sidelink control channel associated with the first sidelink reference signal resource based on one or more parameters of the first sidelink reference signal resource, an index of the first sidelink reference signal resource, and/or an identity of the first sidelink reference signal resource. In step 2215, the first device transmits, using the frequency resource of the sidelink control channel and in the slot in the first sidelink resource pool, a SCI. In step 2220, the first device transmits a sidelink reference signal on the first sidelink reference signal resource in the slot in the first sidelink resource pool.

In one embodiment, the first sidelink resource pool comprises one or more sidelink reference signal time occasions in the slot. In one embodiment, the one or more parameters of the first sidelink reference signal resource comprise timing information associated with the first sidelink reference signal resource (e.g., the timing information may be indicative of a transmission time of the first sidelink reference signal resource). In one embodiment, the one or more parameters of the first sidelink reference signal resource comprise an indication of a sidelink reference signal time occasion (e.g., a sidelink reference signal time occasion index). In one embodiment, the first sidelink reference signal resource is in the sidelink reference signal time occasion. In an example, the indication of the sidelink reference signal time occasion (and/or the sidelink reference signal time occasion index) may indicate that the first sidelink reference signal resource is in the sidelink reference signal time occasion in the slot. In one embodiment, the one or more parameters of the first sidelink reference signal resource comprise timing information associated with the sidelink reference signal time occasion in the slot. In an example, the timing information may indicate that the first sidelink reference signal resource is in the sidelink reference signal time occasion in the slot.

In one embodiment, the one or more parameters of the first sidelink reference signal resource comprise (i) a frequency offset of the first sidelink reference signal resource (e.g., the frequency offset may be in units of REs), (ii) a comb offset of the first sidelink reference signal resource (e.g., the comb offset may be in units of REs), and/or (iii) a RE offset of the first sidelink reference signal resource (e.g., the RE offset may be in units of REs).

In one embodiment, the frequency resource of the sidelink control channel is determined (e.g., derived) based on an association between the frequency resource of the sidelink control channel and (i) the one or more parameters of the first sidelink reference signal resource, (ii) the index of the first sidelink reference signal resource, and/or (iii) the identity of the first sidelink reference signal resource. In one embodiment, the association is configured and/or specified for the first device. In an example, the first device is configured (e.g., pre-configured) with the association. In one embodiment, the first device receives an indication of the association (e.g., the association is indicated to the first device and/or one or more other devices). In one embodiment, the association is applied in (and/or is applicable to) the slot. In some examples, the association comprises a mapping relationship (between the frequency resource of the sidelink control channel and the one or more parameters, the index, and/or the identity of the first sidelink reference signal resource, for example). In some examples, the first device determines (e.g., derives) the frequency resource of the sidelink control channel by mapping the one or more parameters, the index, and/or the identity of the first sidelink reference signal resource to the frequency resource using the mapping relationship.

In one embodiment, the frequency resource of the sidelink control channel is determined (e.g., derived) based on an association between the frequency resource of the sidelink control channel and the first sidelink reference signal resource. In one embodiment, the association is configured and/or specified for the first device. In an example, the first device is configured (e.g., pre-configured) with the association. In one embodiment, the first device receives an indication of the association (e.g., the association is indicated to the first device and/or one or more other devices). In one embodiment, the association is applied in (and/or is applicable to) the slot. In some examples, the association comprises a resource mapping relationship (between the frequency resource of the sidelink control channel and the first sidelink reference signal resource, for example). In some examples, the first device determines (e.g., derives) the frequency resource of the sidelink control channel by mapping the first sidelink reference signal resource to the frequency resource using the resource mapping relationship.

In one embodiment, the frequency resource of the sidelink control channel is associated with (e.g., is indicative of) the first sidelink reference signal resource.

In one embodiment, one sidelink reference signal resource in the slot in the first sidelink resource pool (e.g., the first sidelink resource pool may comprise the one sidelink reference signal resource) is associated with one frequency resource (e.g., only one frequency resource) of the sidelink control channel. In an example, the first sidelink reference signal resource is associated with one frequency resource (e.g., only one frequency resource) of the sidelink control channel in the same slot. In an example, each sidelink reference signal resource of one, some and/or all sidelink reference signal resources of the first sidelink resource pool is associated with one frequency resource (e.g., only one frequency resource) of the sidelink control channel in the same slot. In some examples, different sidelink reference signal resources of the first sidelink resource pool in one slot are associated with different frequency resources of the sidelink control channel in the one slot.

In one embodiment, the first sidelink resource pool comprises a plurality of sidelink reference signal resources in the slot. In one embodiment, each sidelink reference signal resource of the plurality of sidelink reference signal resources is associated with a set of frequency resources occupying and/or covering a full bandwidth of the first sidelink resource pool (in PRB-level, for example) and/or full frequency resources of the first sidelink resource pool (in PRB-level, for example). In an example, the set of frequency resources may correspond to the full bandwidth of the first sidelink resource pool (in PRB-level, for example) and/or the full frequency resources of the first sidelink resource pool (in PRB-level, for example). In an example, the set of frequency resources may correspond to an available and/or usable bandwidth of a sidelink reference signal resource of the plurality of sidelink reference signal resources. For example, each sidelink reference signal resource of the plurality of sidelink reference signal resources may have an available and/or usable bandwidth that occupies and/or covers the full bandwidth of the first sidelink resource pool. In an example, the set of frequency resources may correspond to available and/or usable frequency resources of a sidelink reference signal resource of the plurality of sidelink reference signal resources. In one embodiment, each sidelink reference signal resource of the plurality of sidelink reference signal resources covers and/or occupies the full bandwidth of the first sidelink resource pool in PRB-level (e.g., the full bandwidth may comprise one or more PRBs of the first sidelink resource pool) and/or the full frequency resources of the first sidelink resource pool in PRB-level (e.g., the full frequency resources may comprise one or more PRBs of the first sidelink resource pool). In one embodiment, the plurality of sidelink reference signal resources are multiplexed (e.g., sidelink reference signal resources of the plurality of sidelink reference signal resources are multiplexed with each other) based on a comb-structure (e.g., one or more comb-structures) in one or more sidelink reference signal time occasions in the slot (e.g., one comb-structure is applied in one sidelink reference signal time occasion in the slot). In one embodiment, the plurality of sidelink reference signal resources in the slot are associated with a plurality of frequency resources of the sidelink control channel in one sidelink control channel time occasion in the slot in the first sidelink resource pool. For example, each sidelink reference signal resource of the plurality of sidelink reference signal resources may be associated with a frequency resource of the plurality of frequency resources.

In one embodiment, the first device transmits the SCI, to one or more devices comprising a second device, for scheduling the first sidelink reference signal resource (e.g., the SCI may be used to schedule the first sidelink reference signal resource for transmission of the sidelink reference signal). In one embodiment, the SCI corresponds to a one-stage SCI (e.g., the SCI is transmitted via a single stage, and is not transmitted in multiple stages). In an example, the SCI is not a two-stage SCI. In one embodiment, the first device transmits the one-stage SCI, in the first sidelink resource pool, for scheduling the first sidelink reference signal resource (e.g., the one-stage SCI may be used to schedule the first sidelink reference signal resource for transmission of the sidelink reference signal). In one embodiment, the first device does not transmit a two-stage SCI, in the first sidelink resource pool, for scheduling the first sidelink reference signal resource.

In one embodiment, the first device has configuration of (e.g., receives a configuration of) a second sidelink resource pool with sidelink data resources. In one embodiment, the first device transmits a two-stage SCI, in the second sidelink resource pool, for scheduling a sidelink data transmission in the second sidelink resource pool. The two-stage SCI may comprise a 1st stage SCI and a 2nd stage SCI. In one embodiment, the first device does not transmit a one-stage SCI, in the second sidelink resource pool, for scheduling the sidelink data transmission in the second sidelink resource pool.

In one embodiment, the first sidelink resource pool is a dedicated sidelink resource pool for one or more sidelink reference signals and/or one or more SCIs (e.g., the first sidelink resource pool may be dedicated to transmission, reception and/or measurement of sidelink reference signals and/or SCIs). In one embodiment, the first sidelink resource pool does not comprise sidelink data channel resources (e.g., resources of the first sidelink resource pool may not be used for communication of sidelink data channel resources, such as PSSCH resources).

In one embodiment, the sidelink reference signal is a sidelink positioning reference signal. In one embodiment, the sidelink reference signal is a sidelink CSI-RS for beam management. In one embodiment, the sidelink reference signal corresponds to localization (e.g., high-resolution sidelink localization), positioning (e.g., high-resolution sidelink positioning), ranging (e.g., high-resolution sidelink ranging), sensing (e.g., high-resolution sidelink sensing) and/or imaging (e.g., high-resolution sidelink imaging). In an example, the sidelink reference signal is a signal utilized for localization (e.g., high-resolution sidelink localization), a signal utilized for sensing (e.g., high-resolution sidelink sensing), a signal utilized for positioning (e.g., high-resolution sidelink positioning), a signal utilized for ranging (e.g., high-resolution sidelink ranging), and/or a signal utilized for imaging (e.g., high-resolution sidelink imaging).

In one embodiment, the one or more sidelink reference signal time occasions in the slot comprise a first sidelink reference signal time occasion and a second sidelink reference signal time occasion. In one embodiment, the first sidelink reference signal time occasion is associated with a first bandwidth. For example, each sidelink reference signal resource in the first sidelink reference signal time occasion may be associated with the first bandwidth. For example, the first sidelink reference signal time occasion (and/or each sidelink reference signal resource in the first sidelink reference signal time occasion) may occupy and/or cover the first bandwidth. In one embodiment, the second sidelink reference signal time occasion is associated with the first bandwidth. For example, each sidelink reference signal resource in the second sidelink reference signal time occasion may be associated with the first bandwidth. For example, the second sidelink reference signal time occasion (and/or each sidelink reference signal resource in the second sidelink reference signal time occasion) may occupy and/or cover the first bandwidth. In an example, the first sidelink reference signal time occasion and the second sidelink reference signal time occasion both are associated with (e.g., may occupy and/or cover) the same bandwidth (e.g., the first bandwidth). In one embodiment, the first bandwidth corresponds to a full bandwidth of the first sidelink resource pool (in PRB-level, for example) and/or full frequency resources of the first sidelink resource pool (in PRB-level, for example). In an example, the full bandwidth and/or the full frequency resources of the first sidelink resource pool may correspond to a set of PRBs.

In one embodiment, the first sidelink reference signal time occasion in the slot starts from a first symbol. In one embodiment, the second sidelink reference signal time occasion in the slot starts from a second symbol. In one embodiment, the first symbol is different than the second symbol. In one embodiment, the first sidelink reference signal time occasion and the second sidelink reference signal time occasion are non-overlapped in time domain (e.g., the first sidelink reference signal time occasion and the second sidelink reference signal time occasion do not overlap with each other in time domain). In one embodiment, when (and/or if) the first sidelink reference signal resource is in the first sidelink reference signal time occasion, the one or more parameters of the first sidelink reference signal resource comprise first timing information associated with the first sidelink reference signal time occasion. In one embodiment, when (and/or if) the first sidelink reference signal resource is in the second sidelink reference signal time occasion, the one or more parameters of the first sidelink reference signal resource comprise second timing information associated with the second sidelink reference signal time occasion. In one embodiment, the first timing information is different than the second timing information.

In one embodiment, a first number of sidelink reference signals multiplexed in the first sidelink reference signal time occasion is the same as a second number of sidelink reference signals multiplexed in the second sidelink reference signal time occasion.

In one embodiment, a first number of sidelink reference signals multiplexed in the first sidelink reference signal time occasion is different than a second number of sidelink reference signals multiplexed in the second sidelink reference signal time occasion.

In one embodiment, one sidelink control channel time occasion is in the slot in the first sidelink resource pool (e.g., there is only one sidelink control channel time occasion in the slot in the first sidelink resource pool). In one embodiment, the one sidelink control channel time occasion comprises a plurality of frequency resources (e.g., a plurality of candidate frequency resources) of the sidelink control channel. In one embodiment, the plurality of frequency resources in the one sidelink control channel time occasion are FDMed. For example, frequency resources (e.g., candidate frequency resources) of the plurality of candidate frequency resources are FDMed with each other. In one embodiment, the plurality of candidate frequency resources in the one sidelink control channel time occasion are FDMed in sub-channel-level.

Referring back to FIGS. 3 and 4, in one exemplary embodiment of a first device with a configuration of a first sidelink resource pool comprising sidelink reference signal resources, the device 300 includes a program code 312 stored in the memory 310. The CPU 308 may execute program code 312 to enable the first device (i) to determine a first sidelink reference signal resource in a slot in the first sidelink resource pool, (ii) to determine a frequency resource of a sidelink control channel associated with the first sidelink reference signal resource based on one or more parameters of the first sidelink reference signal resource, an index of the first sidelink reference signal resource, and/or an identity of the first sidelink reference signal resource, (iii) to transmit, using the frequency resource of the sidelink control channel and in the slot in the first sidelink resource pool, a sidelink control information (SCI), and (iv) to transmit a sidelink reference signal on the first sidelink reference signal resource in the slot in the first sidelink resource pool. Furthermore, the CPU 308 can execute the program code 312 to perform one, some and/or all of the above-described actions and steps and/or others described herein.

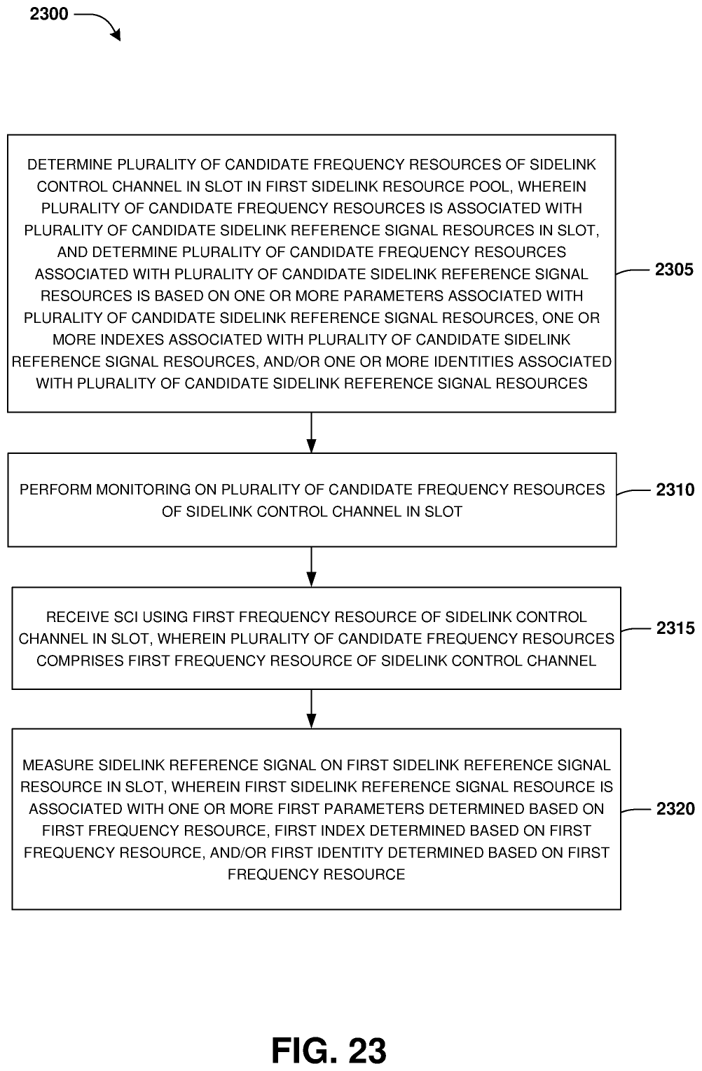

FIG. 23 is a flow chart 2300 according to one exemplary embodiment from the perspective of a second device. The second device has a configuration of a first sidelink resource pool comprising sidelink reference signal resources (e.g., the second device receives the configuration of the first sidelink resource pool). In step 2305, the second device determines (e.g., derives) a plurality of candidate frequency resources of a sidelink control channel in a slot in the first sidelink resource pool. The plurality of candidate frequency resources is associated with a plurality of candidate sidelink reference signal resources in the slot. In an example, each candidate frequency resource of some and/or all of the plurality of candidate frequency resources is associated with a (respective) candidate sidelink reference signal resource (e.g., one candidate sidelink reference signal resource) of the plurality of candidate sidelink reference signal resources. In some examples, each candidate sidelink reference signal resource of some and/or all of the plurality of candidate sidelink reference signal resources is associated with a (respective) candidate frequency resource (e.g., one candidate frequency resource) of the plurality of candidate frequency resources. The second device determines (e.g., derives) the plurality of candidate frequency resources associated with the plurality of candidate sidelink reference signal resources based on one or more parameters associated with the plurality of candidate sidelink reference signal resources, one or more indexes associated with the plurality of candidate sidelink reference signal resources, and/or one or more identities associated with the plurality of candidate sidelink reference signal resources. Embodiments are contemplated in which the second device determines (e.g., derives) the plurality of candidate frequency resources using other information (in addition to the one or more parameters, the one or more indexes, and/or the one or more identities, for example). In some examples, the one or more parameters may comprise a parameter of each candidate sidelink reference signal resource of some and/or all candidate sidelink reference signal resources of the plurality of candidate sidelink reference signal resources. In some examples, the one or more indexes may comprise an index of each candidate sidelink reference signal resource of some and/or all candidate sidelink reference signal resources of the plurality of candidate sidelink reference signal resources. In some examples, the one or more identities may comprise an identity of each candidate sidelink reference signal resource of some and/or all candidate sidelink reference signal resources of the plurality of candidate sidelink reference signal resources. In step 2310, the second device performs monitoring on the plurality of candidate frequency resources of the sidelink control channel in the slot. In some examples, the monitoring performed by the second device (in step 2310) may comprise SCI monitoring and/or PSCCH monitoring (e.g., the second device monitors for SCI/PSCCH). In some examples, the monitoring performed by the second device (in step 2310) may comprise monitoring (e.g., SCI monitoring and/or PSCCH monitoring) on one, some and/or all candidate frequency resources of the plurality of candidate frequency resources. In step 2315, the second device receives a SCI using a first frequency resource of the sidelink control channel in the slot (e.g., the second device receives the SCI on the first frequency resource). The plurality of candidate frequency resources comprises the first frequency resource of the sidelink control channel. In some examples, the SCI is received via the monitoring and/or decoding performed by the second device (in step 2310, for example). In an example, the SCI may be received from the first frequency resource. In step 2320, the second device measures a sidelink reference signal on a first sidelink reference signal resource in the slot. In some examples, the first sidelink reference signal resource is associated with (e.g., is determined based on) one or more first parameters determined based on the first frequency resource of the sidelink control channel, a first index determined based on the first frequency resource of the sidelink control channel, and/or a first identity determined based on the first frequency resource of the sidelink control channel. In some examples, the first frequency resource of the sidelink control channel is indicative of the one or more first parameters, the first index and/or the first identity of the first sidelink reference signal resource. For example, the second device may determine to use the first sidelink reference signal resource (to measure the sidelink reference signal, for example) based on the SCI having been received via the first frequency resource (among the plurality of candidate frequency resources).

In some examples, the one or more parameters associated with the plurality of candidate sidelink reference signal resources may comprise the one or more first parameters associated with the first sidelink reference signal resource. In some examples, the one or more indexes associated with the plurality of candidate sidelink reference signal resources may comprise the first index associated with the first sidelink reference signal resource. In some examples, the one or more identities associated with the plurality of candidate sidelink reference signal resources may comprise the first identity associated with the first sidelink reference signal resource.

In one embodiment, the first sidelink resource pool comprises one or more sidelink reference signal time occasions in the slot. In one embodiment, the one or more first parameters of the first sidelink reference signal resource comprise timing information associated with the first sidelink reference signal resource (e.g., the timing information may be indicative of a transmission time of the first sidelink reference signal resource). In one embodiment the one or more first parameters of the first sidelink reference signal resource comprise an indication of a sidelink reference signal time occasion (e.g., a sidelink reference signal time occasion index). In one embodiment, the first sidelink reference signal resource is in the sidelink reference signal time occasion. In an example, the indication of the sidelink reference signal time occasion (and/or the sidelink reference signal time occasion index) may indicate that the first sidelink reference signal resource is in the sidelink reference signal time occasion in the slot. In one embodiment, the one or more first parameters of the first sidelink reference signal resource comprise timing information associated with the sidelink reference signal time occasion. In an example, the timing information may indicate that the first sidelink reference signal resource is in the sidelink reference signal time occasion in the slot. In one embodiment, the one or more parameters associated with the plurality of candidate sidelink reference signal resources comprise sidelink reference signal time occasions (e.g., sidelink reference signal time occasion indexes) of candidate sidelink reference signal resources of the plurality of candidate sidelink reference signal resources. In an example, the one or more parameters may indicate that the sidelink reference signal time occasions (e.g., sidelink reference signal time occasion indexes) and/or the plurality of candidate sidelink reference signal resources are in the sidelink reference signal time occasions in the slot. In one embodiment, the one or more parameters associated with the plurality of candidate sidelink reference signal resources comprise timing information associated with candidate sidelink reference signal resources of the plurality of candidate sidelink reference signal resources (e.g., the timing information may comprise timing information of one, some and/or all candidate sidelink reference signal resources of the plurality of candidate sidelink reference signal resources, and/or the timing information may indicate that the plurality of candidate sidelink reference signal resources are in the sidelink reference signal time occasions in the slot). In one embodiment, the one or more parameters associated with the plurality of candidate sidelink reference signal resources comprise timing information associated with the one or more sidelink reference signal time occasions (of the first sidelink resource pool) in the slot.

In one embodiment, the one or more first parameters of the first sidelink reference signal resource comprise (i) a frequency offset of the first sidelink reference signal resource (e.g., the frequency offset may be in units of REs), (ii) a comb offset of the first sidelink reference signal resource (e.g., the comb offset may be in units of REs), and/or (iii) a RE offset of the first sidelink reference signal resource (e.g., the RE offset may be in units of REs). In one embodiment, the one or more parameters associated with the plurality of candidate sidelink reference signal resources comprise (i) frequency offsets of candidate sidelink reference signal resources of the plurality of candidate sidelink reference signal resources (e.g., for each candidate sidelink reference signal resource of one, some and/or all candidate sidelink reference signal resources of the plurality of candidate sidelink reference signal resources, the one or more parameters may comprise a frequency offset of the candidate sidelink reference signal resource, wherein the frequency offset may be in units of REs), (ii) comb offsets of candidate sidelink reference signal resources of the plurality of candidate sidelink reference signal resources (e.g., for each candidate sidelink reference signal resource of one, some and/or all candidate sidelink reference signal resources of the plurality of candidate sidelink reference signal resources, the one or more parameters may comprise a comb offset of the candidate sidelink reference signal resource, wherein the comb offset may be in units of REs), and/or (iii) RE offsets of candidate sidelink reference signal resources of the plurality of candidate sidelink reference signal resources (e.g., for each candidate sidelink reference signal resource of one, some and/or all candidate sidelink reference signal resources of the plurality of candidate sidelink reference signal resources, the one or more parameters may comprise a RE offset of the candidate sidelink reference signal resource, wherein the RE offset may be in units of REs).

In one embodiment, the second device determines to use the first sidelink reference signal resource in the slot for measuring the sidelink reference signal based on a first association between the first frequency resource of the sidelink control channel and (i) the one or more first parameters of the first sidelink reference signal resource, (ii) the first index of the first sidelink reference signal resource, and/or (iii) the first identity of the first sidelink reference signal resource. In one embodiment, the first association is configured and/or specified for the second device. In an example, the second device is configured (e.g., pre-configured) with the first association. In one embodiment, the second device receives an indication of the first association (e.g., the first association is indicated to the second device and/or one or more other devices). In one embodiment, the first association is applied in (and/or is applicable to) the slot. In an example, the second device may perform the measuring the sidelink reference signal on the first sidelink reference signal resource in response to determining (based on the first frequency resource and/or the first association, for example) to use the first sidelink reference signal resource in the slot for measuring the sidelink reference signal.

In some examples, the first association comprises a first mapping relationship (between the first frequency resource and the one or more first parameters, the first index, and/or the first identity of the first sidelink reference signal resource, for example). In some examples, the second device determines (e.g., derives) the first sidelink reference signal resource (for use in measuring the sidelink reference signal in step 2320, for example) by mapping the first frequency resource of the sidelink control channel to the one or more first parameters, the first index, and/or the first identity of the first sidelink reference signal resource using the first mapping relationship. For example, the first frequency resource may be used to determine the first sidelink reference signal resource (e.g., the first frequency resource may be mapped to the first sidelink reference signal resource) in response to receiving the SCI via the first frequency resource (among the plurality of candidate frequency resources, for example), wherein the second device may measure the sidelink reference signal on the first sidelink reference signal resource in response to determining the first sidelink reference signal resource (based on the first frequency resource).

In one embodiment, the second device determines (e.g., derives) the plurality of candidate frequency resources of the sidelink control channel based on a second association between the plurality of candidate frequency resources of the sidelink control channel and (i) the one or more parameters associated with the plurality of candidate sidelink reference signal resources, (ii) the one or more indexes associated with the plurality of candidate sidelink reference signal resources, and/or (iii) the one or more identities associated with the plurality of candidate sidelink reference signal resources. In one embodiment, the second association is configured and/or specified for the second device. In an example, the second device is configured (e.g., pre-configured) with the second association. In one embodiment, the second device receives an indication of the second association (e.g., the second association is indicated to the second device and/or one or more other devices). In one embodiment, the second association is applied in (and/or is applicable to) the slot.

In some examples, the second association comprises a plurality of associations (e.g., mapping relationships) between at least some candidate frequency resources of the plurality of candidate frequency resources and parameters, indexes, and/or identities of at least some candidate sidelink reference signal resources of the plurality of candidate sidelink reference signal resources. In some examples, the plurality of associations comprises (i) the first association (e.g., the first mapping relationship) between the first frequency resource and the one or more first parameters, the first index, and/or the first identity of the first sidelink reference signal resource, (ii) a third association (e.g., a mapping relationship) between a second frequency resource of the plurality of candidate frequency resources and a parameter, an index, and/or identity of a second sidelink reference signal resource of the plurality of candidate sidelink reference signal resources, and/or (iii) one or more other associations. In an example, the first association (e.g., the first mapping relationship) may be used to determine the first frequency resource of the plurality of candidate frequency resources (e.g., the first sidelink reference signal resource of the plurality of candidate sidelink reference signal resources may be mapped to the first frequency resource based on the first association), and/or the third association may be used to determine the second frequency resource (e.g., the second sidelink reference signal resource of the plurality of candidate sidelink reference signal resources may be mapped to the second frequency resource based on the third association).

In one embodiment, the second device determines to use the first sidelink reference signal resource in the slot for measuring the sidelink reference signal based on a first association between the first frequency resource of the sidelink control channel and the first sidelink reference signal resource. In one embodiment, the first association is configured and/or specified for the second device. In an example, the second device is configured (e.g., pre-configured) with the first association. In one embodiment, the second device receives an indication of the first association (e.g., the first association is indicated to the second device and/or one or more other devices). In an example, the second device may perform the measuring the sidelink reference signal on the first sidelink reference signal resource in response to determining (based on the first frequency resource and/or the first association, for example) to use the first sidelink reference signal resource in the slot for measuring the sidelink reference signal. In one embodiment, the first association is applied in (and/or is applicable to) the slot. In some examples, the first association comprises a first resource mapping relationship (between the first frequency resource and the first sidelink reference signal resource, for example). In some examples, the second device determines (e.g., derives) the first sidelink reference signal resource (for use in measuring the sidelink reference signal in step 2320, for example) by mapping the first frequency resource of the sidelink control channel to the first sidelink reference signal resource using the first resource mapping relationship. For example, the first frequency resource may be used to determine the first sidelink reference signal resource (e.g., the first frequency resource may be mapped to the first sidelink reference signal resource) in response to receiving the SCI via the first frequency resource (among the plurality of candidate frequency resources, for example), wherein the second device may measure the sidelink reference signal on the first sidelink reference signal resource in response to determining the first sidelink reference signal resource (based on the first frequency resource).

In one embodiment, the second device determines (e.g., derives) the plurality of candidate frequency resources of the sidelink control channel based on a second association between the plurality of candidate frequency resources of the sidelink control channel and the plurality of candidate sidelink reference signal resources. In one embodiment, the second association is configured and/or specified for the second device. In an example, the second device is configured (e.g., pre-configured) with the second association. In one embodiment, the second device receives an indication of the second association (e.g., the second association is indicated to the second device and/or one or more other devices). In one embodiment, the second association is applied in (and/or is applicable to) the slot. In some examples, the second association comprises a plurality of associations (e.g., resource mapping relationships) between at least some candidate frequency resources of the plurality of candidate frequency resources and at least some candidate sidelink reference signal resources of the plurality of candidate sidelink reference signal resources. In some examples, the plurality of associations comprises (i) the first association (e.g., the first resource mapping relationship) between the first frequency resource and the first sidelink reference signal resource, (ii) a third association (e.g., a resource mapping relationship) between a second frequency resource of the plurality of candidate frequency resources and a second sidelink reference signal resource of the plurality of candidate sidelink reference signal resources, and/or (iii) one or more other associations between one or more other frequency resources of the plurality of candidate frequency resources and one or more other sidelink reference signal resources of the plurality of candidate sidelink reference signal resources. In an example, the first association (e.g., the first resource mapping relationship) may be used to determine the first frequency resource of the plurality of candidate frequency resources (e.g., the first sidelink reference signal resource of the plurality of candidate sidelink reference signal resources may be mapped to the first frequency resource based on the first association), the third association may be used to determine the second frequency resource (e.g., the second sidelink reference signal resource of the plurality of candidate sidelink reference signal resources may be mapped to the second frequency resource based on the third association), and/or the one or more other associations may be used to determine the one or more other frequency resources of the plurality of candidate frequency resources.

In one embodiment, the first frequency resource of the sidelink control channel is associated with (e.g., is indicative of) the first sidelink reference signal resource.

In one embodiment, one sidelink reference signal resource (e.g., one candidate sidelink reference signal resource) in the slot in the first sidelink resource pool (e.g., the first sidelink resource pool may comprise the one sidelink reference signal resource) is associated with one frequency resource (e.g., only one frequency resource) of the sidelink control channel (e.g., the one frequency resource may be a candidate frequency resource). In an example, the first sidelink reference signal resource is associated with the first frequency resource (e.g., only one frequency resource) of the sidelink control channel in the same slot. In an example, each sidelink reference signal resource (e.g., each candidate sidelink reference signal resource) of one, some and/or all sidelink reference signal resources (e.g., candidate sidelink reference signal resources) of the first sidelink resource pool is associated with one (candidate) frequency resource (e.g., only one frequency resource) of the sidelink control channel in the same slot. In some examples, different sidelink reference signal resources (e.g., different candidate sidelink reference signal resources) of the first sidelink resource pool are associated with different frequency resources (e.g., different candidate frequency resources) of the sidelink control channel. In an example, each candidate sidelink reference signal resource of one, some and/or all candidate sidelink reference signal resources of the plurality of candidate sidelink reference signal resources is associated with one candidate frequency resource (e.g., only one candidate frequency resource) of the plurality of candidate frequency resources.

In one embodiment, the first sidelink resource pool comprises a plurality of sidelink reference signal resources in the slot. The plurality of sidelink reference signal resources may be the same as (or different than) the plurality of candidate sidelink reference signal resources. In one embodiment, each sidelink reference signal resource of the plurality of sidelink reference signal resources is associated with a set of frequency resources occupying and/or covering a full bandwidth of the first sidelink resource pool (in PRB-level, for example) and/or full frequency resources of the first sidelink resource pool (in PRB-level, for example). In an example, the set of frequency resources may correspond to the full bandwidth of the first sidelink resource pool (in PRB-level, for example) and/or the full frequency resources of the first sidelink resource pool (in PRB-level, for example). In an example, the set of frequency resources may correspond to an available and/or usable bandwidth of a sidelink reference signal resource of the plurality of sidelink reference signal resources. For example, each sidelink reference signal resource of the plurality of sidelink reference signal resources may have an available and/or usable bandwidth that occupies (e.g., covers) the full bandwidth of the first sidelink resource pool. In an example, the set of frequency resources may correspond to available and/or usable frequency resources of a sidelink reference signal resource of the plurality of sidelink reference signal resources. In one embodiment, each sidelink reference signal resource of the plurality of sidelink reference signal resources covers and/or occupies the full bandwidth of the first sidelink resource pool in PRB-level (e.g., the full bandwidth may comprise one or more PRBs of the first sidelink resource pool) and/or the full frequency resources of the first sidelink resource pool in PRB-level (e.g., the full frequency resources may comprise one or more PRBs of the first sidelink resource pool). In one embodiment, the plurality of sidelink reference signal resources are multiplexed (e.g., sidelink reference signal resources of the plurality of sidelink reference signal resources are multiplexed with each other) based on a comb-structure (e.g., one or more comb-structures) in one or more sidelink reference signal time occasions in the slot (e.g., one comb-structure is applied in one sidelink reference signal time occasion in the slot). In one embodiment, the plurality of candidate sidelink reference signal resources in the slot are associated with the plurality of candidate frequency resources of the sidelink control channel in one sidelink control channel time occasion in the slot in the first sidelink resource pool. For example, each candidate sidelink reference signal resource of the plurality of candidate sidelink reference signal resources may be associated with a candidate frequency resource of the plurality of candidate frequency resources.

In one embodiment, the second device receives the SCI, from a first device, for scheduling the first sidelink reference signal resource (e.g., the SCI may be used to schedule the first sidelink reference signal resource for reception and/or measurement of the sidelink reference signal). In an example, the second device may use the SCI to acquire scheduling information associated with the first sidelink reference signal resource (e.g., the second device may use the SCI to determine the first sidelink reference signal resource for use in measuring the sidelink reference signal). In one embodiment, the SCI corresponds to a one-stage SCI (e.g., the SCI is received via a single stage, and is not received in multiple stages). In an example, the SCI is not a two-stage SC. In one embodiment, the second device receives (and/or the first device transmits) the one-stage SCI, in the first sidelink resource pool, for acquiring scheduling information associated with the first sidelink reference signal resource (e.g., the one-stage SCI may be used for determining which resource to use to receive and/or measure the sidelink reference signal). In one embodiment, the second device does not receive (and/or the first device does not transmit) a two-stage SCI, in the first sidelink resource pool, for acquiring scheduling information associated with the first sidelink reference signal resource.

In one embodiment, the second device has configuration of (e.g., receives a configuration of) a second sidelink resource pool with sidelink data resources. In one embodiment, the second device receives a two-stage SCI, in the second sidelink resource pool, for acquiring scheduling information associated with a sidelink data transmission in the second sidelink resource pool. The two-stage SCI may comprise a 1st stage SCI and a 2nd stage SCI. In one embodiment, the second device does not receive a one-stage SCI, in the second sidelink resource pool, for acquiring scheduling information associated with the sidelink data transmission in the second sidelink resource pool.

In one embodiment, the first sidelink resource pool is a dedicated sidelink resource pool for one or more sidelink reference signals and/or one or more SCIs (e.g., the first sidelink resource pool may be dedicated to transmission, reception, and/or measurement of sidelink reference signals and/or SCIs). In one embodiment, the first sidelink resource pool does not comprise sidelink data channel resources (e.g., resources of the first sidelink resource pool may not be used for communication of sidelink data channel resources, such as PSSCH resources).

In one embodiment, the sidelink reference signal is a sidelink positioning reference signal. In one embodiment, the sidelink reference signal is a sidelink CSI-RS for beam management. In one embodiment, the sidelink reference signal corresponds to localization (e.g., high-resolution sidelink localization), positioning (e.g., high-resolution sidelink positioning), ranging (e.g., high-resolution sidelink ranging), sensing (e.g., high-resolution sidelink sensing) and/or imaging (e.g., high-resolution sidelink imaging). In an example, the sidelink reference signal is a signal utilized for localization (e.g., high-resolution sidelink localization), a signal utilized for sensing (e.g., high-resolution sidelink sensing), a signal utilized for positioning (e.g., high-resolution sidelink positioning), a signal utilized for ranging (e.g., high-resolution sidelink ranging), and/or a signal utilized for imaging (e.g., high-resolution sidelink imaging).

In one embodiment, the one or more sidelink reference signal time occasions in the slot comprise a first sidelink reference signal time occasion and a second sidelink reference signal time occasion. In one embodiment, the first sidelink reference signal time occasion is associated with a first bandwidth. For example, each sidelink reference signal resource in the first sidelink reference signal time occasion may be associated with the first bandwidth. For example, the first sidelink reference signal time occasion (and/or each sidelink reference signal resource in the first sidelink reference signal time occasion) may occupy and/or cover the first bandwidth. In one embodiment, the second sidelink reference signal time occasion is associated with the first bandwidth. For example, each sidelink reference signal resource in the second sidelink reference signal time occasion may be associated with the first bandwidth. For example, the second sidelink reference signal time occasion (and/or each sidelink reference signal resource in the second sidelink reference signal time occasion) may occupy and/or cover the first bandwidth. In an example, the first sidelink reference signal time occasion and the second sidelink reference signal time occasion both are associated with (e.g., may occupy and/or cover) the same bandwidth (e.g., the first bandwidth). In one embodiment, the first bandwidth corresponds to a full bandwidth of the first sidelink resource pool (in PRB-level, for example) and/or full frequency resources of the first sidelink resource pool (in PRB-level, for example). In an example, the full bandwidth and/or the full frequency resources of the first sidelink resource pool may correspond to a set of PRBs.

In one embodiment, the first sidelink reference signal time occasion in the slot starts from a first symbol. In one embodiment, the second sidelink reference signal time occasion in the slot starts from a second symbol. In one embodiment, the first symbol is different than the second symbol. In one embodiment, the first sidelink reference signal time occasion and the second sidelink reference signal time occasion are non-overlapped in time domain (e.g., the first sidelink reference signal time occasion and the second sidelink reference signal time occasion do not overlap with each other in time domain). In one embodiment, when (and/or if) the first sidelink reference signal resource is in the first sidelink reference signal time occasion, the one or more first parameters of the first sidelink reference signal resource comprise first timing information associated with the first sidelink reference signal time occasion. In one embodiment, when (and/or if) the first sidelink reference signal resource is in the second sidelink reference signal time occasion, the one or more first parameters of the first sidelink reference signal resource comprise second timing information associated with the second sidelink reference signal time occasion. In one embodiment, the first timing information is different than the second timing information.

In one embodiment, a first number of sidelink reference signals multiplexed in the first sidelink reference signal time occasion is the same as a second number of sidelink reference signals multiplexed in the second sidelink reference signal time occasion.

In one embodiment, a first number of sidelink reference signals multiplexed in the first sidelink reference signal time occasion is different than a second number of sidelink reference signals multiplexed in the second sidelink reference signal time occasion.

In one embodiment, one sidelink control channel time occasion is in the slot in the first sidelink resource pool (e.g., there is only one sidelink control channel time occasion in the slot in the first sidelink resource pool). In one embodiment, the one sidelink control channel time occasion comprises the plurality of candidate frequency resources of the sidelink control channel. In one embodiment, the plurality of candidate frequency resources in the one sidelink control channel time occasion are FDMed (e.g., candidate frequency resources of the plurality of candidate frequency resources are FDMed with each other). In one embodiment, the plurality of candidate frequency resources in the one sidelink control channel time occasion are FDMed in sub-channel-level.

Referring back to FIGS. 3 and 4, in one exemplary embodiment of a second device with a configuration of a first sidelink resource pool comprising sidelink reference signal resources, the device 300 includes a program code 312 stored in the memory 310. The CPU 308 may execute program code 312 to enable the second device (i) to determine a plurality of candidate frequency resources of sidelink control channel in a slot in the first sidelink resource pool, wherein the plurality of candidate frequency resources is associated with a plurality of candidate sidelink reference signal resources in the slot, and determining the plurality of candidate frequency resources associated with the plurality of candidate sidelink reference signal resources is based on one or more parameters associated with the plurality of candidate sidelink reference signal resources, one or more indexes associated with the plurality of candidate sidelink reference signal resources, and/or one or more identities associated with the plurality of candidate sidelink reference signal resources, (ii) to perform monitoring on the plurality of candidate frequency resources of the sidelink control channel in the slot, (iii) to receive a SCI using/on a first frequency resource of the sidelink control channel in the slot, wherein the plurality of candidate frequency resources comprises the first frequency resource of the sidelink control channel, and (iv) to measure a sidelink reference signal on a first sidelink reference signal resource in the slot, wherein the first sidelink reference signal resource is associated with one or more first parameters determined based on the first frequency resource of the sidelink control channel, a first index determined based on the first frequency resource of the sidelink control channel, and/or a first identity determined based on the first frequency resource of the sidelink control channel. Furthermore, the CPU 308 can execute the program code 312 to perform one, some and/or all of the above-described actions and steps and/or others described herein.

A communication device (e.g., a UE, a base station, a network node, etc.) may be provided, wherein the communication device may comprise a control circuit, a processor installed in the control circuit and/or a memory installed in the control circuit and coupled to the processor. The processor may be configured to execute a program code stored in the memory to perform method steps illustrated in FIGS. 20-23. Furthermore, the processor may execute the program code to perform one, some and/or all of the above-described actions and steps and/or others described herein.

A computer-readable medium may be provided. The computer-readable medium may be a non-transitory computer-readable medium. The computer-readable medium may comprise a flash memory device, a hard disk drive, a disc (e.g., a magnetic disc and/or an optical disc, such as at least one of a digital versatile disc (DVD), a compact disc (CD), etc.), and/or a memory semiconductor, such as at least one of static random access memory (SRAM), dynamic random access memory (DRAM), synchronous dynamic random access memory (SDRAM), etc. The computer-readable medium may comprise processor-executable instructions, that when executed cause performance of one, some and/or all method steps illustrated in FIGS. 20-23, and/or one, some and/or all of the above-described actions and steps and/or others described herein.

It may be appreciated that applying one or more of the techniques presented herein may result in one or more benefits including, but not limited to, increased efficiency of communication between devices (e.g., UEs and/or other types of devices). The increased efficiency may be a result of managing (and/or mitigating) SCI/PSCCH overlapping and/or conflict problem for SL PRS. Alternatively and/or additionally applying one or more of the techniques presented herein may result in reducing (and/or preventing) resource waste and/or increasing spectrum utilization efficiency and/or resource utilization efficiency.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Alternatively and/or additionally, in some aspects any suitable computer-program product may comprise a computer-readable medium comprising codes relating to one or more of the aspects of the disclosure. In some aspects a computer program product may comprise packaging materials.

While the disclosed subject matter has been described in connection with various aspects, it will be understood that the disclosed subject matter is capable of further modifications. This application is intended to cover any variations, uses or adaptation of the disclosed subject matter following, in general, the principles of the disclosed subject matter, and including such departures from the present disclosure as come within the known and customary practice within the art to which the disclosed subject matter pertains.

1. A method of a device with a configuration of a first sidelink resource pool comprising sidelink reference signal resources, the method comprising:
determining a plurality of candidate frequency resources of a sidelink control channel in a slot in the first sidelink resource pool, wherein:
the plurality of candidate frequency resources is associated with a plurality of candidate sidelink reference signal resources in the slot; and
determining the plurality of candidate frequency resources associated with the plurality of candidate sidelink reference signal resources is based on at least one of:
one or more parameters associated with the plurality of candidate sidelink reference signal resources;
one or more indexes associated with the plurality of candidate sidelink reference signal resources; or
one or more identities associated with the plurality of candidate sidelink reference signal resources
performing monitoring on the plurality of candidate frequency resources of the sidelink control channel in the slot;
receiving a sidelink control information (SCI) using a first frequency resource of the sidelink control channel in the slot, wherein the plurality of candidate frequency resources comprises the first frequency resource of the sidelink control channel; and
measuring a sidelink reference signal on a first sidelink reference signal resource in the slot, wherein the first sidelink reference signal resource is associated with at least one of:
one or more first parameters determined based on the first frequency resource of the sidelink control channel;
a first index determined based on the first frequency resource of the sidelink control channel; or
a first identity determined based on the first frequency resource of the sidelink control channel.

2. The method of claim 1, wherein at least one of:
the first sidelink resource pool comprises one or more sidelink reference signal time occasions in the slot;
the one or more first parameters of the first sidelink reference signal resource comprise timing information associated with the first sidelink reference signal resource;
the one or more first parameters of the first sidelink reference signal resource comprise an indication of a sidelink reference signal time occasion in the slot, wherein the first sidelink reference signal resource is in the sidelink reference signal time occasion;
the one or more first parameters of the first sidelink reference signal resource comprise timing information associated with the sidelink reference signal time occasion in the slot;
the one or more parameters associated with the plurality of candidate sidelink reference signal resources comprise sidelink reference signal time occasions of candidate sidelink reference signal resources of the plurality of candidate sidelink reference signal resources;
the one or more parameters associated with the plurality of candidate sidelink reference signal resources comprise timing information associated with candidate sidelink reference signal resources of the plurality of candidate sidelink reference signal resources; or
the one or more parameters associated with the plurality of candidate sidelink reference signal resources comprise timing information associated with the one or more sidelink reference signal time occasions in the slot.

3. The method of claim 1, wherein at least one of:
the one or more first parameters of the first sidelink reference signal resource comprise at least one of:
a frequency offset of the first sidelink reference signal resource;
a comb offset of the first sidelink reference signal resource; or
a Resource Element (RE) offset of the first sidelink reference signal resource; or
the one or more parameters associated with the plurality of candidate sidelink reference signal resources comprise at least one of:
frequency offsets of candidate sidelink reference signal resources of the plurality of candidate sidelink reference signal resources;
comb offsets of candidate sidelink reference signal resources of the plurality of candidate sidelink reference signal resources; or
RE offsets of candidate sidelink reference signal resources of the plurality of candidate sidelink reference signal resources.

4. The method of claim 1, wherein at least one of:
the method comprises determining to use the first sidelink reference signal resource in the slot for measuring the sidelink reference signal based on a first association between the first frequency resource of the sidelink control channel and at least one of:
the one or more first parameters of the first sidelink reference signal resource;
the first index of the first sidelink reference signal resource; or
the first identity of the first sidelink reference signal resource;
the first association is at least one of configured or specified for the device;
the method comprises receiving an indication of the first association;
the first association is applied in the slot;
determining the plurality of candidate frequency resources of the sidelink control channel is performed based on a second association between the plurality of candidate frequency resources of the sidelink control channel and at least one of:
the one or more parameters associated with the plurality of candidate sidelink reference signal resources;
the one or more indexes associated with the plurality of candidate sidelink reference signal resources; or
the one or more identities associated with the plurality of candidate sidelink reference signal resources;
the second association is at least one of configured or specified for the device;
the method comprises receiving an indication of the second association; or
the second association is applied in the slot.

5. The method of claim 1, wherein at least one of:
the method comprises determining to use the first sidelink reference signal resource in the slot for measuring the sidelink reference signal based on a first association between the first frequency resource of the sidelink control channel and the first sidelink reference signal resource;
the first association is at least one of configured or specified for the device;
the method comprises receiving an indication of the first association;
the first association is applied in the slot;
determining the plurality of candidate frequency resources of the sidelink control channel is performed based on a second association between the plurality of candidate frequency resources of the sidelink control channel and the plurality of candidate sidelink reference signal resources;
the second association is at least one of configured or specified for the device;
the method comprises receiving an indication of the second association; or
the second association is applied in the slot.

6. The method of claim 1, wherein:
the first frequency resource of the sidelink control channel is associated with the first sidelink reference signal resource.

7. The method of claim 1, wherein:
one sidelink reference signal resource in the slot in the first sidelink resource pool is associated with one frequency resource of the sidelink control channel.

8. The method of claim 1, wherein:
the first sidelink resource pool comprises the plurality of candidate sidelink reference signal resources in the slot; and
at least one of:
each sidelink reference signal resource of the plurality of candidate sidelink reference signal resources at least one of covers or occupies at least one of a full bandwidth of the first sidelink resource pool in Physical Resource Block (PRB)-level or full frequency resources of the first sidelink resource pool in PRB-level;
the plurality of candidate sidelink reference signal resources are multiplexed based on a comb-structure in one or more sidelink reference signal time occasions in the slot; or
the plurality of candidate sidelink reference signal resources in the slot are associated with the plurality of candidate frequency resources of the sidelink control channel in one sidelink control channel time occasion in the slot in the first sidelink resource pool.

9. The method of claim 1, wherein at least one of:
the receiving the SCI comprises receiving the SCI, from a second device, for scheduling the first sidelink reference signal resource;
the SCI corresponds to a one-stage SCI;
the receiving the SCI comprising receiving the one-stage SCI, in the first sidelink resource pool, for acquiring scheduling information associated with the first sidelink reference signal resource; or
the method comprises not receiving a two-stage SCI, in the first sidelink resource pool, for acquiring scheduling information associated with the first sidelink reference signal resource.

10. The method of claim 1, wherein at least one of:
the method comprises receiving a configuration of a second sidelink resource pool with sidelink data resources;
the method comprises receiving a two-stage SCI, in the second sidelink resource pool, for acquiring scheduling information associated with a sidelink data transmission in the second sidelink resource pool; or
the method comprises not receiving a one-stage SCI, in the second sidelink resource pool, for acquiring scheduling information associated with the sidelink data transmission in the second sidelink resource pool.

11. The method of claim 1, wherein at least one of:
the first sidelink resource pool is a dedicated sidelink resource pool for at least one of one or more sidelink reference signals or one or more SCIs; or
the first sidelink resource pool does not comprise sidelink data channel resources.

12. The method of claim 1, wherein at least one of:
the sidelink reference signal is a sidelink positioning reference signal;
the sidelink reference signal is a sidelink Channel State Information based Reference Signal (CSI-RS) for beam management; or
the sidelink reference signal is utilized for at least one of localization, positioning, range, sensing or imaging.

13. The method of claim 2, wherein at least one of:
the one or more sidelink reference signal time occasions in the slot comprise a first sidelink reference signal time occasion and a second sidelink reference signal time occasion;
each candidate sidelink reference signal resource in the first sidelink reference signal time occasion is associated with a first bandwidth;
each candidate sidelink reference signal resource in the second sidelink reference signal time occasion is associated with the first bandwidth;
the first bandwidth corresponds to at least one of a full bandwidth of the first sidelink resource pool in Physical Resource Block (PRB)-level or full frequency resources of the first sidelink resource pool in PRB-level;
the first sidelink reference signal time occasion in the slot starts from a first symbol;
the second sidelink reference signal time occasion in the slot starts from a second symbol;
the first symbol is different than the second symbol;
the first sidelink reference signal time occasion and the second sidelink reference signal time occasion are non-overlapped in time domain;
when the first sidelink reference signal resource is in the first sidelink reference signal time occasion, the one or more first parameters of the first sidelink reference signal resource comprise first timing information associated with the first sidelink reference signal time occasion;
when the first sidelink reference signal resource is in the second sidelink reference signal time occasion, the one or more first parameters of the first sidelink reference signal resource comprise second timing information associated with the second sidelink reference signal time occasion; or
the first timing information is different than the second timing information.

14. The method of claim 13, wherein:
a first number of sidelink reference signals multiplexed in the first sidelink reference signal time occasion is the same as a second number of sidelink reference signals multiplexed in the second sidelink reference signal time occasion.

15. The method of claim 13, wherein:
a first number of sidelink reference signals multiplexed in the first sidelink reference signal time occasion is different than a second number of sidelink reference signals multiplexed in the second sidelink reference signal time occasion.

16. The method of claim 1, wherein at least one of:
one sidelink control channel time occasion is in the slot in the first sidelink resource pool;
the one sidelink control channel time occasion comprises the plurality of candidate frequency resources of the sidelink control channel; or
the plurality of candidate frequency resources in the one sidelink control channel time occasion are frequency division multiplexed (FDMed).

17. A device with a configuration of a first sidelink resource pool comprising sidelink reference signal resources, the device comprising:
a control circuit;
a processor installed in the control circuit; and
a memory installed in the control circuit and operatively coupled to the processor, wherein the processor is configured to execute a program code stored in the memory to perform operations, the operations comprising:
determining a plurality of candidate frequency resources of a sidelink control channel in a slot in the first sidelink resource pool, wherein:
the plurality of candidate frequency resources is associated with a plurality of candidate sidelink reference signal resources in the slot; and
determining the plurality of candidate frequency resources associated with the plurality of candidate sidelink reference signal resources is based on at least one of:
one or more parameters associated with the plurality of candidate sidelink reference signal resources;
one or more indexes associated with the plurality of candidate sidelink reference signal resources; or
one or more identities associated with the plurality of candidate sidelink reference signal resources
performing monitoring on the plurality of candidate frequency resources of the sidelink control channel in the slot;
receiving a sidelink control information (SCI) using a first frequency resource of the sidelink control channel in the slot, wherein the plurality of candidate frequency resources comprises the first frequency resource of the sidelink control channel; and
measuring a sidelink reference signal on a first sidelink reference signal resource in the slot, wherein the first sidelink reference signal resource is associated with at least one of:
one or more first parameters determined based on the first frequency resource of the sidelink control channel;
a first index determined based on the first frequency resource of the sidelink control channel; or
a first identity determined based on the first frequency resource of the sidelink control channel.

18. The device of claim 17, wherein at least one of:
the first sidelink resource pool comprises one or more sidelink reference signal time occasions in the slot;
the one or more first parameters of the first sidelink reference signal resource comprise timing information associated with the first sidelink reference signal resource;
the one or more first parameters of the first sidelink reference signal resource comprise an indication of a sidelink reference signal time occasion in the slot, wherein the first sidelink reference signal resource is in the sidelink reference signal time occasion;
the one or more first parameters of the first sidelink reference signal resource comprise timing information associated with the sidelink reference signal time occasion in the slot;
the one or more parameters associated with the plurality of candidate sidelink reference signal resources comprise sidelink reference signal time occasions of candidate sidelink reference signal resources of the plurality of candidate sidelink reference signal resources;
the one or more parameters associated with the plurality of candidate sidelink reference signal resources comprise timing information associated with candidate sidelink reference signal resources of the plurality of candidate sidelink reference signal resources; or
the one or more parameters associated with the plurality of candidate sidelink reference signal resources comprise timing information associated with the one or more sidelink reference signal time occasions in the slot.

19. A non-transitory machine readable medium having stored thereon processor-executable instructions, that when executed by a device with a configuration of a first sidelink resource pool comprising sidelink reference signal resources, cause performance of operations, the operations comprising:
determining a plurality of candidate frequency resources of a sidelink control channel in a slot in the first sidelink resource pool, wherein:
the plurality of candidate frequency resources is associated with a plurality of candidate sidelink reference signal resources in the slot; and
determining the plurality of candidate frequency resources associated with the plurality of candidate sidelink reference signal resources is based on at least one of:
one or more parameters associated with the plurality of candidate sidelink reference signal resources;
one or more indexes associated with the plurality of candidate sidelink reference signal resources; or
one or more identities associated with the plurality of candidate sidelink reference signal resources
performing monitoring on the plurality of candidate frequency resources of the sidelink control channel in the slot;
receiving a sidelink control information (SCI) using a first frequency resource of the sidelink control channel in the slot, wherein the plurality of candidate frequency resources comprises the first frequency resource of the sidelink control channel; and
measuring a sidelink reference signal on a first sidelink reference signal resource in the slot, wherein the first sidelink reference signal resource is associated with at least one of:
one or more first parameters determined based on the first frequency resource of the sidelink control channel;
a first index determined based on the first frequency resource of the sidelink control channel; or
a first identity determined based on the first frequency resource of the sidelink control channel.

20. The non-transitory machine readable medium of claim 19, wherein at least one of:
the first sidelink resource pool comprises one or more sidelink reference signal time occasions in the slot;
the one or more first parameters of the first sidelink reference signal resource comprise timing information associated with the first sidelink reference signal resource;
the one or more first parameters of the first sidelink reference signal resource comprise an indication of a sidelink reference signal time occasion in the slot, wherein the first sidelink reference signal resource is in the sidelink reference signal time occasion;
the one or more first parameters of the first sidelink reference signal resource comprise timing information associated with the sidelink reference signal time occasion in the slot;
the one or more parameters associated with the plurality of candidate sidelink reference signal resources comprise sidelink reference signal time occasions of candidate sidelink reference signal resources of the plurality of candidate sidelink reference signal resources;
the one or more parameters associated with the plurality of candidate sidelink reference signal resources comprise timing information associated with candidate sidelink reference signal resources of the plurality of candidate sidelink reference signal resources; or
the one or more parameters associated with the plurality of candidate sidelink reference signal resources comprise timing information associated with the one or more sidelink reference signal time occasions in the slot.
